(19) United States
(12) Patent Application Publication
(10) Pub. No.: US 2010/0326023 A1
(43) Pub. Date: Dec. 30, 2010

(54) LOAD-BEARING FRAME APPARATUS FOR PACK ANIMALS

(76) Inventor: Robert J. Ferrand, Redwood City, CA (US)

Correspondence Address: KOLISCH HARTWELL, P.C., 200 PACIFIC BUILDING, 520 SW YAMHILL STREET, PORTLAND, OR, 97204, US

(21) Appl. No.: 12/665,881

(22) PCT Filed: Jul. 11, 2008
(86) PCT No.: PCT/US08/69820

§ 371 Date: Dec. 21, 2009

Related U.S. Application Data
(60) Provisional application No. 60/959,305, filed on Jul. 12, 2007.

(51) Int. Cl. B68C 1/00; B68B 9/00

(52) U.S. Cl. 54/37.1; 54/84

(57) ABSTRACT

The present disclosure relates generally to load-bearing frame apparatus for a pack animals, and more particularly to a saddle for transporting cargo upon the backs of pack animals that may be adapted to carry a wide variety of different types and configurations of cargo. Examples of load-bearing apparatus may include a modular load-bearing frame, a load-distribution assembly, a hoist assembly, and/or a multiply-positionable link.

### RELATED APPLICATIONS

This application claims the benefit of U.S. Provisional Application No. 60/959,305, filed Jul. 12, 2007 incorporated herein by reference in its entirety for all purposes.

### FIELD OF THE DISCLOSURE

The present disclosure relates generally to a load-bearing frame apparatus for a pack animal, and more particularly to a saddle and apparatus for transporting cargo upon the backs of pack animals that may be adapted to carry a wide variety of different types and configurations of cargo. In some examples, at least part of the disclosed apparatus may include a modular load-bearing frame, a load-distribution assembly, a hoist assembly, and/or a multiply-positionable link.

The subject matter of the present disclosure is related to the following list of U.S. patents. The disclosures of each of these patents are incorporated herein by reference in their entirety for all purposes.
Curve-conforming sensor array pad and method of measuring saddle pressures on a horse—Inventor Robert J. Ferrand et al.—U.S. Pat. No. 5,375,397—Issue date: Dec. 27, 1994
Gauge and method for measuring animal backs and saddles—Inventor Robert J. Ferrand—U.S. Pat. No. 6,334,262—Issue date: Jan. 1, 2002
Saddle support device and adjustable form jig and method to correct for the variation between animal backs and saddles—Inventor Robert J. Ferrand—U.S. Pat. No. 6,948,256—Issue date: Sep. 27, 2005

### BACKGROUND OF THE DISCLOSURE

Pack animals are commonly used to transport loads such as heavy objects when vehicles are neither available nor convenient. Numerous devices, which are generally called saddles and/or pack saddles, have heretofore been presented that claim to distribute the weight of the pack loads more evenly on the animal's back. The following disclosure uses the terms “pack saddle” and/or “saddle” to include any device used to support a load weight wherein the load may comprise any item including a human. Because the pressure exerted by the weight of the load affects the tissue on the pack animal's back, fitting the saddle to the animal may prevent injuries to the animal, which may include saddle sores or other tissue traumas. Further, the saddle may tend to slip from side to side as the animal walks, especially if the load is not accurately balanced. This instability may force the animal to travel at a slow pace, basically at a walk, to avoid causing the load to shift and become unbalanced. While a walk maybe acceptable for a recreational packer, in certain environments such as military operations, a faster pace such as a trot or even a gallop may be desired.

Pack saddles in particular and riding saddles in general, have two critical factors—fit and function. Pack animals, like humans, come in all shapes and sizes. As an example, employing three-dimensional angular measurements to horses (equines), the side to side angular measurements of the animal's back at the withers (corresponding to the front of the saddle) may vary from 60 degrees on some Thoroughbred horses to as much as 120 degrees on Draft horses, such as Shires. This 60-degree variation, however, may represent only a two dimensional measurement on one plane. Because the horse's back is a three dimensional shape, the measurements at the loin (corresponding to the back of the saddle or cantle) can vary from 110 degrees to 150 degrees, representing a 40-degree variation. Further, there may be a concave arc to the back that not only changes from animal to animal, but also changes on individual animals as the animal ages.

Comparisons of computer interface pressure measurements of the three dimensional shape of an animal's back relative to the three-dimensional shape of a saddle have shown that variations greater than 7-10 degrees between the animal's back and the saddle cannot be corrected by conventional saddle pads. Therefore, the “Fit” of the saddle that is within an accuracy of less than 5 degrees of variation may be considered to be able to “Fit” the animal and prevent injury.

Whereas the preceding discussion had focused on horses only, there are a variety of different species of animals that are employed as pack animals: horse, mule, donkey, llama, camel, elephant, ox, and yak, just to name a few. Additionally and/or alternatively, the load-bearing animal in some examples may be a person (a human animal), or it may be a robot (a mechanical animal) providing a horizontal load-bearing structure. In this context, the permutations of three-dimensional animal back shapes, may not be infinite, but it is, at best, a daunting number.

In addition to the effects of the back shape of the animal, the weight of the load caused by gravitational forces may cause the concave arc of the back to increase as the weight of the load increases. Accordingly, the shape an unloaded back may not be the same as shape of the back when the saddle is loaded. Calibrated three-dimensional angular measurement and computer interface pressure measurement instruments may be employed to accurately fit a loaded saddle to an animal.

### SUMMARY OF THE DISCLOSURE

A lightweight modular animal-pack-saddle apparatus may have an integrated load distribution assembly that is selectively deformably adaptable to the variety of different shapes of animal backs, and can be constructed in a variety of different materials to be readily and economically manufactured. In some examples, the pack saddle may be adapted to carry a wide variety of different cargo by changing the configuration of a finite set of parts relative to each other. In some examples, a pipe and locking collar mechanism may be used to secure the various parts relative to one another through holes in the parts. Moreover, the holes may lighten the weight of the pack saddle. This locking collar mechanism may also permit the modular pack saddle to be reconfigured for different cargos without the employment of tools.

Upon this pipe frame, examples of a pack saddle may also provide an adjustable deformable load distribution assembly. In some examples, various thin materials such as leaf springs may be used to distribute the weight of the pack load. The load of the pack saddle may be distributed to several points or areas, such as four points. At each load point, the load may be first distributed to a leaf spring that divides the load into an increased number of load points, such as six load points. In turn, each of those load points may rest on another smaller leaf spring that further divides the primary load point into multiple secondary load points corresponding to each primary load point. These smaller load points may then load yet another leaf spring, such as a longer leaf spring that may be either the length of the saddle, or a shorter spring that divides the load on to four areas on either side of the spine that may more evenly distribute the load onto the back of the animal. This cascading series of leaf springs may divide the load into over 80 different areas of contact, thereby distributing and reducing the pressure created by the weight of the load.

A method may be used to adjust the shape of a deformable load distribution assembly, such as the one just described. In some examples, one or more methods of measurement may be used, such as three-dimensional angular measurement and/or computer interface pressure measurement. The measurements may be used to accurately adjust the pack saddle deformable load distribution assembly to the pack animal. As indicated, adjustments may be made by one or more techniques such as by adjusting the configuration of the deformable load distribution assembly, by arc and angular position adjustment, by moving the relative position of the springs relative to each other, or by the use of tapered contour shims, until even pressure distribution is achieved. Weight distribution measurement may be able to objectively validate that the fit does, in fact, evenly distribute the pressure of weight of the load on the back of the pack animal, prior to placing the animal and pack saddle in service.

In some examples, a pack saddle may additionally or alternatively include a side stabilization system. Such a side stabilization system may form a secure base for the pack saddle frame, upon which additional parts can be added to accommodate a wide variety of cargo. An animal pack saddle that fits the animal's back more accurately may create a more secure and stable fit, so that the load is resistant to shift. Accordingly, the animal can walk, trot, canter, and gallop without the load shifting.

Additionally or alternatively, a universal cleat may be used that permits the cargo to be secured to the frame without the use of knots. In some examples, a loading winch system may permit the cargo load to be lifted on to the pack animal's back, evenly side to side, as well as, progressively, reducing injury to the animal, as well as, the packer.

In one embodiment, a kit for a load-supporting saddle is provided. The kit may include a plurality of frame members. Each frame member may extend rigidly in a member plane and may include a first section and a second section extending transverse to the first section in the member plane. The frame members may be adapted to be attached together to form a first frame assembly that, during use, may be downwardly-open arched and sized to receive the back of a load-carrying or load-bearing animal. The kit may also include a weight-transferring assembly, adapted to be attached to the assembled frame, for transferring weight of a load received by the frame onto the back of the load-carrying animal.

The kit may further include at least a first transverse member adapted to be supported on a frame member so that, during use, it may extend transverse to the member plane of the one frame member, transverse to the frame assembly, and along the back of the load-carrying animal. The first frame assembly and the transverse member may be adapted to be assembled to form a frame for supporting a load to be carried by a load-carrying animal. In some embodiments of the kit, a plurality of frame members may be adapted to be attached together to form first and second U-shaped frame assemblies supported in spaced-apart positions along the back of the load-carrying animal by one or more transverse members.

In another embodiment in accordance with the present disclosure, a load-supporting saddle is provided. The saddle may include a frame, for supporting a load, and a hoist assembly for raising a load vertically toward the frame while the frame is supported by a load-carrying animal. The hoist assembly may include a first support member supported on the frame. The first support member may extend laterally of the animal beyond a first side of the frame. A first guide element may be supported by the first support member at a position disposed horizontally beyond the first side of the frame so that a first cord hanging downwardly from the first guide element may be spaced from the frame.

In some embodiments of a load carrying saddle in accordance with the present disclosure, the hoist assembly may further include a winch assembly. The winch assembly may include a first spool section and a drive mechanism rotatingly mounting the first spool, relative to the saddle frame. The drive mechanism may be operable in a hoisting mode for rotating the first spool section relative to the frame. A first cord may thereby be winded while attached to the first spool section, and may have a free end extending over, and hanging from, the first guide element.

In other embodiments of a load-supporting saddle, the hoist assembly may include a second support member supported on the frame. The second support member may extend laterally beyond a second side of the frame opposite the first side. A second guide element may be supported by the second support member at a position disposed horizontally beyond the second side of the frame so that a second cord hanging downwardly from the second guide element is spaced from the frame.

In another embodiment of a load-supporting saddle in accordance with the present disclosure, a load-distribution assembly is provided. The load-distribution assembly may be for supporting a load-carrying frame on the back of a pack animal and may include at least a first load-distributing member. The first load-distributing member may have opposing first and second surfaces extending between spaced-apart first and second sections and an intermediate third section disposed between and spaced from the first and second sections.

The load-distribution assembly may further include at least a first load-bearing member. The first load-bearing member may be attached to each of the opposite first and second sections of the first load-distributing member. The first load-bearing member may have a first surface facing the second surface of the first load-distributing member and a second surface opposite the first surface and facing the load-carrying animal during use. The load-supporting saddle may also include an attachment mechanism for attaching the frame to the load-distribution assembly.

In another embodiment in accordance with the present disclosure, a multiply-positionable link is provided. The link may be for use in attaching an object to a load-carrying frame having at least first and second frame-mounting stations spaced-apart a given distance. The link may include a body and a first pair of link-mounting stations attached to the body. The first pair of link-mounting stations may be spaced-apart the given distance and disposed on the body along a first station line. The link may further include a second pair of link-mounting stations, also attached to the body, spaced-apart the given distance, and disposed along a second station line different than the first station line.

The body of the link may be supportable on the frame in at least two orientations. For example, the body may be supportable on the frame in a first orientation, with first and second link-mounting stations of the first pair of link-mounting stations aligned with the first and second frame-mounting stations and at least one of the mounting stations of the second pair of mounting stations spaced from the first-station lines. The body may further be supportable on the frame in a second orientation with first and second link-mounting stations of the second pair of link-mounting stations aligned with the first and second frame-mounting stations and at least one of the mounting stations of the first pair of mounting stations spaced from the second-station line.

In some embodiments of a multiply-positionable link, the link may further include at least one hook extending from the body and spaced from at least one of the first and second station lines. The hooks may be distributed in a body plane. The link may be symmetrical about a plane of symmetry containing the first station line that is orthogonal to the body plane.

These and other features of the disclosed pack saddles and methods of supporting a load will become apparent from a review of the accompanying drawings and the following detailed description of the exemplary embodiments.

### BRIEF DESCRIPTION OF THE SEVERAL VIEWS OF THE DRAWINGS

FIG. 1 Perspective view of an exemplary modular animal pack saddle frame.

FIG. 2 Side view of an exemplary modular animal pack saddle on an animal such as a horse.

FIG. 3 Top view of an exemplary modular animal pack saddle on an animal such as a horse.

FIG. 4 Front view of an exemplary modular animal pack saddle on an animal such as a horse.

FIG. 5 Perspective view of an exemplary modular animal pack saddle frame.

FIG. 6 Perspective view of an exemplary animal pack saddle with Javelin Missile hanger load.

FIG. 7 Top view of a plurality of parts that may be assembled form one or more exemplary modular animal pack saddles.

FIG. 8 Perspective view of an exemplary animal pack saddle palletable shipping case.

FIG. 9 Top view of an exemplary modular animal pack saddle shipping case with the parts of FIG. 7 loaded inside.

FIG. 10 Exploded view of an exemplary Javelin Missile hanger load.

FIG. 11 Perspective view of an exemplary modular pack saddle with mortar and rockets hanger load.

FIG. 12 Exploded view of an exemplary modular pack saddle with mortar and rockets hanger load.

FIG. 13 Perspective view of an exemplary modular pack saddle with 3-80 lb. back packs.

FIG. 14 Perspective view of an exemplary modular pack saddle sniper rifle case and 50 cal. ammo boxes

FIG. 15 Perspective view of an exemplary modular pack saddle with water or fuel cans.

FIG. 16 Perspective view of an exemplary modular pack saddle with manatee/lash load.

FIG. 17 Perspective view of an exemplary modular pack saddle with 463l pallet boxes.

FIG. 18 Perspective view of an exemplary modular pack saddle with a stokes stretcher.

FIG. 19 Perspective view of an exemplary modular pack saddle with foldable litter stretchers.

FIG. 20 Perspective view of an exemplary modular pack saddle with chair litters.

FIG. 21 Perspective view of an exemplary modular pack saddle with retrofit assembly attached to a box.

FIG. 22 Perspective view of an exemplary modular pack saddle showing universal cleat detail outside hanger hooks.

FIG. 23 Perspective view of an exemplary modular pack saddle showing universal cleat detail hang inside box.

FIG. 24 Perspective view of an exemplary modular pack saddle in a brick/rock transportation configuration.

FIG. 25 Perspective view of an exemplary modular pack saddle in a gravel spreading assembly configuration.

FIG. 26 Perspective view of an exemplary modular pack saddle in a loose hay or branch transport assembly configuration.

FIG. 27 Perspective view of an exemplary modular pack saddle in a dual load winch assembly configuration.

FIG. 28 Perspective view of an exemplary modular pack saddle in a dual load winch assembly configuration.

FIG. 29 Top view of an exemplary modular pack saddle dual load winch assembly configuration.

FIG. 30 Front view of an exemplary base modular pack saddle reduced to fit a smaller size animal.

FIG. 31 Perspective view of an exemplary modular pack saddle reduced to fit a smaller size animal.

FIG. 32 Front view of an exemplary modular pack saddle expanded to fit a medium size animal.

FIG. 33 Perspective view of an exemplary modular pack saddle expanded to fit a medium size animal.

FIG. 34 Front view of an exemplary modular pack saddle expanded to fit a larger size animal

FIG. 35 Perspective view of an exemplary modular pack saddle expanded to fit a larger size animal.

FIG. 36 Perspective view of an exemplary modular pack saddle configured for a dromedary camel.

FIG. 37 Perspective view of an exemplary modular pack saddle configured for a bactrin camel.

FIG. 38 Perspective view of an exemplary modular pack saddle configured for an elephant.

FIG. 39 Exploded view of exemplary modular pack saddle deformable long load distribution assembly and tapered shims.

FIG. 40 Exploded detail view of an exemplary modular pack saddle long load distribution assembly.

FIG. 41 Perspective view of an exemplary legacy sawbuck pack saddle on a saddle pad.

FIG. 42 Exploded view of an exemplary legacy sawbuck pack saddle on a saddle pad with an exemplary long deformable load distribution assembly and adjustable tapered shims.

FIG. 43 Side view of an exemplary deformable saddle long load distribution spring.

FIG. 44 Perspective view of an exemplary deformable saddle long load distribution spring.

FIG. 45 Side view of an exemplary deformable long load distribution spring.

FIG. 46 Perspective view of an exemplary deformable long load distribution spring.

FIG. 47 Perspective view of an exemplary long load distribution spring showing detail of the scapular relief.

FIG. 48 Top view of an exemplary long load distribution spring showing detail of an elongated hole pattern.

FIG. 49 Side view of an exemplary deformable short load distribution spring.

FIG. 50 Perspective view of an exemplary deformable short load distribution spring.

FIG. 51 Top View of an exemplary deformable short load distribution spring.

FIG. 52 Perspective view of two exemplary deformable short load distribution springs secured end to end.

FIG. 53 Top view of two exemplary deformable short load distribution springs secured end to end.

FIG. 54 Side view of two exemplary deformable short load distribution springs secured end to end.

FIG. 55 Top view of two exemplary deformable short load distribution springs secured end to end.

FIG. 56 Perspective view of an exemplary deformable saddle short load distribution spring.

FIG. 57 Side view of an exemplary deformable saddle short load distribution spring.

FIG. 58 Top view of an exemplary deformable saddle short load distribution spring.

FIG. 59 Perspective view of an exemplary deformable primary leaf spring.

FIG. 60 Top view of an exemplary deformable primary leaf spring.

FIG. 61 Top view of an exemplary deformable primary leaf spring showing the detail of elongated and round hole pattern.

FIG. 62 Perspective view of an exemplary deformable secondary leaf spring.

FIG. 63 Top view of an exemplary deformable secondary leaf spring.

FIG. 64 Top view of an exemplary deformable secondary leaf spring showing the detail of elongated and round holes.

FIG. 65 Perspective view of an exemplary spring shim.

FIG. 66 Top view of an exemplary spring shim.

FIG. 67 Perspective view of an exemplary deformable secondary leaf spring assembly.

FIG. 68 Side view of an exemplary deformable secondary leaf spring assembly.

FIG. 69 Top view of an exemplary tapered contour shim.

FIG. 70 Perspective view of an exemplary tapered contour shim.

FIG. 71 Perspective view of an exemplary primary and secondary leaf spring assembly.

FIG. 72 Top view of an exemplary primary and secondary leaf spring assembly.

FIG. 73 Side view of an exemplary primary and secondary leaf spring assembly.

FIG. 74 Perspective view of an exemplary primary and secondary leaf spring assembly with an exemplary load bearing.

FIG. 75 Perspective view of an exemplary load bearing.

FIG. 76 Perspective view of an exemplary deformable long load distribution assembly configured for legacy pack and riding saddles.

FIG. 77 Side view of an exemplary deformable long load distribution assembly configured for legacy pack and riding saddles.

FIG. 78 Top view of an exemplary deformable long load distribution assembly configured for legacy pack and riding saddles.

FIG. 79 Side view of an exemplary deformable long load distribution assembly configured for a modular pack saddle with rails and an adjustable support mechanism.

FIG. 80 Perspective view of an exemplary deformable load distribution assembly configured for a modular pack saddle with rails and an adjustable support mechanism.

FIG. 81 Top view of an exemplary deformable short load secondary spring assembly.

FIG. 82 Perspective view of an exemplary deformable short load secondary spring assembly.

FIG. 83 Side view of an exemplary deformable short load secondary spring assembly.

FIG. 84 Perspective view of an exemplary deformable short load primary and secondary spring assembly.

FIG. 85 Top view of an exemplary deformable short load primary and secondary spring assembly.

FIG. 86 Side view of an exemplary deformable short load primary and secondary spring assembly.

FIG. 87 Side view of an exemplary legacy saddle deformable short load distribution assembly.

FIG. 88 Side view detail of an exemplary legacy saddle deformable short load distribution assembly.

FIG. 89 Perspective view of an exemplary modular animal pack saddle deformable double short load distribution spring/primary and secondary spring assembly with adjustable mounting rails.

FIG. 90 Side view of an exemplary modular animal pack saddle deformable double short load distribution spring/primary and secondary spring assembly with adjustable mounting rails.

FIG. 91 Top view of an exemplary modular animal pack saddle deformable double short load distribution spring/primary and secondary spring assembly with adjustable mounting rails.

FIG. 92 Exploded view of an exemplary legacy saddle short load distribution spring/primary and secondary spring assembly.

FIG. 93 Top view of an exemplary legacy saddle deformable short load distribution spring/primary and secondary spring assembly.

FIG. 94 Perspective view of an exemplary legacy saddle deformable short load distribution spring/primary and secondary spring assembly.

FIG. 95 Perspective view of an exemplary thwartship panel alignment spring.

FIG. 96 Front view of an exemplary thwartship panel alignment spring.

FIG. 97 Top view of an exemplary thwartship panel alignment spring.

FIG. 98 Perspective view of an exemplary legacy saddle deformable double short load distribution assembly.

FIG. 99 Side view of an exemplary legacy saddle deformable double short load distribution assembly.

FIG. 100 Front view of an exemplary legacy saddle deformable double short load distribution assembly.

FIG. 101 Top view of an exemplary legacy saddle deformable double short load distribution assembly.

FIG. 102 Perspective view of an exemplary adjustable rail sliding part.

FIG. 103 Front view of an exemplary adjustable rail sliding part.

FIG. 104 Perspective view of an exemplary angular adjustment part.

FIG. 105 Side view of an exemplary angular adjustment part.

FIG. 106 Front view of an exemplary adjustable support mechanism/angular adjustment part and slider part assembly adjusted for 90 degrees.

FIG. 107 Front view of an exemplary adjustable support mechanism/angular adjustment part and slider part assembly adjusted for 60 degrees.

FIG. 108 Perspective view of an exemplary top rail.

FIG. 109 Front view of an exemplary top rail.

FIG. 110 Perspective view of an exemplary hanger side rail.

FIG. 111 Perspective view of an exemplary side support rail.

FIG. 112 Perspective view of an exemplary 90 degree shelf rail.

FIG. 113 Top view of an exemplary 90 degree shelf rail.

FIG. 114 Perspective view of an exemplary top hanger support.

FIG. 115 Front view of an exemplary top hanger support.

FIG. 116 Perspective view of an exemplary universal cleat.

FIG. 117 Front view of an exemplary universal cleat.

FIG. 118 Front view of an exemplary universal cleat turned 180 degrees from the position shown in FIG. 117.

FIG. 119 Perspective view of an exemplary universal cleat part secured to side rail.

FIG. 120 Front view of an exemplary hanger load assembly.

FIG. 121 Side view of an exemplary hanger load assembly.

FIG. 122 Perspective view of an exemplary hanger assembly with 90-degree shelf rail.

FIG. 123 Perspective detailed view of an exemplary universal cleat secured hanger sail rail.

FIG. 124 Side view of an exemplary hanger assembly/Javelin Missile support.

FIG. 125 Side view of an exemplary hanger assembly/Javelin Missile support detail.

FIG. 126 Side view of an exemplary hanger assembly/Javelin Missile support detail.

FIG. 127 Side view of an exemplary hanger assembly/Javelin Missile support detail.

FIG. 128 Top view of an exemplary side stabilization pad.

FIG. 129 Perspective view of an exemplary side stabilization pad.

FIG. 130 Top view of an exemplary side stabilization pad rail connector.

FIG. 131 Side view of an exemplary side stabilization pad rail connector.

FIG. 132 Top view of an exemplary side stabilization pad rail assembly.

FIG. 133 Perspective view of an exemplary side stabilization pad rail assembly.

FIG. 134 Perspective view of an exemplary locking collar clamp assembly in an open position.

FIG. 135 Perspective view of an exemplary locking collar clamp assembly in a closed position.

FIG. 136 Perspective view of an exemplary short pipe rail.

FIG. 137 Perspective view of an exemplary long pipe rail.

FIG. 138 Perspective view of an exemplary dual load winch assembly.

FIG. 139 Perspective view of an exemplary load winch.

FIG. 140 Perspective view of an exemplary load winch with rope.

FIG. 141 Side view of an exemplary load winch cheek plate.

FIG. 142 Perspective view of an exemplary load winch assembly detail with rope.

FIG. 143 Perspective view of an exemplary load winch assembly detail without rope.

FIG. 144 Front view of an exemplary load winch assembly rail locking part.

FIG. 145 Perspective view of an exemplary load winch assembly rail locking assembly.

FIG. 146 Perspective view of an exemplary three-dimensional angular animal back measurement instrument on an animal's back.

FIG. 147 Perspective view of an exemplary three-dimensional angular animal back measurement instrument mounted within a saddle.

FIG. 148 Side view of an exemplary computer saddle interface pressure sensor array on animal's back.

FIG. 149 Top view of an exemplary computer saddle interface pressure sensor array on animal's back.

FIG. 150 Exploded front view of an exemplary computer saddle interface pressure sensor array on animal back in relationship with the modular pack saddle.

FIG. 151 Front view of an exemplary computer saddle interface pressure sensor scan screen image.

FIG. 152 Flow chart of an exemplary method to adjust an exemplary load distribution assembly to the pack animal, employing three-dimensional angular measurement and computer interface pressure measurement for an exemplary modular animal pack system.

FIG. 153 Flow chart of an exemplary method to adjust an exemplary load distribution assembly to the pack animal, employing three-dimensional angular measurement and computer interface pressure measurement for legacy pack saddles or riding saddles.

FIG. 154 Isometric view of an exemplary universal cleat.

FIG. 155 Front view of the universal cleat of FIG. 154.

FIG. 156 Expanded isometric view universal cleats of FIG. 154 positioned in different orientations between frame members.

FIG. 157 Expanded isometric view of the universal cleat of FIG. 154 supported between frame members in an optional orientation.

FIG. 158 Front view of the exemplary universal cleat and frame members shown in FIG. 157.

FIG. 159 Expanded isometric view illustrating the universal cleat of FIG. 154 supported between frame members in an additional optional orientation.

### DETAILED DESCRIPTION OF THE DISCLOSURE

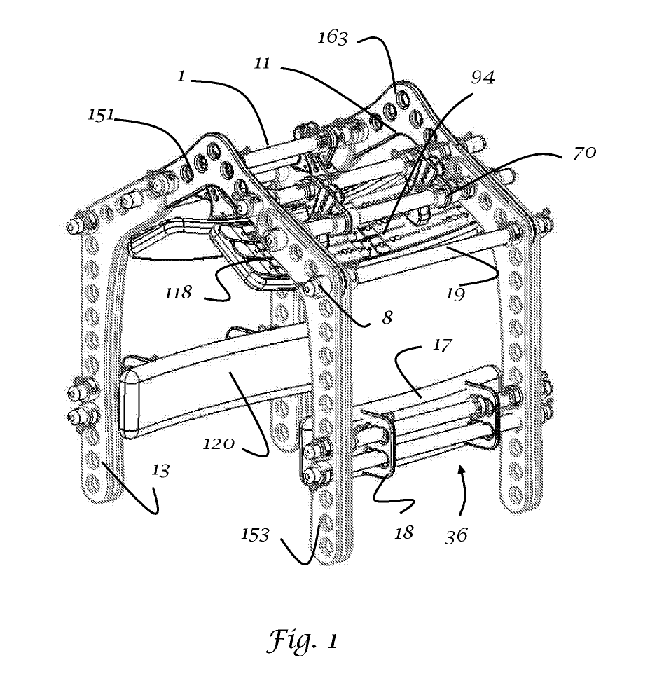

Referring to the figures, FIG. 1 shows an exemplary modular animal pack saddle frame at 1. Saddle frame 1 may include a first U-shaped frame assembly 1a and a second U-shaped frame assembly 1b attached by a plurality of pipe rails 19, also referred to generally as transverse members or bars. The depicted frame includes of two top rails 11 spaced apart by a round pipe rail 19 that is attached through holes 151 formed in the top rails. The holes may have a dual functionality of permitting the parts to be assembled employing a locking collar clamp mechanism 8, also referred to generally as a mounting device, while also significantly reducing the weight of the individual parts. The sides of the pack frame may be constructed by employing a side support rail 13 attached through holes 153 formed in the side support rail coincident to the respective holes 151 in the top rails 11, permitting adjustment for width and length in order to accommodate a variety of size and species of animals.

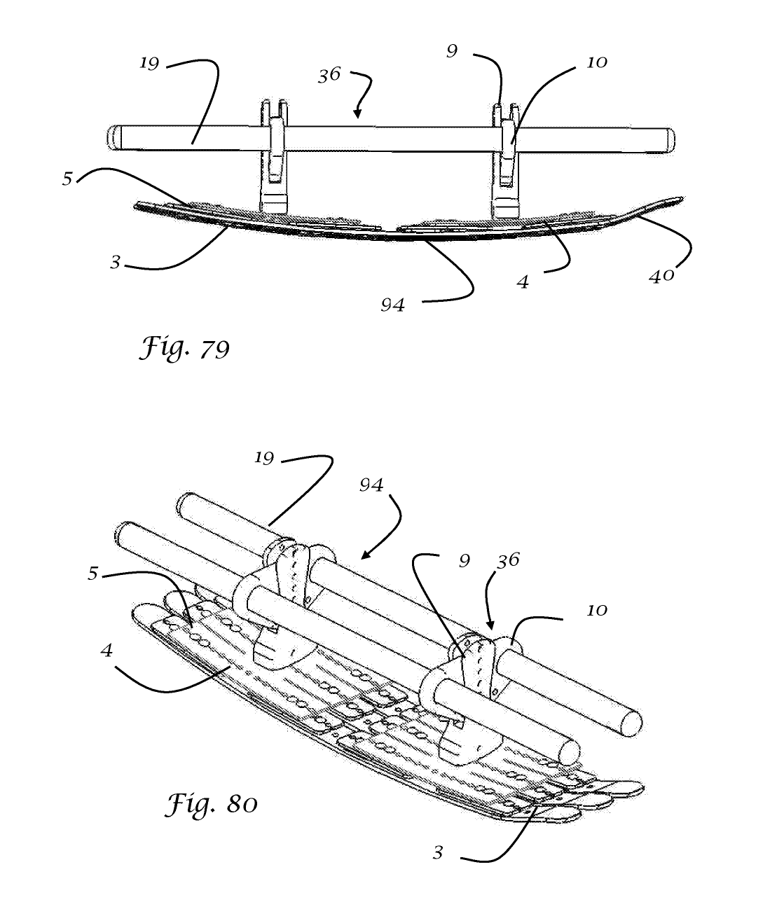

In order to distribute the pressure created by the weight of the load upon the animals back, a deformable weight or load distribution assembly 94 may be secured to the pack frame by an attachment mechanism 36 attaching the frame to the load-distribution assembly. In some embodiments, the attachment mechanism may include a paired set of pipe rails 19 and/or an adjustable angular sliding support assembly 10 (shown in FIGS. 79-80). The sliding support assembly 10 may be attached to both pipes 19.

In order to stabilize the pack frame on the animal so that a variety of different cargo can be stably carried at a faster pace, a side support assembly 120 may be secured to the pack frame by a paired set of pipe rails 19 on the perpendicular section of the frame though holes 153, and through a side support device 18.

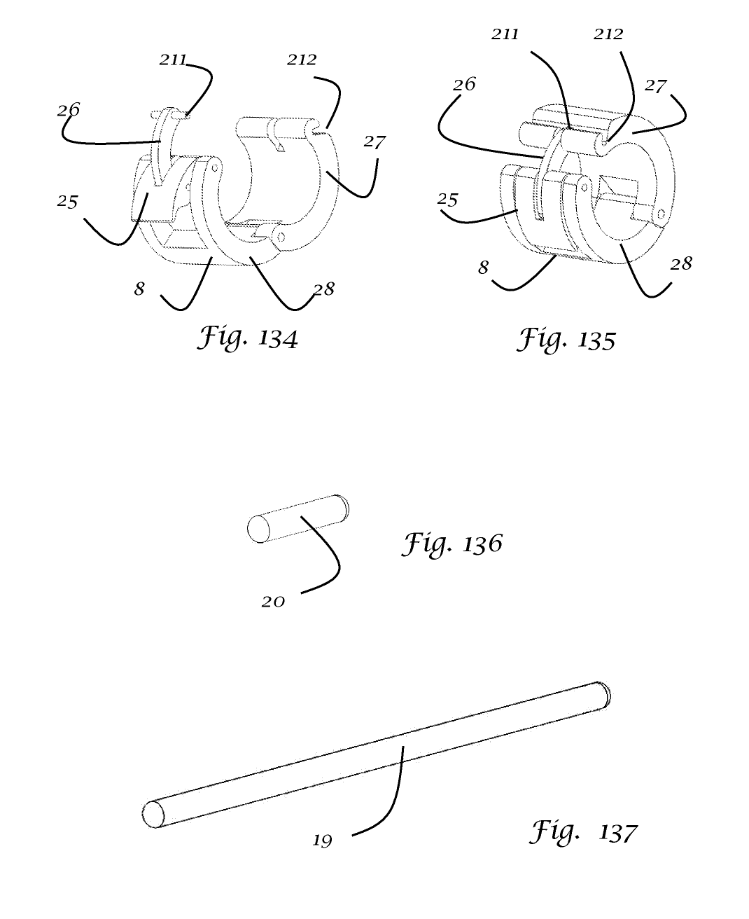

One or more elements may be provided in order for the pack frame to remain rigid and/or in order for the parts not to move on the pipe relative to one another. For example, any or all of the above parts may be secured onto the pipe by placing locking collar mechanism 8 adjacent to the respective parts. Locking collar mechanisms 8 may be adapted to clamp or compress around the pipe itself. Accordingly, the locking collar mechanisms may selectively open and close, as shown in FIGS. 134-135, so that the locking collar mechanism can be placed on the pipe at any location adjacent to any part to prevent further movement, without sequentially placing a variety of parts on the respective rails. This locking collar mechanism may be opened and then locked by securing a locking “T” 26 onto an upper collar part 27 and a pressing lever tab 25 down to be coincident with the radius of a lower collar part 28. This method of assembly may eliminate the need for tools to assemble or disassemble the pack saddle frame 1 when changing from one configuration to another configuration.

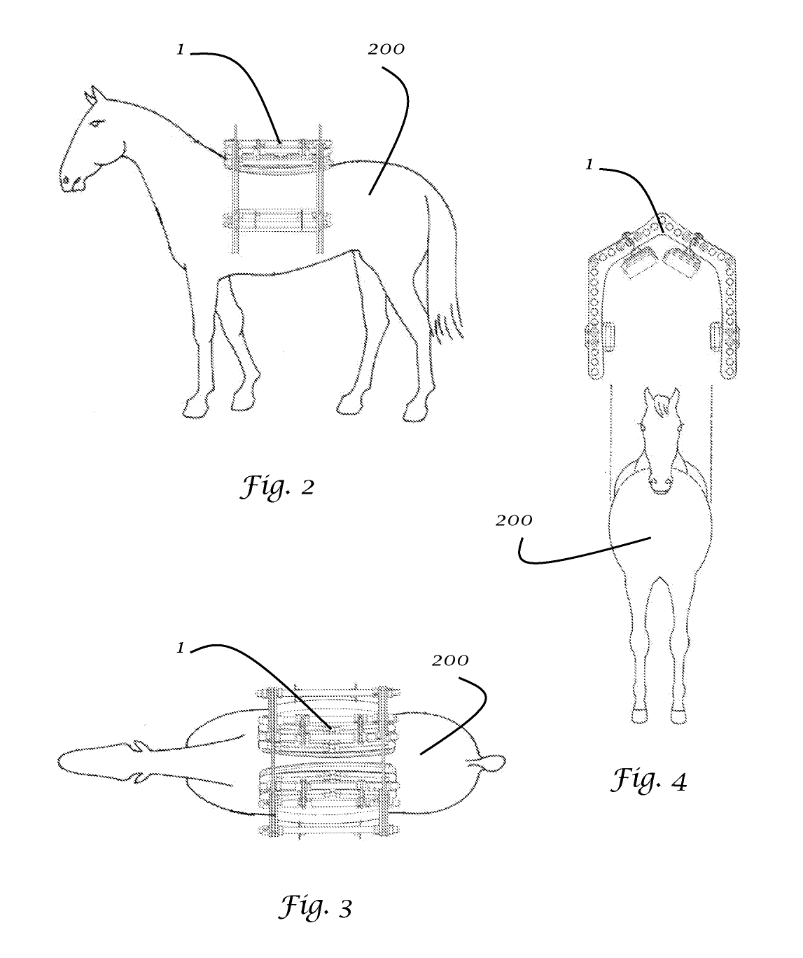

FIGS. 2, 3, and 4 show side, top, and front views, respectively, of exemplary modular pack frame 1 placed on an animal 200, in this illustration a horse. However, other animals can also be accommodated in a similar method, in order that additional parts may be attached that accommodate a wide variety of different cargos. Additionally and/or alternatively, the load-carrying animal in some examples may be a person, or it may be a robot (mechanical animal) providing a horizontal load-carrying structure.

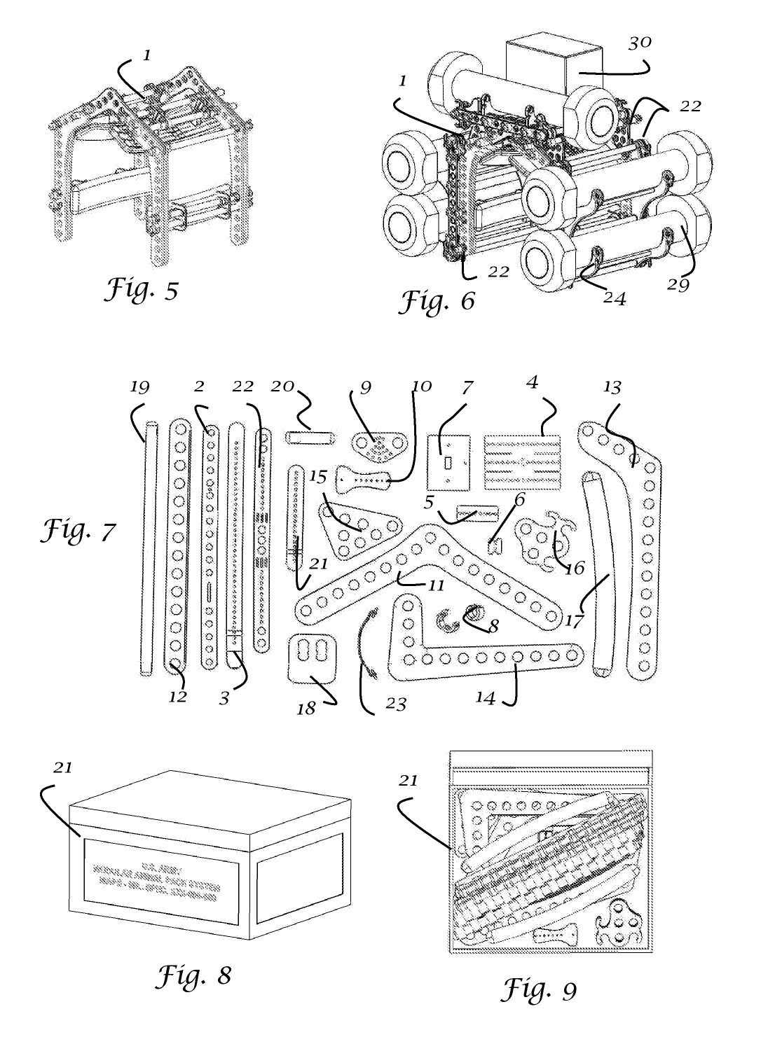

Referring to FIG. 5, base modular animal pack frame 1 is shown in a base state that may permit additional parts to be attached in a similar manner so that a wide variety of different cargos may be transported. For example, FIG. 6 illustrates modular animal pack frame 1 fitted with a hanger load assembly 24. In this example, a Javelin Missile system hanger 29 is attached to the modular pack frame with a universal cleat 16, which will be shown and described later.

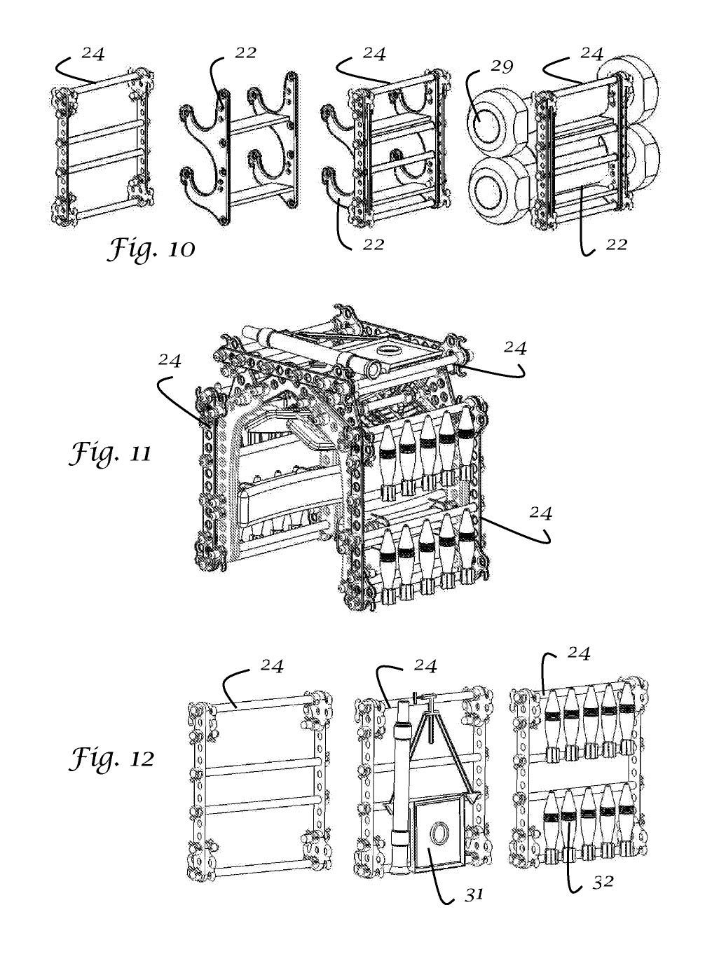

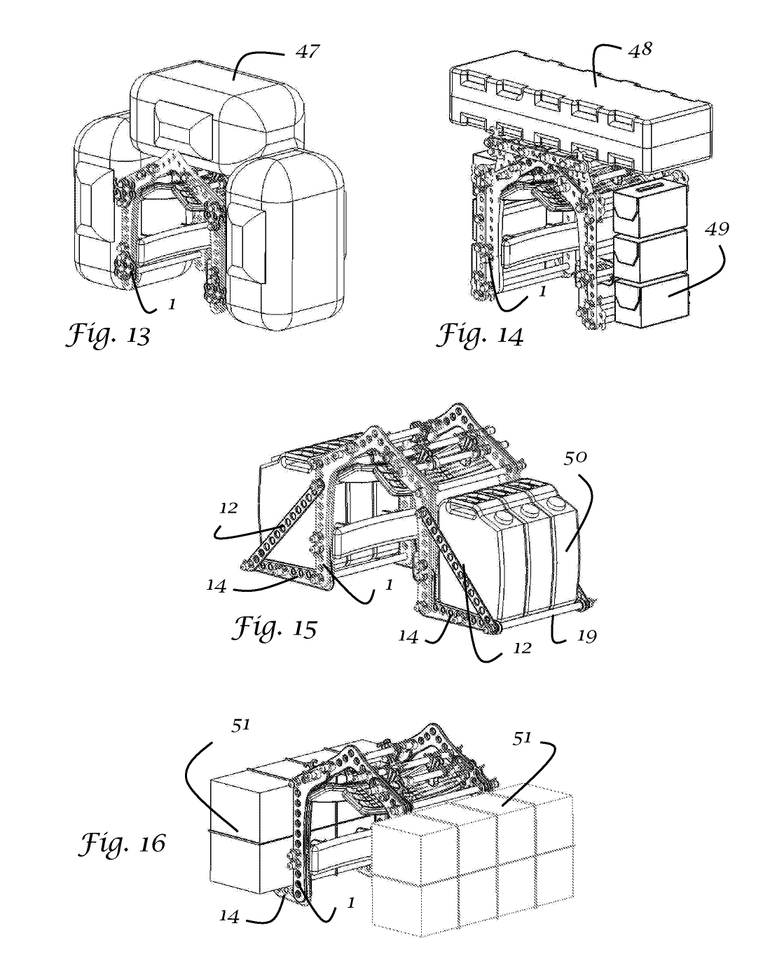

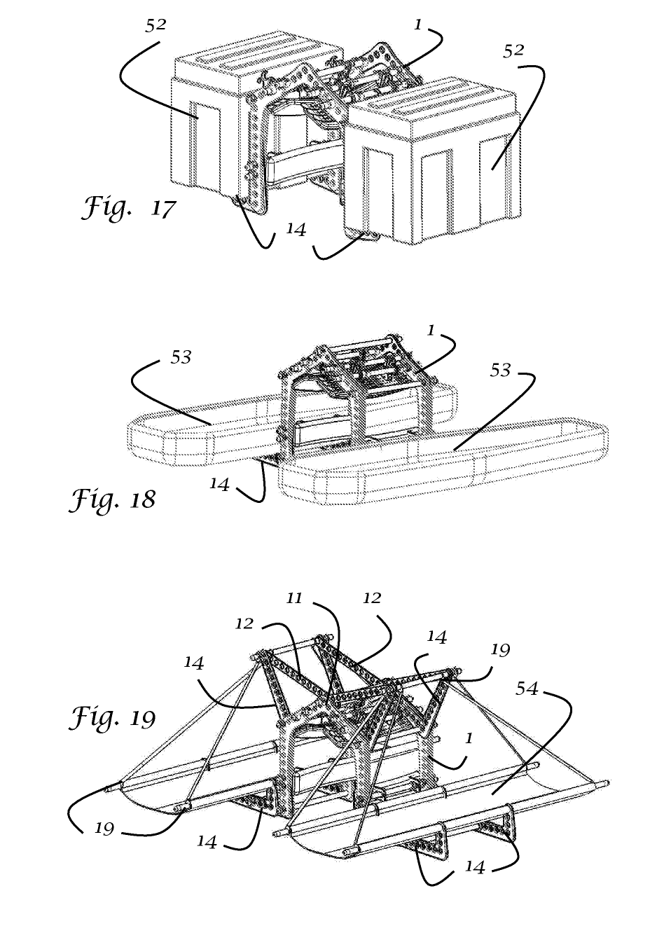

The disclosed modular animal pack saddle may be constructed with a finite number of parts that may be adapted create a wide variety of different configurations to be able to carry a wide variety of different cargos. FIG. 7 shows a plurality of parts of an exemplary system, which may include the following:
2—Saddle Panel Long Load Distribution Spring
3—Deformable Long Load Distribution Spring
4—Primary Leaf Spring
5—Secondary Leaf Spring
6—Leaf Spring Shim
7—Tapered Contour Shim
8—Locking Collar Assembly—open and closed
9—Adjustable Support Mechanism/Rail Sliding Part
10—Adjustable Support Mechanism/Angular Adjustment Part
11—Top Rail frame member
12—Hanger Side Rail frame member
13—Side Support Rail frame member
14—90 Degree Shelf frame member
15—Top Hanger Support
16—Universal Cleat
17—Side Stabilization Pad
18—Side Stabilization Pad Rail Connector
19—Pipe Rail/long
20—Pipe Rail/short
21—Short Load Distribution Spring
22—Saddle Short Load Distribution Spring
23—Thwartship Panel Alignment Spring

In one embodiment of the present disclosure, a kit including a plurality of frame members for a load-supporting saddle is provided. Each frame member may extend rigidly in a member plane and may include a first section and a second section, extending transverse to the first section in the member plane. The first and second sections of a frame member may be substantially equal length. Additionally and/or alternatively, the length of the first and second sections may vary. The frame members may be adapted to be attached together to form a first frame assembly, which during use, may be a downwardly-open arch and may be sized to receive the back of a load-carrying animal. In some embodiments the member planes of the plurality of frame members in the assembled first frame assembly may be parallel. A frame member in accordance with the present disclosure may include a rail, a top rail, a hanger side rail, a side support rail, a shelf, a 90 degree shelf, a support, a top hanger support, and/or any other frame member known in the art or suitably configured for a particular application.

A transverse member may be adapted to be supported on at least one frame member so that it extends transverse to the member plane of the one frame member. The transverse member may also be transverse to the frame assembly, and may extend along the back of the load-carrying animal during use. In accordance with the present disclosure, a transverse member may include a pipe, a pipe rail, a frame member and/or any other transverse member known in the art.

In some embodiments, at least a portion of the frame members have a plurality of holes, otherwise generally referred to as frame-mounting stations, disposed along the lengths of the sections and the transverse member may include ends that are configured to engage the frame-mounting stations. At least a portion of the frame-mounting stations may be disposed in a regular pattern along at least a portion of a frame member. For example, the frame-mounting stations may be spaced equally apart. Frame mounting stations may have the same or varying sizes.

At least a portion of the frame-mounting stations in the first and second sections of a frame member may extend rectilinearly. Further, the frame-mounting stations in the first and second sections of a first frame member may be disposed along respective lines. The line of frame-mounting stations in the first section of the first frame member may be at a first member angle relative to the line of frame-mounting stations in the second section of the first frame member. Similarly, the frame-mounting stations in the first and second sections of a second frame member may be disposed in respective lines, and the line of the frame-mounting stations in the first section of the second frame member may be at a second member angle relative to the line of the frame-mounting stations in the second section of the second frame member. In such embodiments, the first section of the first frame member may have a length that is different than lengths of the first and second sections of the second frame member. The first frame-member angle may be the same as, or different then, the second frame-member angle.

A first frame assembly and a transverse member may be adapted to be assembled to form a frame for supporting a load to be carried by a load-carrying animal. In some embodiments of the kit, a plurality of frame members may be adapted to be attached together to form first and second U-shaped frame assemblies supported in spaced-apart positions along the back of the load-carrying animal by one or more transverse members. In some embodiments, the transverse members may include bars, and the frame-mounting stations may include holes in the frame members, and the bars may be sized to extend at least partially into the holes. Furthermore, a plurality of mounting devices may be configured to attach to at least one bar for securing the position of the one bar in an associated hole of a frame member.

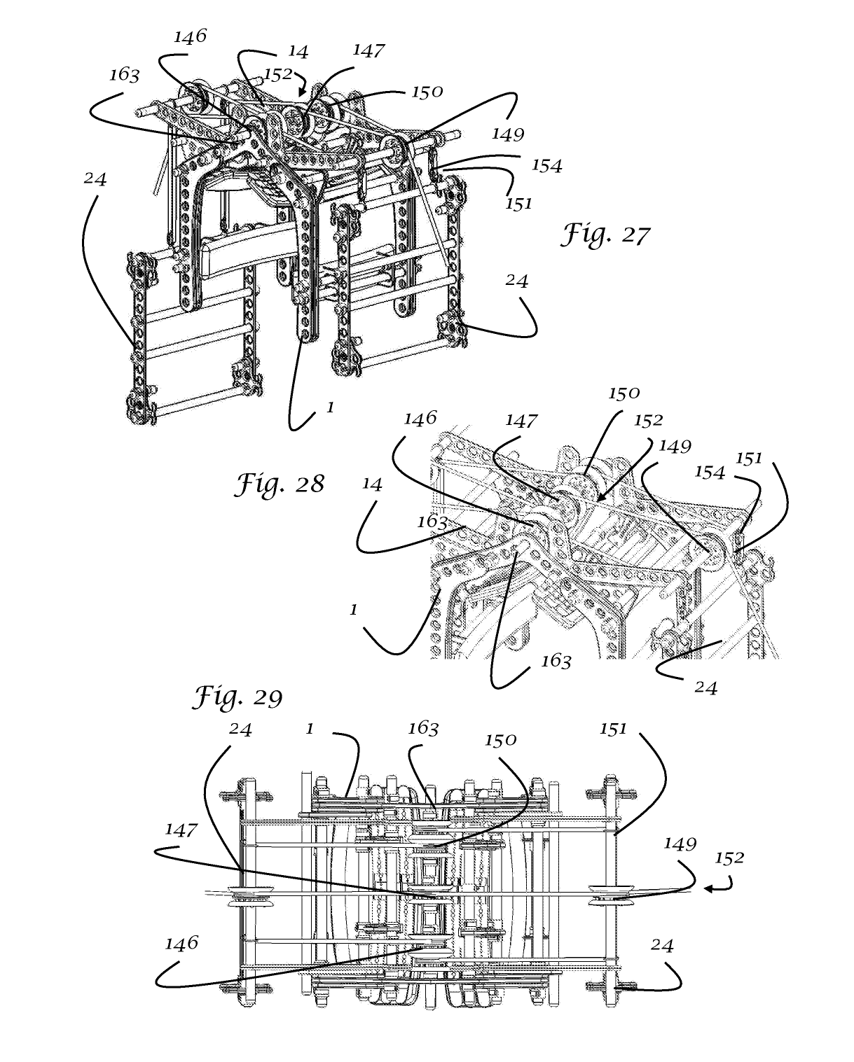

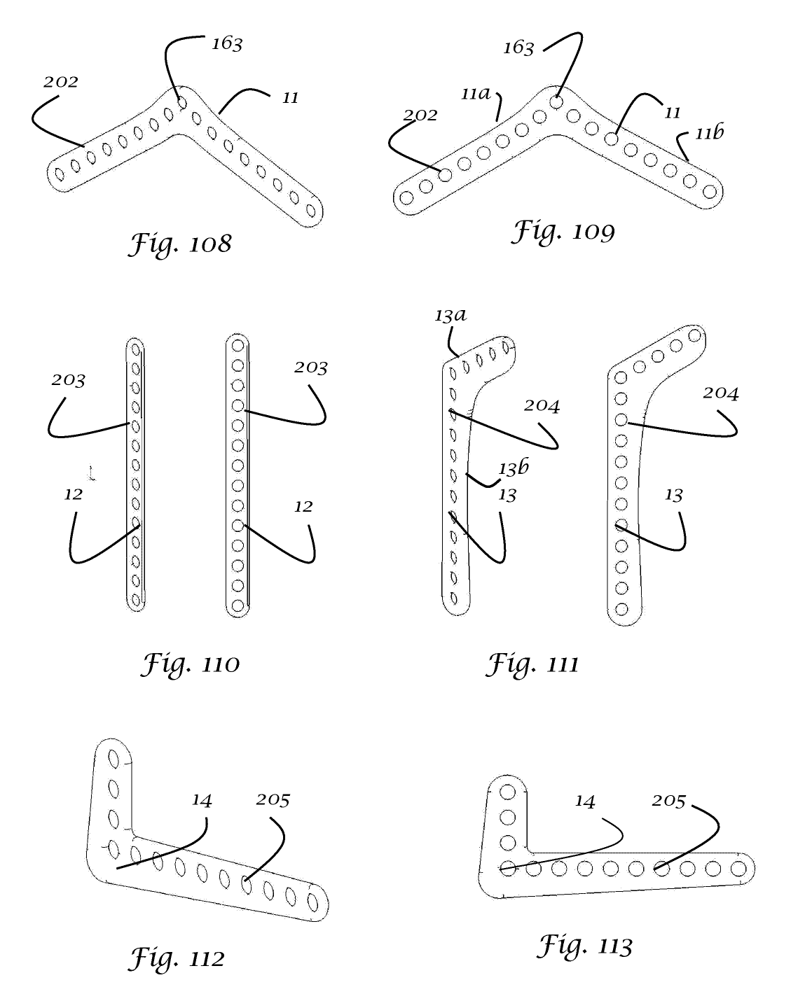

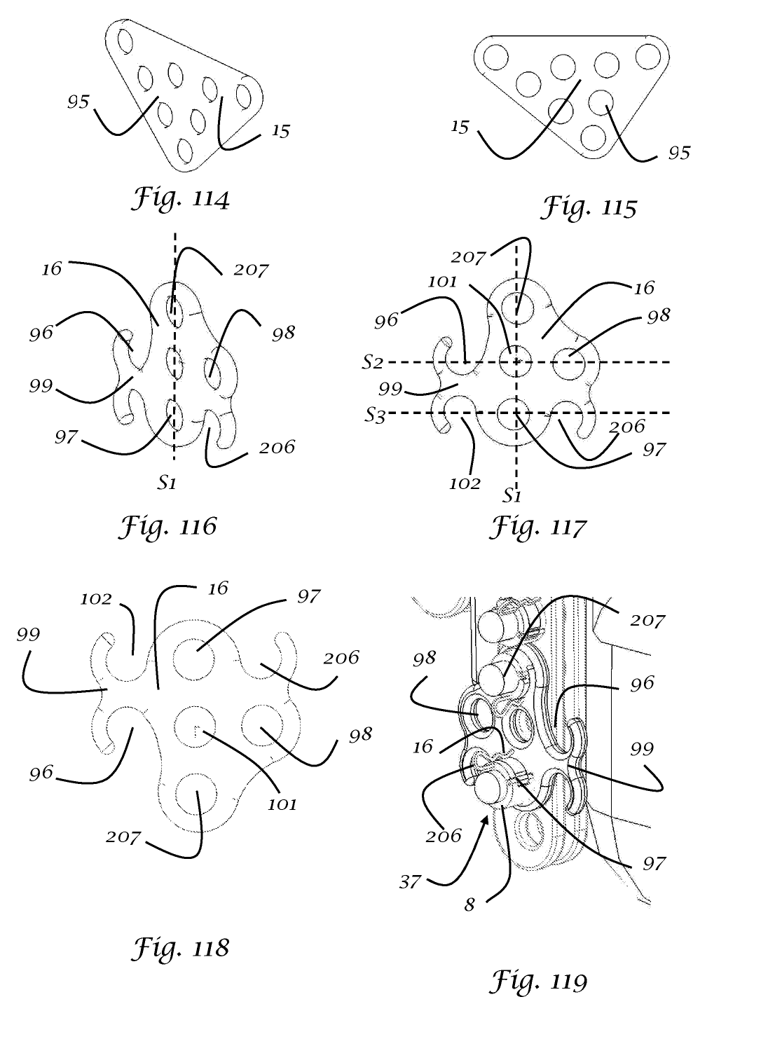

The kit may also include a weight-transferring assembly adapted to be attached to the assembled frame, for transferring weight of a load received by the frame onto the back of the load-carrying animal. An embodiment of a weight-transferring assembly is described in greater detail below and in reference to FIGS. 40-107. The kit may also include a hoist assembly for raising a load vertically toward the frame while the frame is supported by the load-carrying animal. An embodiment of a hoist assembly is described in greater detail below and in reference to FIGS. 27-29 and FIGS. 138-145. Further, the kit may also include a universal cleat, also generally referred to as a multiply-positionable link, for attaching an object to a load-carrying frame. An embodiment of a link is described in greater detail below and in reference to FIGS. 22-23 and FIGS. 116-119.

Pack saddles, by their nature, are large enough to be able to fit on large animals, and therefore may be cumbersome to transport in an in-use state. This becomes a serious logistical issue when moving a large amount of cargo, as required in a disaster-relief environment or in military operations that require a large number of animals and, in turn, pack saddles.

The disclosed modular animal pack apparatus may be highly transportable in a disassembled state. For example, modular animal pack saddle apparatus 1 may be adapted to be disassembled and reduced in size to fit within a modular size box 21, as shown in FIG. 8, that may fit on a U.S. Commercial Pallet or 463L Military Pallet. FIG. 9 illustrates the parts of modular animal pack saddle 1 shown in FIG. 7, nested in box 21.

Referring to FIG. 10, an exploded view of a Javelin Missile 29 hanger load including a base hanger assembly 24 and an attachment 22 is shown. The hangar load can be made to fit a variety of different pieces of equipment, such as Javelin Missile 29, that can be attached to hanger 24. The hangar may be attached to modular animal pack frame 1 with universal cleat 16.

In an alternate configuration, FIG. 11 illustrates three base hangers 24 attached to the top and to the sides of the frame. FIG. 12 shows the three hangars of FIG. 11 side-by-side. A mortar 31 may be attached to the hangar on the top of the frame. Similarly, rockets 32 may be attached to the hangar on the sides.

FIGS. 13-17 illustrate non-exclusive exemplary configurations that can be formed by the disclosed modular animal pack saddle in order to transport other exemplary cargo options. Other uses or cargos for the disclosed apparatus include laying barbed wire, moving logs, fire water pumps for fire suppression, etc. This disclosed modular animal pack saddle may be considered to be similar to an erector set that can be reconfigured into virtually an infinite number of configurations.

In the embodiment depicted in FIG. 13, modular animal pack saddle frame 1 is shown configured for carrying three 80 lb back packs 47. In the embodiment depicted in FIG. 14, the modular animal pack saddle frame is shown configured for hauling one or more sniper rifles in a protective case 48 and one or more 50-caliber ammunition cases 49.

In the embodiment depicted in FIG. 15, the modular animal pack saddle frame is shown with several 90 degree shelf parts 14 attached and supported to handle the additional weight. Hanger side supports 12 may be secured through the respective holes by pipe 19 and secured from movement by the locking collar 8. The configuration in FIG. 15 may be used in order to carry water and/or fuel cans 50.

In the embodiment depicted in FIG. 16, the modular animal pack saddle frame is shown with 90 degree shelf part 14 attached without the hanger support 12. In this configuration, the apparatus may be used to carry a manatee 51 and/or a lash load of an aggregate of different items of cargo. The cargo may be covered by a large tarp and lashed with rope and then attached to the pack frame, resting on the 90 degree shelf parts 14. The load may be attached by using the attachment holes to lace the rope and then secure the rope to universal cleat 16, as will be described in detail below. In this configuration, no knots may be required to secure the load.

In the embodiment depicted in FIG. 17, the modular animal pack saddle frame is shown with 90 degree shelf part 14 reversed and secured to the modular animal pack saddle frame 1. In this configuration, the apparatus may be used to accommodate Military 463L Pallet boxes 52. Since the box has its own structure the 90-shelf part may align the box to the pack frame. The box may be attached by using the attachment holes to lace the rope and securing the rope to universal cleat 16. Like the configuration shown in FIG. 16, this configuration, may not employ knots to secure the load.

FIGS. 18-20 illustrate different configurations of the disclosed apparatus that may be used to transport injured individuals with pack animals. For example, FIG. 17, illustrates modular animal pack saddle frame 1 employing 90 degree shelf 14 to secure a stokes stretcher 53. Further, FIG. 19 illustrates a military folding litter 54 that may employ a variety of parts from the pack saddle to create a stable structure using modular animal pack saddle frame 1. A number of 90 degree shelf 14 parts may be used to stabilize the folding litter. For example, two 90 degree shelf parts 14 may be connected in an opposing configuration using pipe rail 19 and locking collars 8. The connected 90-degree shelf parts may be connected to the frame, also using pipe rail 19 and locking collars 8. To achieve additional support from above, four 90 degree shelf 14 parts may be attached to top rail 11 of modular animal pack saddle frame 1. These 90 degree shelf parts may be further stabilized by attaching hanger side supports 12 by aligning respective holes on the top rail 11 and employing pipe 19 and the locking collar mechanism 8. In this manner, the ends of the litter can be secured by rope or webbing when traveling in rough terrain.

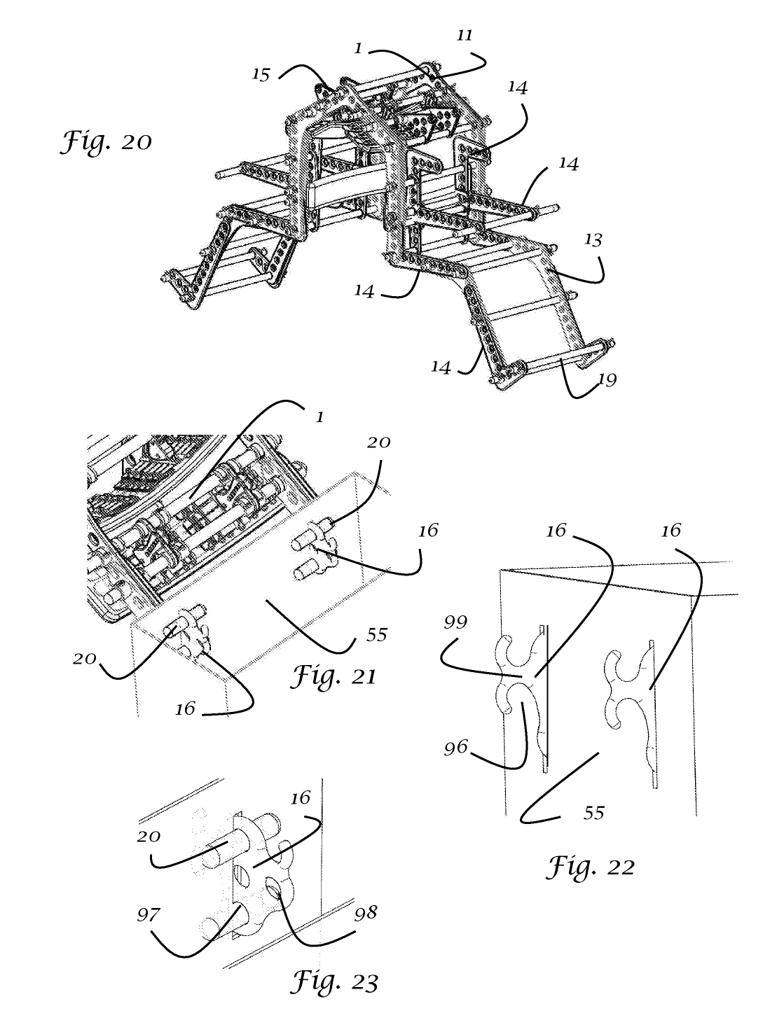

FIG. 20 illustrates a further embodiment of the disclosed apparatus. In this example, parts from a number of modular animal pack saddle frame 1 could be reconfigured into a evacuation litter chair, 15 (duplicate number). By aligning a number of 90 degree shelves 14 and side support rails 13 on the animal pack saddle frame, a secure method of evacuation of two injured individuals could be facilitated on trails where there are switchbacks on the trail.

FIGS. 21-23 illustrate other non-exclusive examples of attaching cargo to the disclosed apparatus. FIG. 21 illustrates an exemplary embodiment of modular animal pack saddle 1 configured to carry cargo boxes 55, which may include a slot or rectangular hole 97. In this configuration, universal cleat 16 and pipe rail 20 may secure the box to the frame. FIG. 22 shows the portion of universal cleats 16 outside the box that may permit the box to be hung on the pack frame. For example, an attachment hook 96 may be formed on the universal cleat. The attachment hook may be mated with pipe rail 19 or similar members. FIG. 23 shows the portion of the universal cleat inside the box. A short pipe rail 20 may secure the universal cleat by means of attaching the short pipe rail through respective holes 97.

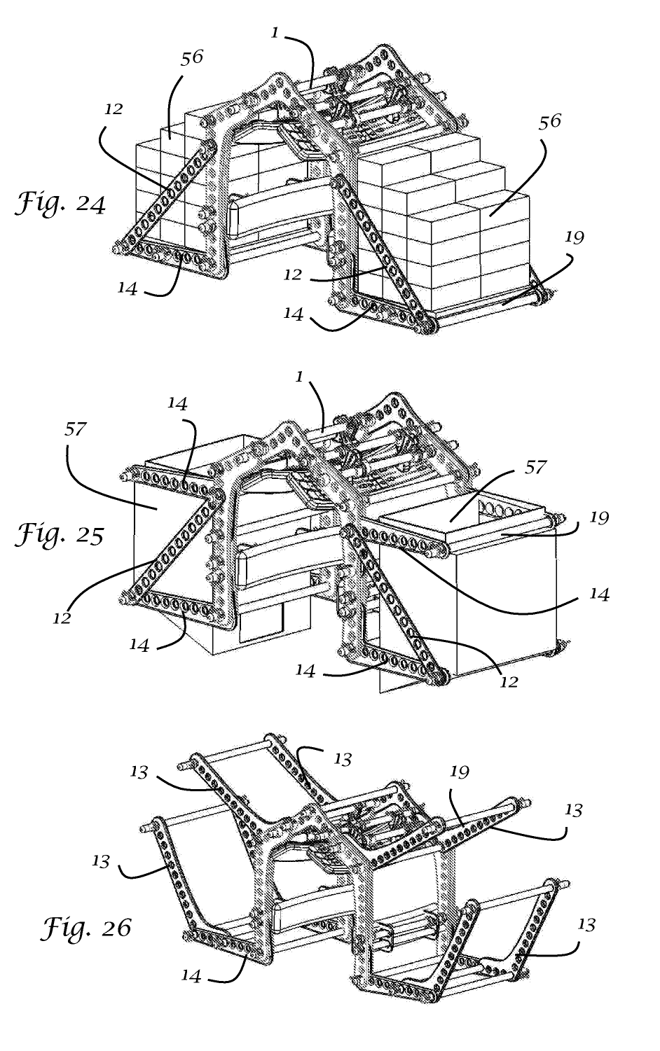

While applications of the apparatus of the present disclosure in military operations have been shown, the apparatus may also be used to employ animal traction in civilian applications. For example, FIG. 24 illustrates animal pack saddle frame 1 in a configuration for the movement of bricks 56. The same configuration could be used to move rock. The modular animal pack saddle frame may be configured with the 90-degree shelf 14 and additional hanger side support 12, which may be secured in position by the employment of pipe 19 and locking collar 8. On a variation of the configuration of FIG. 24, the configuration of FIG. 25 uses four more 90 degree shelves 14 to secure a gravel box 57 to gain additional stability.

Further, the apparatus of the present disclosure may be used to move cumbersome light cargo, such as loose hay for feeding pack animal and branches for kindling. FIG. 26 illustrates modular animal pack saddle 1 configured as a hay hauler 179, by using a plurality of 90-degree shelves 14 and a plurality of side support rails 13 parts to create a cradle to secure such loose cargo.

Loading the modular animal pack saddle may present challenges. For example, if the animal can carry 200 pounds of cargo, the load is 100 pounds per side. If the cargo is only carried in one container per side of the animal, it must be lifted and secured to the pack saddle in sequence. Lifting 100 pounds may be difficult, for even two packers. Further, even when it is lifted and secured, the pack saddle may twist toward the heavier side until the other side is loaded to balance the load. Keeping the saddle from shifting during that time requires tightening the girth significantly, which may irritate the animal. This may set up the potential for an accident, as the animal may move during the process to get away from the load. Alternatively, assuming there are four packers available, the four packers may lift the load simultaneously.

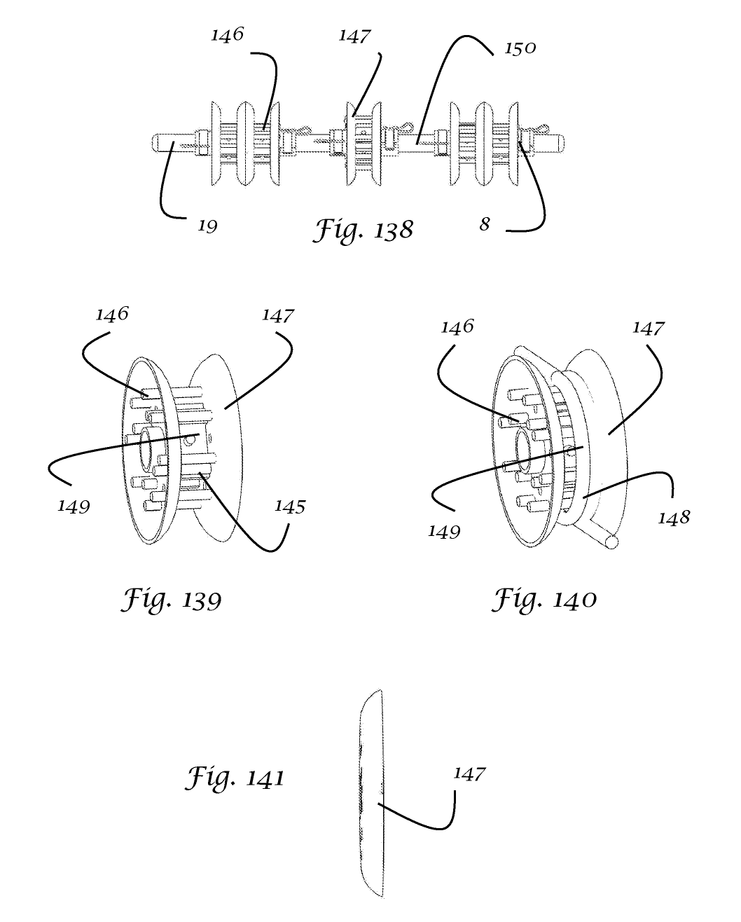

As described with reference to FIGS. 27-29, and later with reference to FIGS. 138-145, some embodiments of a saddle in accordance with the present disclosure may include a frame for supporting a load and a hoist assembly for raising a load vertically toward the frame while the frame is supported by the load-carrying animal. The hoist assembly may include a first support member supported on the frame, extending laterally of the animal beyond a first side of the frame, for example the left or right side of the frame. In accordance with the present disclosure, a support member may include one or more of a side rail, a support rail, a shelf, a support, a pipe and/or any other support member known in the art.

A first guide element may be supported by the first support member. The first guide element may be at a position disposed horizontally beyond the first side of the frame so that a first cord, or rope, may hang downwardly from the first guide element along a line spaced from the frame. A guide element may include a rail or pipe rail, a pulley, a winch, a winch system and/or any other suitable guide element.

A second support member may also be supported on the frame. The second support member may extend laterally beyond a second side of the frame opposite the first side. A second guide element may be supported by the second support member at a position disposed horizontally beyond the second side of the frame so that a second cord hanging downwardly from the second guide element is spaced from the frame.

The hoist assembly may further include a winch assembly, including a first spool section, also sometimes referred to as a winch drum, and a drive mechanism rotatingly mounting the first spool relative to the frame. The drive mechanism may be operable in a hoisting mode for rotating the first spool section relative to the frame, thereby winding the first cord while the first cord is attached to the first spool section. The drive mechanism may include a shaft, also referred to as a pipe rail, on which the first spool section is mounted. A second spool section may also be mounted on the shaft and may be operable in a manner similar to the first spool section. The shaft may be rotated by unwinding a second cord wound on the second spool section. A third spool section may also be mounted on the shaft and the shaft may be rotated by unwinding a third cord wound on the third spool section.

Turning to FIGS. 27-29, the system of the present disclosure may be configured as a winch system 150, also referred to generally as a hoist assembly, as shown in FIG. 27. A plurality of winch drums 146 and 147, also referred to generally as spool sections, may be aligned and locked to common pipe rails 19 by means of a locking mechanism 145 (as shown particularly in FIGS. 142-145). The winch drums may be secured in position relative to each other with locking collar 8, and are referred to collectively as a drive mechanism 152. For example, five winch drums may be used to configure the winch assembly using holes 163 and the corresponding point on opposite top rail 11 as a bearing to permit the rotation of the assembly 150. Winch drums 146 and 147 may lock onto a common shaft 19. Thereby, when the center drum is turned, the four outboard drums may turn in concert.

With reference to FIGS. 28 and 29 and with continued reference to FIG. 27, the four outboard drums may be attached to a block and tackle assembly 151 with the tackle including a pulley forming a guide element 154. By adding several 90 degree shelf parts and several top hanger supports 15 and pipe rails 19, also referred to collectively and/or separately as a support member, an additional drum 149, also referred to as a guide element, can be added as an idler drum and attached to the center drum 147 on winch assembly 150. Pulling on a rope attached to winch idler drum 149 may pull the rope on the center drum 147 on winch assembly 150. This may rotate outboard winch drums 146 that are attached to block and tackle assemblies and thereby, simultaneously on four lift points, lift the load on both sides of the animal. One packer may therefore load the animal with little or no effort. The load may also be evenly balanced and progressively loaded on the animal. Accordingly, the load may be placed on the saddle without excessive girth pressure.

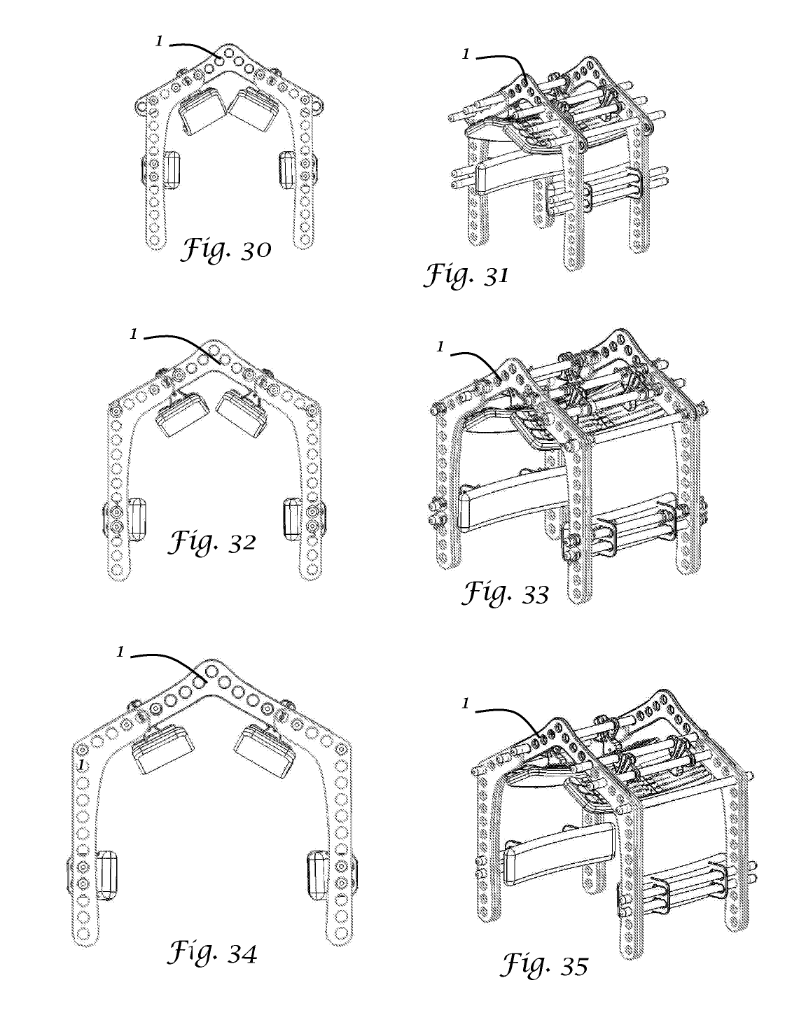

FIGS. 30-35 illustrate the system of the present disclosure configured to accommodate a wide variety of animals. For example, FIGS. 30-31 illustrate modular animal pack saddle frame 1 configured to accommodate a smaller animal, such as a burro, a donkey, or a llama. FIGS. 32-33 illustrate the modular animal pack saddle frame configured to fit an intermediate size animal such as a horse or mule. Further, FIGS. 34-35 illustrate the modular animal pack saddle frame configured to fit a larger animal, such as an ox or yak. By adjusting the relative position of the holes in top rail 11 relative to side support rail 13 and moving the corresponding pipe rail 19 to the appropriate corresponding holes, a wide variety of species can be fitted with the system.

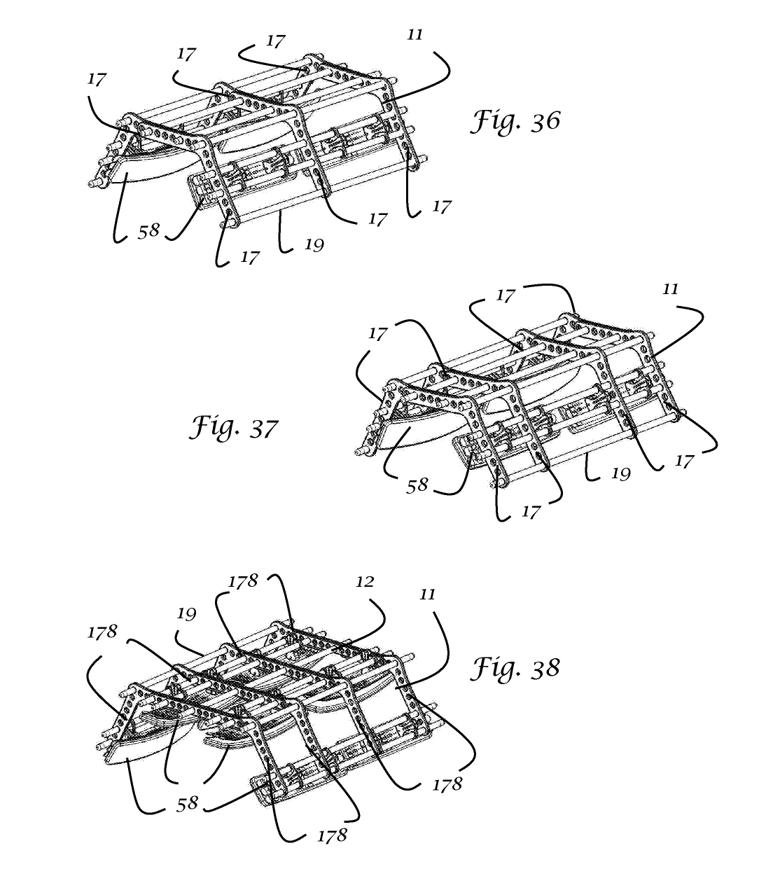

Referring now to FIGS. 36, 37 and 38, the system of the present disclosure may be reconfigured in a completely different manner to fit larger animals such as camels or elephants, by using several top rails 11 as the main frame to create the top as well as the sides of the frame, rather than employing side support rails. Additionally, instead of the two deformable load distribution assemblies employed with smaller animals, an additional set of the load distribution assemblies may be required for larger animals, to achieve four or even eight or more separate loading points, creating a greater surface area to accommodate significantly larger cargo weight.

Because of the unusual shape of the camel, the Dromedary being different than Bactrin, a different configuration may be required for each. For example, FIG. 36 shows the system configured to accommodate the Bactrin camel, which has two humps. Specifically, FIG. 36 shows frame rails 17, which may be composed of at least two top rails 11, secured by pipe rail 19 through the corresponding holes and secured in relative position by locking collar 8. Alternatively, FIG. 37 shows the system in a different configuration to accommodate the one hump of the Dromedary Camel. In FIG. 37, the position of frame rails 17, which may also be composed of two or more top rails 11, may be secured by pipe rail 19, through the corresponding holes and secured in relative position by locking collar 8. The relative position of the side supports may be changed to accommodate the different animal back shapes.

The system may also accommodate an elephant, which is significantly larger than other animals. For example, FIG. 38 illustrates the modular animal pack saddle configured with additional load distribution assemblies 58. In some examples, a total of eight or more load distribution assemblies may be used, with four on the back of the animal adjacent to the spine and an additional four on the side to stabilize the frame for the load.

With continued reference to FIG. 38, frame rails 178 may be formed by two or more top rails 11 and at least one hangar side support 12. These elements may be secured by pipe rails 19 through the corresponding holes, and secured in relative position by locking collar 8. In order to achieve the greater width required for animals of larger girth, the hanger side supports 12 may be attached the ends of top rails 11, to create frame 178.

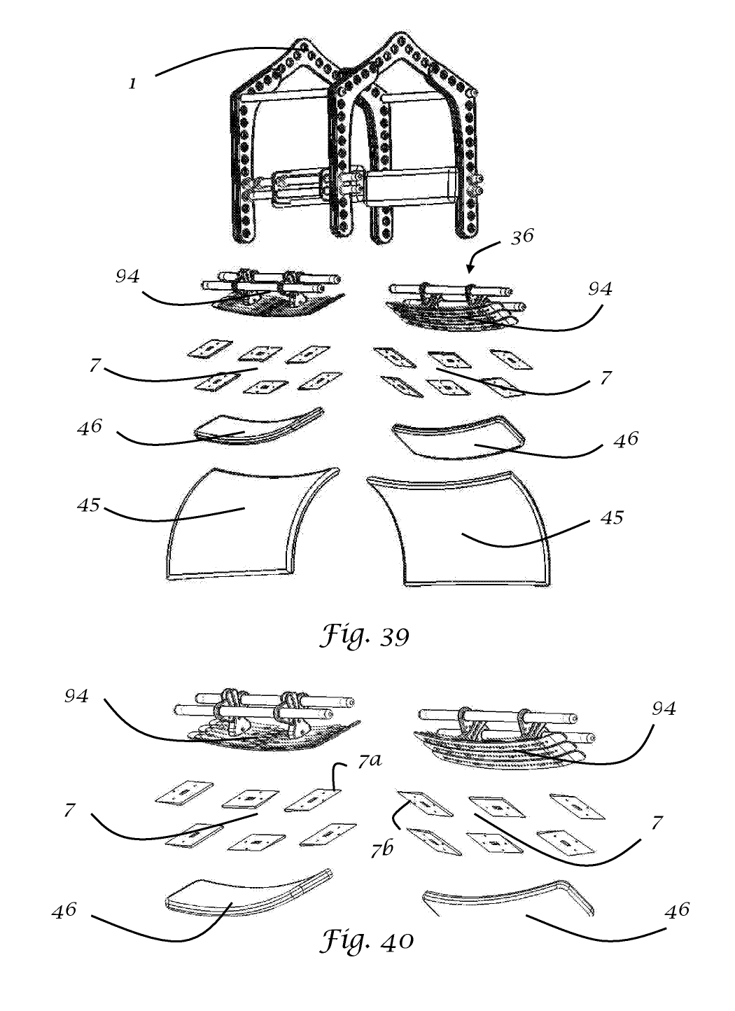

Referring now to FIG. 39, a configuration of modular animal pack saddle frame 1 is shown in exploded form. The frame configuration may include top rail 11, side support rails 13 and side support pads 120. Load distribution assembly 94, tapered contour shims set 7, curly fiber or foam pad or cushion 46, and a saddle pad 45 are shown positioned in sequence below the frame. The combination of some or all of these elements may protect the assembly from the elements and further may cushion the load on the animal.

As later described in more detail with reference to FIGS. 40-107, a load distribution assembly may include at least a first load-distributing member having first and second opposing surfaces and a first, a second and an intermediate third section disposed between the first and second sections and spaced from the first and second sections. A load-distributing member in accordance with the present disclosure may include a load distribution spring, a leaf spring and/or any other load-distributing member known in the art.

At least a first load-bearing member may be attached to each of the opposite first and second sections of the first load-distributing member. Each first load-bearing member may have a first surface facing the second surface of the first load-distributing member and a second surface, opposite the first surface, facing the load-carrying animal during use. A load-bearing member in accordance with the present disclosure may include a shim, a spring shim, contour shim, a load-distributing member and/or any other suitable load-bearing member.

Some embodiments of the load distribution assembly may include a second load-distributing member. The second load-distributing member may include an intermediate section, disposed between and spaced from spaced first and second sections, attached the first load-bearing member, opposite the first load-distributing member. A second load-bearing member may be attached to each of the first and second sections of the second load-distributing member. The second load-bearing member may have a first surface facing the second load-distributing member and a second surface opposite the first surface and facing the load-carrying animal during use.

A plurality of load-bearing members may be attached to the load distribution assembly at spaced locations and/or in a rectangular array. In some embodiments, a spring-plate member, including a primary spring and/or a primary leaf spring, may be included. The spring-plate member may extend along and attach to the second surfaces of the plurality of load-bearing members.

The load-supporting saddle may also include an attachment mechanism attaching the frame to the load-distribution assembly. The attachment mechanism may include a support rail and/or a sliding or adjustable support mechanism. The attachment mechanism may be configured to allow pivoting of the load-distribution assembly relative to the frame.

FIG. 40 shows a subset of the components shown in FIG. 39, including components of the load distribution assembly 94. Contour tapered shims 7 may provide additional control on the shape of the load distribution assembly 94. The contoured tapered shims can be stacked one on top of the other orienting at either 90 or 180 degrees. Accordingly, alternating stacking contoured tapered shims 7 at 180 degree rotations may create a uniform thickness. Alternatively, stacking contoured tapered shims 7 one on top of the other without rotation can incrementally increase the angle. In this manner, the variation between the three-dimensional shape of the animal's back relative to the shape of the saddle, including the angle and arc, may be controlled and thereby may be compensated. Tapered shims 7, also generally referred to as load bearing members, may include a first surface 7a facing a second surface of a distribution or leaf spring, also generally referred to as a load-distributing member, and a second surface 7b, facing the load-carrying animal during use.

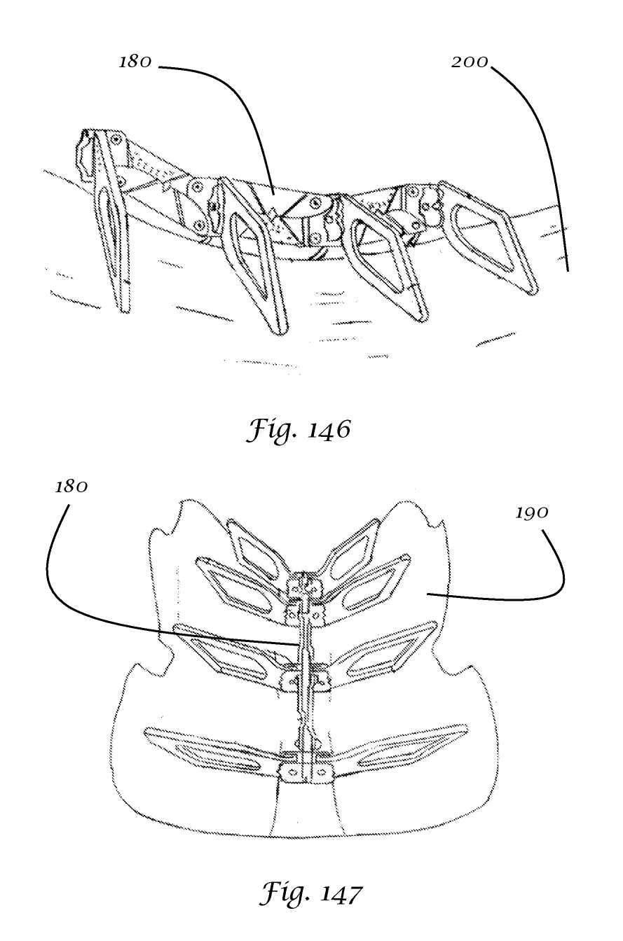

In an exemplary embodiment of the disclosed system, the three-dimensional shape of the animal's back may be measured employing a gauge 180 (shown in FIGS. 146-147). The gauge may be readjusted to compensate for gravitational forces by adjusting for the weight of the animal relative to the weight of the load, using the weight compensation formula, and recorded. The gauge may then be placed in the saddle and the relative distances between the gauge wings and the saddle panel may be recorded. Then, contoured tapered shims 7 may be arranged into substantially the same shape as the difference between the gauge wings and the saddle panel. The contoured tapered shims 7 can be oriented adjacent to the load distribution assembly 94 to make quick and easy adjustments. In some examples, there may be limits to the precision of adjustments that can be made using the contoured tapered shims.

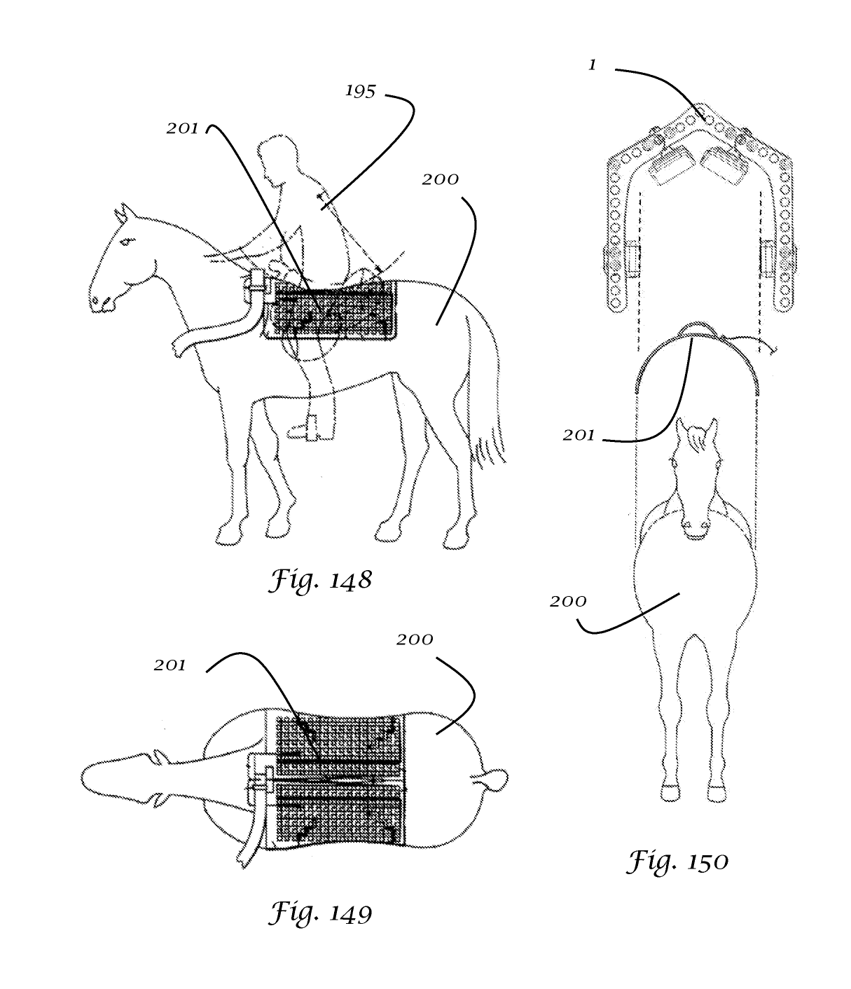

In order to validate that the pack saddle does, in fact, fit the animal, a computer interface pressure measurement device 201 (shown in FIGS. 148-150), may be placed on the animal, and a computer scan 192 may measure the pressures exerted by the pack saddle on the back of the animal with its appropriate load secured. If the interface pressure is evenly distributed, which may be indicated by uniform color on a display of the computer interface pressure measurement device, the saddle may be considered to fit the animal and is ready for service.

However, if higher pressure is revealed in any area, which may be indicated by color gradients on a display of the computer interface pressure measurement device, incremental adjustment of the shape of the load distribution assembly 94 may be required. In such a case, readjustment of the relative position of the leaf springs that constitute the load distribution assembly 94 or the relative position of the contour shim set may be required. The process may be repeated until even pressure is achieved and validated by computer interface pressure measurement.

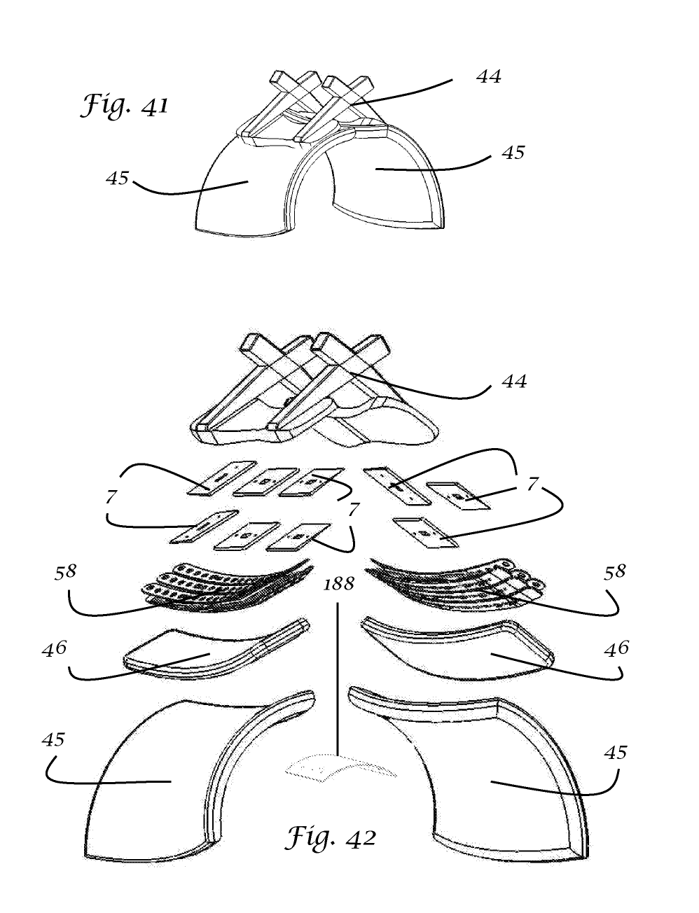

Referring to FIG. 41 and FIG. 42, another example of the load distribution assembly is shown. This example may address the fit of legacy pack saddles and riding saddles. FIG. 41 shows a legacy pack saddle system, including a sawbuck pack saddle 44 and a saddle pad 45.

FIG. 42 shows a combination of components of the system of the present disclosure configured to form load distribution assembly 58 with legacy sawbuck pack saddle 44. The combination includes legacy sawbuck pack saddle 44, Contoured tapered shim set 7, load distribution assembly 58 configured for legacy saddles, an alignment assembly 23 or 188, a foam or curly fiber pad 46, and a saddle pad 45. The alignment assembly may attach to the inboard edges of the load distribution assemblies 58, both left and right. The saddle pad may include a pocket in which all of the above parts can be enclosed, for protection from the elements and provide additional cushion for the animal.

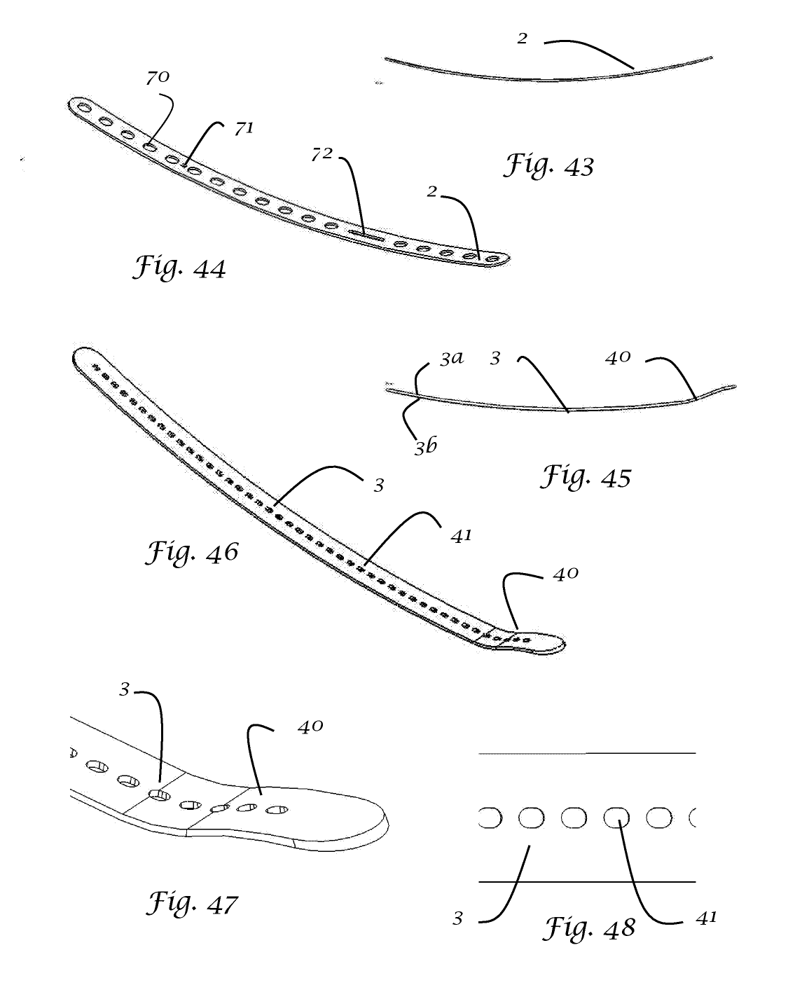

FIGS. 43-70 show individual parts and/or combinations of parts that may form the load distribution assembly 94 for use with the base modular animal pack saddle frame 1. One or more of the depicted parts may also be configured to form load distribution assembly 58 for use with legacy pack saddles or riding saddles, with one or more noted differences.

As shown, one or more of the depicted parts or combinations of parts may be considered a leaf spring or a leaf spring system. The pressure distributed by a leaf spring system may be adjusted by varying the modulus or stiffness of the individual springs within the system. The configuration of the system may be verified by employing an interface pressure measurement to create a feedback loop to control the configuration, so that the appropriate modulus or stiffness can be determined. Being able to control the material properties permits a different modulus or stiffness by using a variety of materials, such as aluminum, stainless steel, plastic, or wood, where each have different properties. Additionally, being able to control the thickness of the material provides greater control. Thicker material is stiffer than thinner material, however, thinner material can provide additional stiffness by stacking a number of thinner pieces on top of one another, which provides precise control of the modulus or stiffness.

Referring to FIG. 43, deformable saddle long load distribution spring 2 is shown. The deformable saddle long load distribution spring may permit load distribution assembly 54 to be adjusted to accommodate legacy pack or riding saddles by spreading the load on to the primary spring 4 and, in turn, onto secondary spring assembly 89.

FIG. 44 also shows deformable saddle long load distribution spring 2. In this view, lightening holes 70, which reduce the weight of the part, can be seen. A hole 71 may be used to secure the deformable saddle long load distribution spring 2 to the primary leaf spring 4. Hole 72 may be elongated to attach the leaf spring 2 to the primary leaf spring 4, but permitting some movement of the parts relative to each other, as weight and torsion are applied.

FIGS. 45-48 show deformable long load distribution spring 3. The deformable long load distribution spring may distribute the load from the saddle through the deformable saddle long load distribution assembly 94 onto the curly fiber pad and saddle pad, which may then distribute the load onto the animal's back. As shown in FIG. 45, distribution spring 3, also generally referred to as a load distributing member, may include opposing surfaces 3a and 3b.

In FIG. 47, a reverse curve 40 is shown molded into deformable long load distribution spring 3. The reverse curve may permit the scapula of the animal to slip unobstructed under the deformable long load distribution assembly 94 when the animal extends its leg in gait, and the scapula then rotates back under the saddle.

This reverse curve may be different than a flair, which is a continuous relative constant curve. The saddle bar flair has been common practice in saddle tree. However, interface pressure measurement reveals that the flair does not prevent the scapula from contacting the saddle tree. To avoid contact between the animal's scapula and the saddle tree or deformable long load distribution assembly 94, requires the bar or in this case the deformable long load distribution spring 3 to be hollowed so that contact is prevented. In some examples, hole 41 may be elongated as shown in FIG. 48 to permit some movement between the primary leaf spring 4, when attached and put under stress and torsion from the pack load.

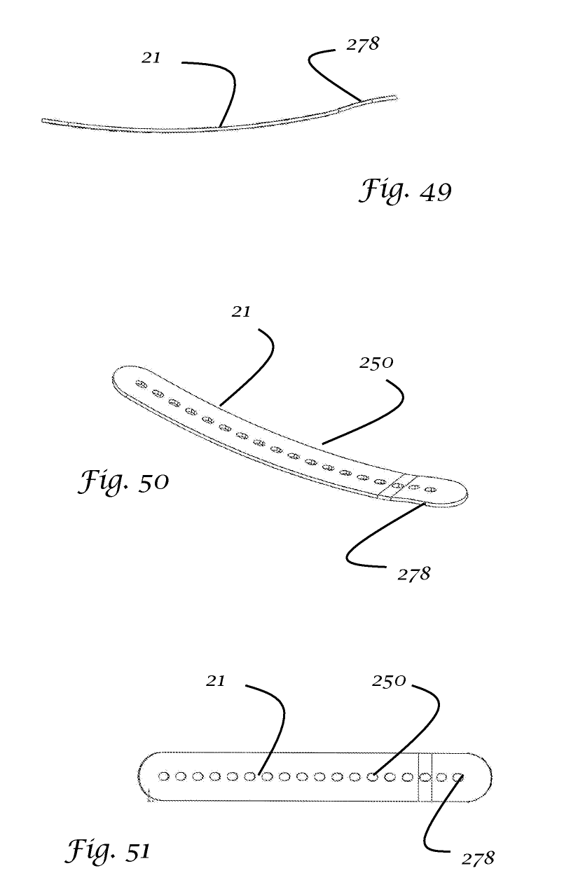

FIGS. 49-55 show various views and configurations of deformable short load distribution spring 21. Deformable short load distribution spring 21 may be substantially shorter than deformable long load distribution spring 3. Two or more deformable short load distribution spring assemblies 275 may be attached to either adjustable rail 19 or a legacy saddle load distribution assembly 290.

Accordingly, the length of the panel may be extended or reduced to accommodate the different lengths of different species of animal's backs. Thereby, the load may be distributed evenly on the back of the animal, so that smaller animals that have lighter loads can have a smaller load bearing area, and conversely, larger animals that can carry larger loads can have the weight bearing area increased, to reduce the pressure respectively.

Specifically, FIGS. 50-51 shows the deformable short load distribution spring incorporating an oblong hole 250. Oblong hole 250 may permit movement of the attachment means as weight and torsion are applied. Additionally, the shape of the deformable short load distribution spring 21 may include a reverse curve 278, to permit the scapula of the animal to move back unobstructed. Conversely, when spring 21 is mounted to the rear of the saddle, it can be reversed so that reverse curve 278, may permit the loin of the animal to also receive no pressure.

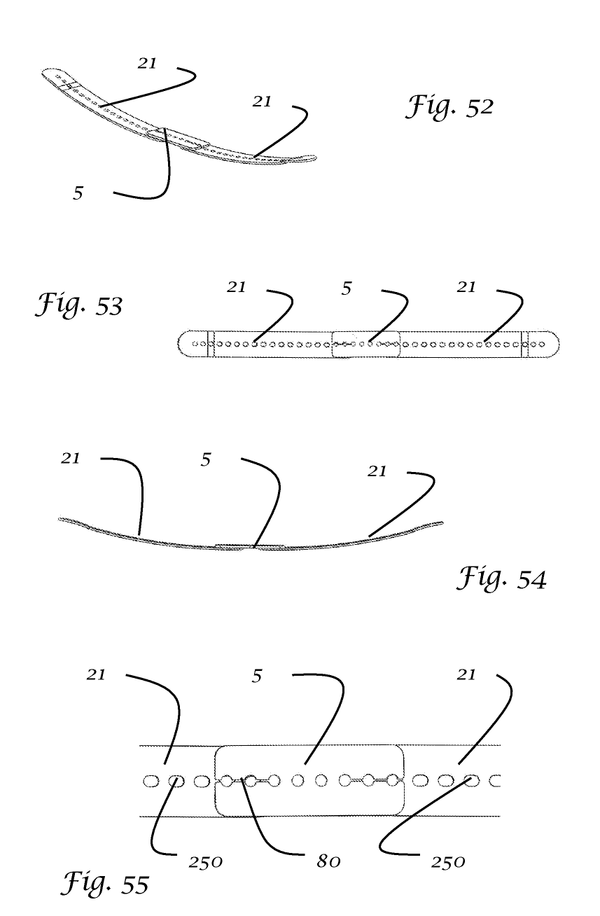

FIG. 52-55 shows a plurality of deformable short load distribution springs 21 secured end to end to permit the adjustment of the length of the panel to be adjusted to the appropriate length of the animal's back. Leaf spring 5 may be used to connect two deformable short load distribution spring 21.

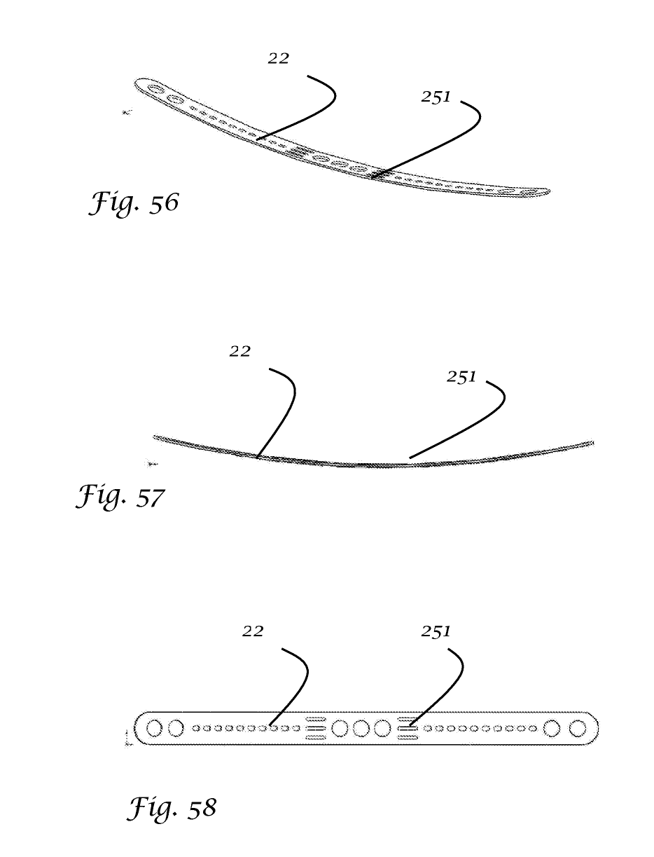

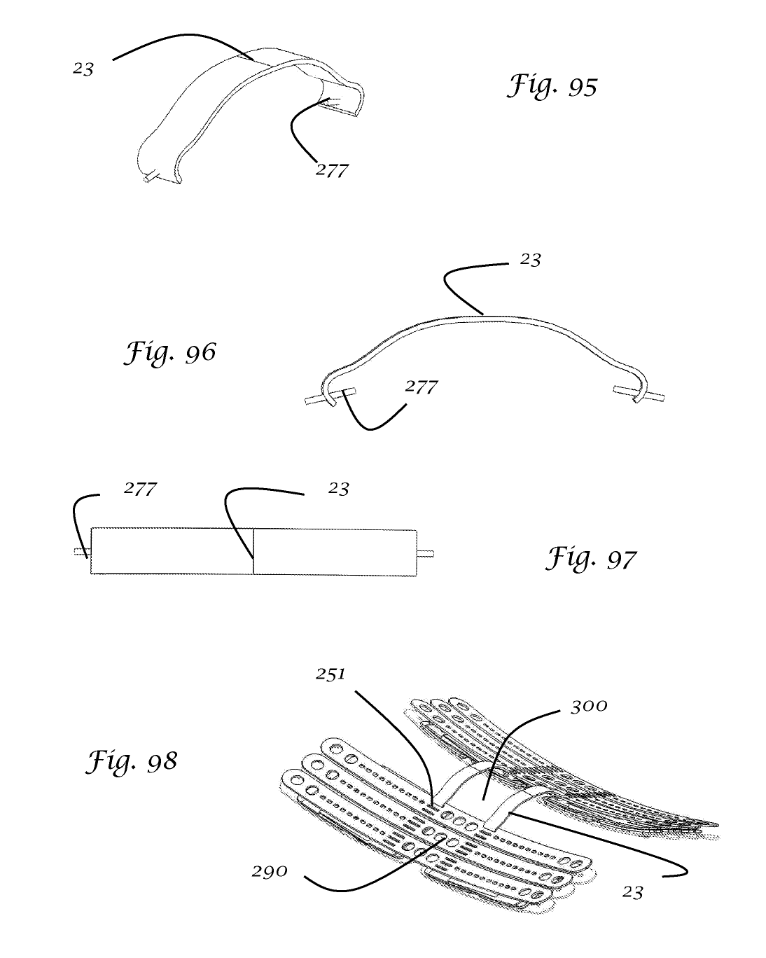

Similarly, FIGS. 56-58 show various views and configurations of deformable saddle short load distribution springs 22. The deformable saddle short load distribution spring may distribute the load of the legacy saddle onto the primary leaf spring 4. A series of slits or elongate holes 251 may receive thwartship alignment spring 23 (shown in FIGS. 95-97). These elements may permit two or more deformable load distribution assemblies 290 to be fixed substantially parallel to each other as well as parallel to the spine of the animal. Thereby, a deformable short load distribution assembly 300 may be created that can protect the animal from legacy saddle related injury.

As shown particularly in FIG. 58, the series of slits 251 may form a ladder in the deformable saddle short load distribution spring that may link to thwartship alignment part 23. The thwartship alignment part may be positioned with a simple pin and in turn may permit some axial rotation of the two assemblies relative to each other relative to the spine of the animal.

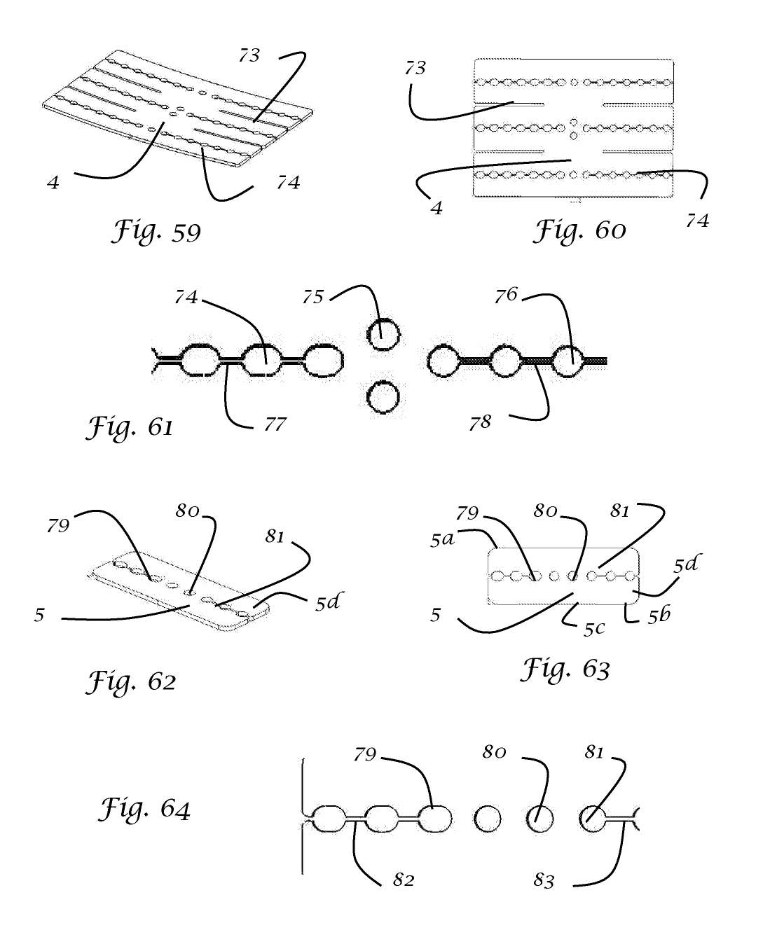

FIGS. 59-61 show primary leaf spring 4 that may distribute the load from the angular adjustment part 10 or from the above deformable saddle short load distribution spring 2 on to a plurality of secondary leaf spring assemblies 5. Accordingly, leaf springs 4 and 5 may also be referred to generally as load-distributing members. These members may be interconnected using an attachment device such as a Chicago screw. In some examples, a slit 73 may permit the primary leaf spring adjustment of greater movement or modulus or stiffness. By adjusting the length of the slit, precise control of the modulus may be possible. The hole distribution may also facilitate spring movement to distribute the pressure from the load and compensate for the torsional loads. Slit 77 may permit further spring movement. By increasing or decreasing the thickness of the leaf spring, by stacking thinner springs on top of one another, or by changing the material that the leaf spring is composed, the modulus or stiffness of the leaf spring can be adjusted to achieve the desired load-bearing characteristics.

As shown particularly in FIG. 61, hole 75 may secure primary leaf spring 4 to angular adjustment part 10. Hole 74 may provide attachment of primary leaf spring 4 to secondary leaf spring 5 permitting some movement under load. In contrast, hole 75 may secure primary leaf spring 4 to angular adjustment part 10. Hole 74 may also provide attachment of primary leaf spring 4 to secondary leaf spring 5 permitting some movement under load. Accordingly, the position of the assemblies can be fixed, while also providing the leaf spring to move under load.

FIGS. 62-64 show secondary leaf spring 5 that may distribute the load to the long or short load distribution leaf springs using an attachment device such as a Chicago screw. Slits 82 and 83 may permit the leaf spring greater movement. The hole distribution may also facilitate spring movement to distribute the pressure from the load. Hole 80 may secure primary leaf spring 4 to secondary leaf spring 5. Holes 79 and 81 may secure secondary leaf spring 5 to load distribution leaf spring 3, permitting some movement between the primary leaf spring 4 and the secondary leaf spring 5. Slit 82 may permit greater spring movement. By increasing or decreasing the thickness of the leaf spring, by stacking thinner springs on top of one another, or by changing the material composition of the leaf spring, the modulus or stiffness of the leaf spring can be adjusted to achieve the desired load-bearing characteristics.

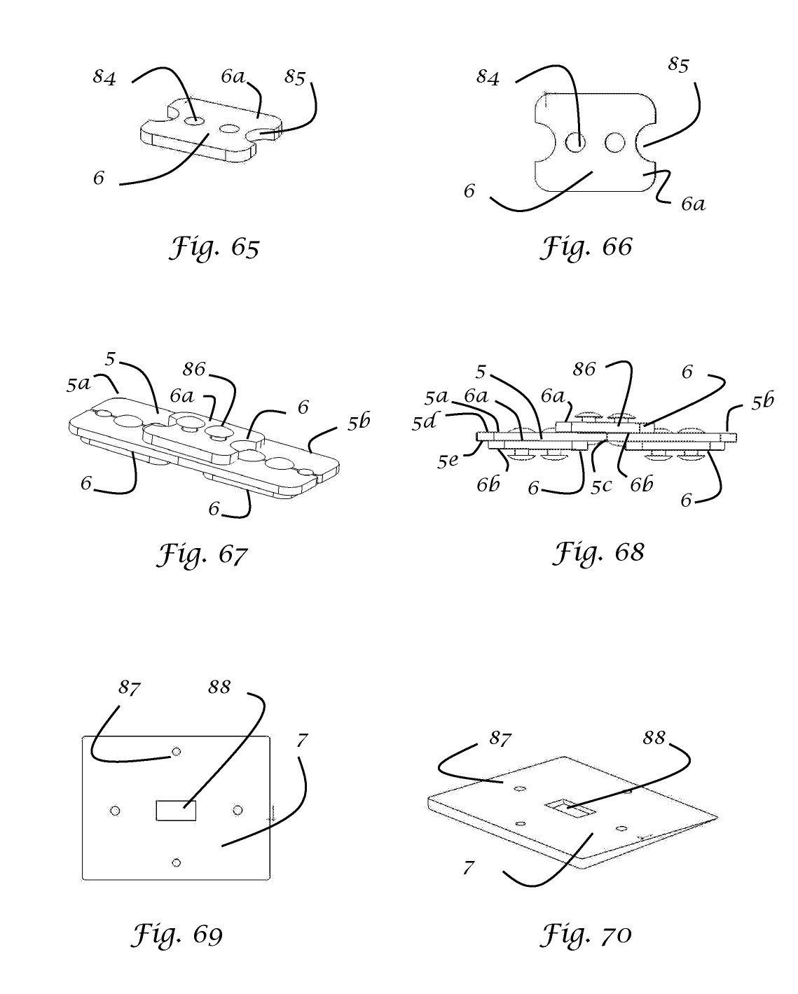

FIGS. 65-68 show leaf spring shims 6 and configurations of multiple leaf spring shims, also generally referred to as load-bearing members. Hole 84 and its associated hole may be used to provide attachment of the shim between primary leaf spring 4 and secondary leaf spring 5 as well as between secondary leaf spring 5 and load distribution leaf spring 3 with an attachment mechanism such as a Chicago screw. Leaf spring shim 6 may provide a controlled amount of separation from the various layers from primary spring 4 and secondary spring 5 and load distribution leaf spring 3. The leaf spring shim may also allow the parts to move laterally between each other as torsion forces are applied, permitting the entire structure of the assembly to twist, under the torsional load. FIGS. 67-68 show a secondary leaf spring assembly 86 that may be formed from one secondary spring assembly 5 and three leaf spring shims 6, one above and two below. In this configuration, load-applying leaf springs 6 may include a first load-receiving major surface 6a facing a load and a second load-applying surface 6b facing the load-carrying animal during use.

Shown particularly in FIGS. 62, 67, and 68, leaf spring 5 may include spaced first and second sections 5a and 5b and an intermediate third section 5c. The other load-distributing members, such as the leaf springs 2, 3, and 4, also have corresponding load-bearing or load-applying sections. Leaf spring 5 is planar and has a first major surface 5d and an opposite second major surface 5e. Depending on how the leaf spring is positioned in a load-distributing assembly, one of these major surfaces is a load-receiving surface and the other major surface is a load-applying surface.

FIGS. 69-70 show rectangular contoured tapered shim 7. Hole 87 and associated holes at 90 degrees may permit the contoured tapered shims to be stacked one on top of the other. The tapered profile of the shims may permit a user to shim the space between the saddle and the animal, and to simultaneously control the shape of the angle and/or the arc with one individual part.

In some examples, the three-dimensional shape of the animal's back would be measured employing gauge 180 (shown in FIGS. 146-147). Gauge 180 may be readjusted to compensate for gravitational loads by adjusting for the weight of the animal relative to the weight of the load, using the weight compensation formula, and recorded. The gauge may then be placed in the saddle and the relative distances between the gauge wings and the saddle panel may be recorded. Then, contoured tapered shims 7 may be arranged into the same shape as the difference between the gauge wings and the saddle panel. Contoured tapered shims 7 can be oriented adjacent to the load distribution assembly 58 or 94 to make quick and easy adjustments. However, there may be limits to those adjustments that can be made using only the contoured tapered shims 7.

In order to validate that the pack saddle does, in fact, fit the animal, computer interface pressure measurement device 201 may be placed on the animal. A computer scan 192 may measure the pressures exerted by the loaded pack saddle on the back of the animal, with its appropriate load secured. If the interface pressure is evenly distributed, which may be indicated by a uniform color distribution on a display of the computer interface pressure measurement device, the saddle fits the animals and may be ready for service.

However, if higher pressure is revealed in any area, which may be indicated by color gradients on a display of the computer interface pressure measurement device, incremental adjustment to the shape of the load distribution assembly 58 or 94 may be performed. In such a case, readjustment of the relative position of the leaf springs that constitute the load distribution assembly 58 or 94, or the relative position of the contoured tapered shim 7 may be performed, and the process repeated until even pressure is achieved and validated by computer interface pressure measurement.

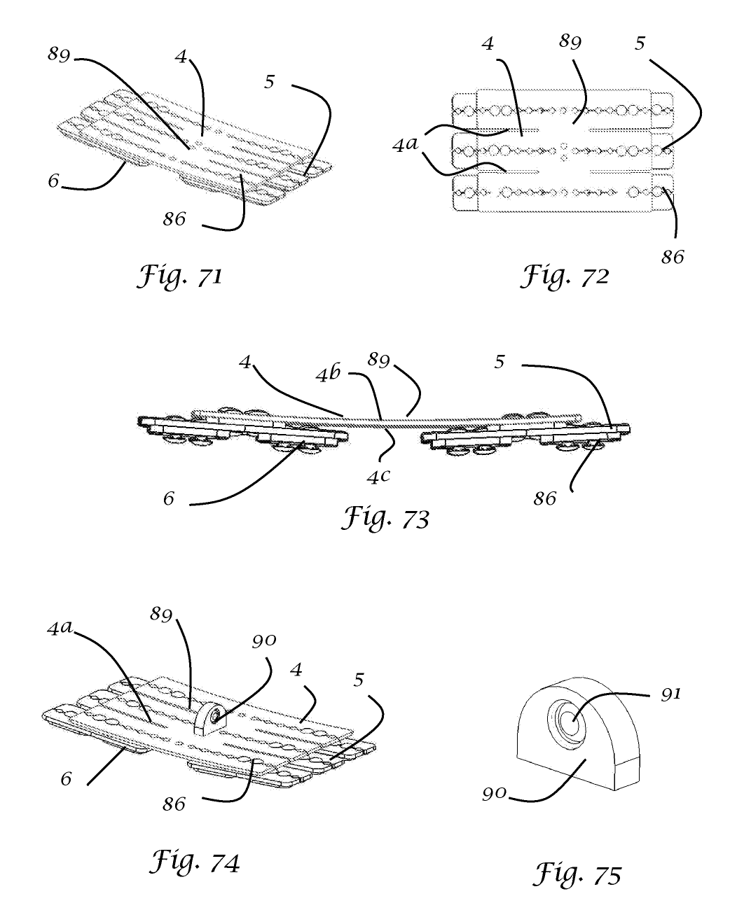

FIGS. 71-75 show long load distribution assembly 89 that may be formed with primary leaf spring 4 and secondary leaf spring 5. Slits 4a extending partially into leaf spring 4 from opposite ends divides the leaf spring into arms and thereby may permit the primary spring arms, each with the attached secondary leaf spring 5 to move independently from the other arms. FIG. 73 illustrates how the load applied to a load-receiving surface 4b may be transferred from primary leaf spring 4 to secondary leaf spring 5 by contact of a load-applying surface 4c of leaf spring 4 to a leaf-spring assembly 86, so that each load distribution assembly 89 divides the initial load applied above to a plurality of different load points, effectively spreading the load over a greater area. For example, 12 different load points may be used.

FIG. 74 illustrates placement of load bearing assembly 90 upon load distribution assembly 89. FIG. 75 shows the load bearing assembly, which may include an articulating spherical bearing 91 that may secure to rail support 10 with an attachment member, such as a clevis pin, through hole 189 formed in the rail support.

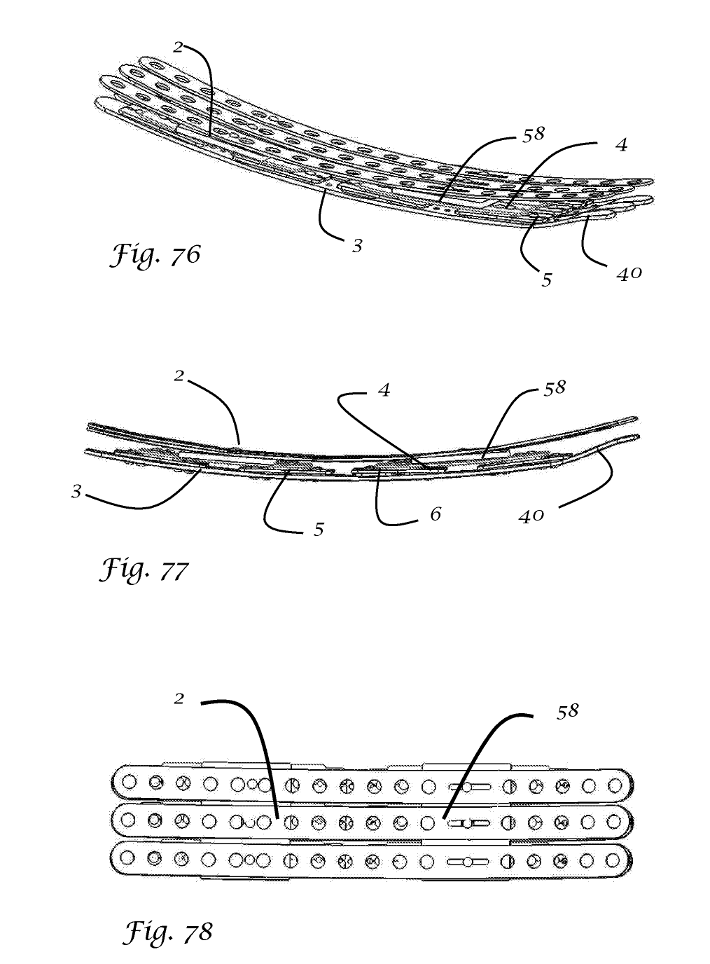

FIGS. 76-78 show long load distribution assembly 58 configured for legacy pack saddles or riding saddles. In particular, FIG. 77 shows long load distribution assembly 58 formed from saddle panel pressure distribution spring 2, functioning as a load-distributing member, and primary leaf spring 4, secondary leaf spring 5, and load distribution leaf spring 3. Each of these parts may be separated by leaf spring shim 6, and may be attached by an attachment mechanism such as a Chicago screw.

FIGS. 79-80 show long load distribution assembly 94 configured for use with modular pack saddle frame 1. Long load distribution assembly 94 may be attached to attachment mechanism 36, including angular support 9, which may be attached to side support rail part 10, which may be attached to rail 19, which may be attached to pack saddle frame 1, though respective holes in top rail 11.

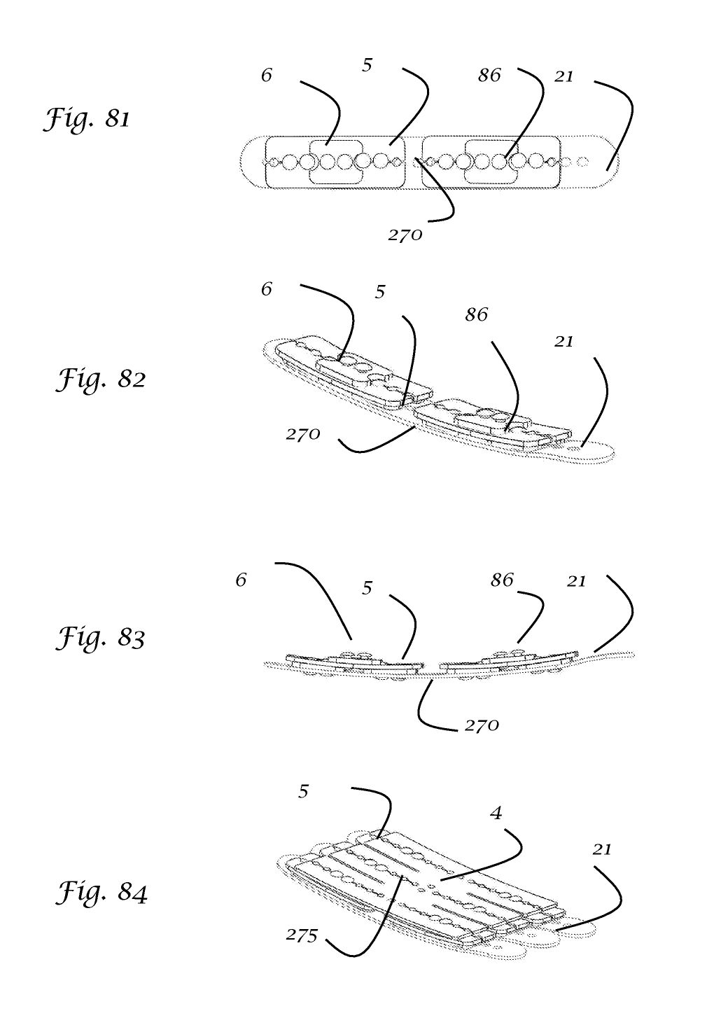

FIG. 81-83 show deformable short load secondary spring assembly 270. As has been suggested, the pressure distribution of a system of leaf springs can be adjusted by controlling the modulus or stiffness of the individual springs within the system. A variety of materials, such as aluminum, stainless steel, plastic, or wood may provide different properties. Additionally, being able to control the thickness of the material may provide greater control. Further, although thicker material may be stiffer than thinner material, thinner material can provide additional stiffness by stacking a number of thinner pieces on top of one another, which may provide additional control of the modulus. Interface pressure measurement may create a feedback loop to control the configuration so that the appropriate modulus or stiffness can be determined.

Referring to FIG. 82, deformable short load secondary spring assembly 270 is shown. Deformable short load secondary spring assembly 270 may be formed from one short load distribution spring 21 and two secondary leaf springs 5. These elements may be spaced apart by four leaf spring shims 5, placed above and below each of the secondary leaf springs 5. Parts of the assembly may employ leaf-spring assembly 86 attached though respective holes.

In contrast to the deformable long load distribution assembly 94 shown in FIGS. 79-80, the deformable short load distribution spring assembly 270 may be substantially shorter, thereby permitting more than one short distribution assembly 270, for example two assemblies, to be attached to either an adjustable rail or a legacy saddle load distribution assembly 290.

FIG. 83 shows deformable short load secondary spring assembly 270. The deformable short load secondary spring assembly permits the length of the panel to be extended or reduced to accommodate the different lengths of different species of animal's backs. Accordingly, the load may be distributed more accurately, so that smaller animals that have lighter load-bearing abilities can have a smaller load bearing area, and, conversely, larger animals that can carry larger loads can have the weight bearing area increased to reduce the pressure.

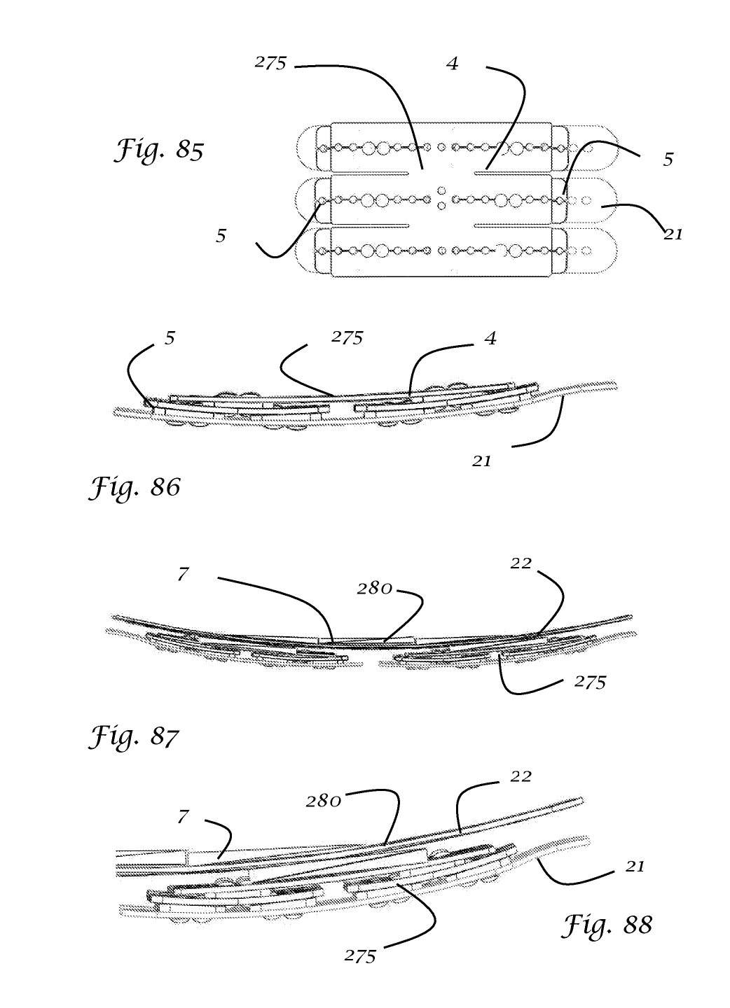

FIGS. 84-86 show a short load distribution assembly 275 that may be formed by primary leaf spring 4 and secondary leaf spring 5. The short load distribution assembly may be fabricated from a plurality of deformable short load distribution spring assemblies 270 attached substantially parallel in relationship to primary leaf spring 4. The assembly may be attached to either the saddle panel long load distribution spring or the deformable long load distribution spring. For example, three deformable short load distribution spring assemblies 270 may be used. In some examples, slit 4 may permit the primary spring arm with the attached secondary leaf spring 5 to move independently from the other sections. FIG. 86 illustrates in particular how the load may be transferred from the primary leaf spring 4 to the secondary leaf spring 5 so that each short load distribution assembly 275 divides the initial load applied above to a plurality of different load points, for example 12 different load points. Accordingly, the load may be effectively spread over a greater area.

FIGS. 87-94 illustrate non-exclusive exemplary configurations using one or more short load distribution assemblies 275. For example, in FIGS. 87-88, legacy saddle deformable short load distribution assembly 280 is formed using two short load distribution assemblies 275, attached to saddle short load distribution spring 22 and to contoured tapered shims 7. FIG. 88 in particular shows the relative relationship between the various parts in this example. Short load distribution spring 21 may be attached to primary leaf spring 4 and to secondary leaf spring 5. The secondary leaf spring may be spaced apart from saddle short load distribution spring 22 by two contoured tapered shims 7. In some examples, contoured tapered shims 7 can also be placed above saddle short load distribution spring 22 in order to control the variations of the angle and/or arc of the saddle relative to the shape of the animal's back.

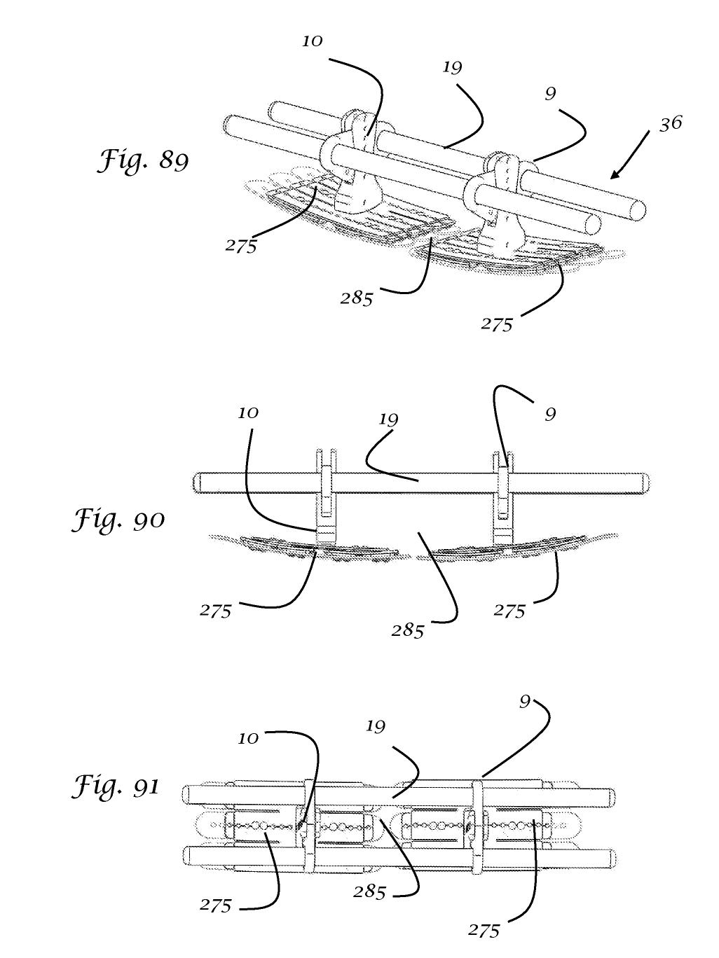

FIGS. 89-91 show a modular animal pack saddle deformable double short load distribution assembly 285 attached to adjustable mounting rails 19 configured for use with the modular pack saddle frame 1. As shown, the modular animal pack saddle deformable double short load distribution assembly 285 is formed from two separate short load distribution assemblies 275 that may be attached to angular support 9. The angular support may be attached to side support rail part 10. The side support rail may be attached to rail 19, which may be attached to the pack saddle frame 1 though respective holes in top rail 11. Accordingly, the two short load distribution assembly 275 may slide upon rail 19 and lengthen or reduce the relative distance between the two short load distribution assemblies 275, relative to the length of the animals back.

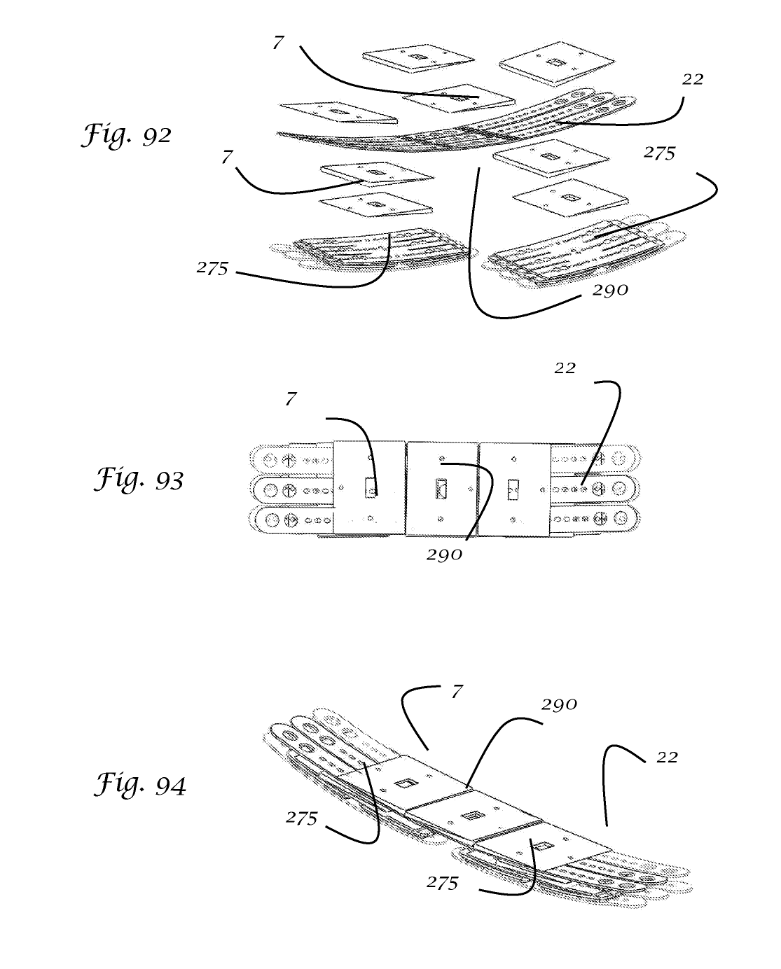

FIGS. 92-94 show a legacy saddle short load distribution assembly 290 configured for legacy pack saddle or riding saddles. In this configuration, more than one short load distribution assembly 275 may be attached to saddle short load distribution spring 22. For example, two short load distribution assemblies may be attached in a spaced apart arrangement by one or more contoured tapered shims 7. One or more contoured tapered shims 7 may also be attached above saddle short load distribution spring 22 in order to control the variations of the angle and arc of the saddle relative to the shape of the animal's back. One or more of these components may be fastened together using an attachment mechanism such as a Chicago screw configured for legacy pack saddle or riding saddles.

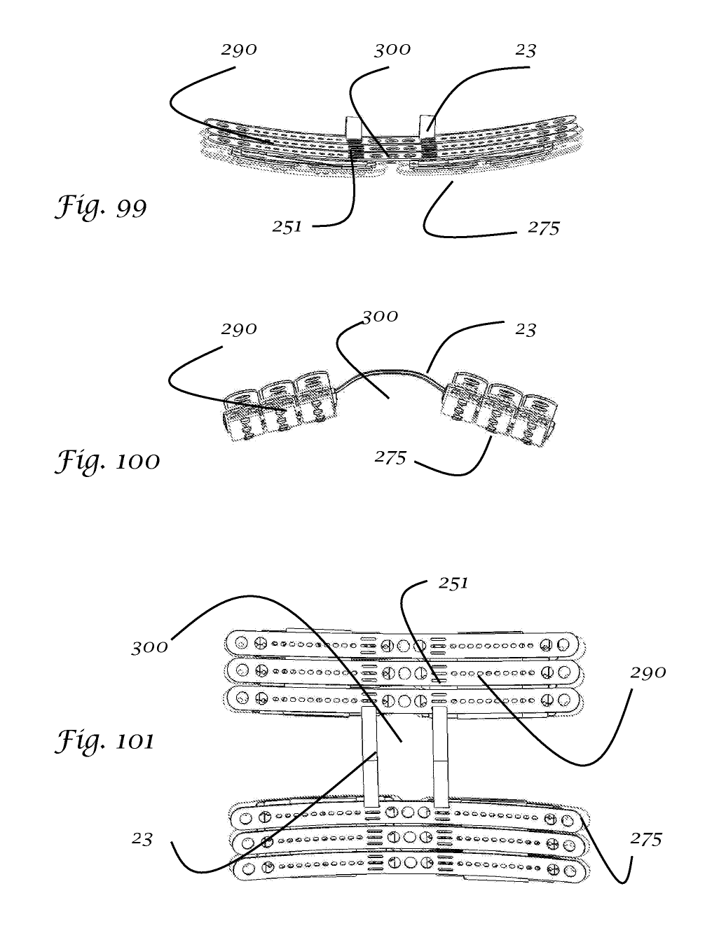

FIGS. 95-101 show thwartship panel alignment spring 23 and a non-exclusive example of its use. The thwartship panel alignment spring may be adapted to maintain two load distribution assembly 58 at a fixed distance apart relative to each other and/or aligned to the spine of the animal. The thwartship panel alignment spring may also permit the individual load distribution assembly 58 to rotate axially. Accordingly, legacy saddle deformable load distribution assembly 300 may remain relatively parallel to the animal's spine when the forces of the load and the saddle press upon the structure. Thwartship panel alignment spring 23, as shown in FIGS. 98-101, may attach to saddle short load distribution springs 22 by sliding the respective end of the curved section of the thwartship panel alignment spring though slit 251 in saddle short load distribution spring 22 and may be secured in position with a pin 277. The distance from the spine of the animal to saddle short load distribution springs 22 can be adjusted by choosing one of the plurality of slits 251 on the saddle short load distribution spring.

As shown in FIGS. 98-101, a legacy saddle deformable double short load distribution assembly 300 may be formed by joining one or more thwartship panel alignment springs 23 with one or more legacy saddle short load distribution assemblies 290. In some examples, a load distribution assembly may formed by joining two long load distribution assemblies 58 with two thwartship panel alignment springs 23. The thwartship panel alignment springs may be disposed substantially in the middle of the assemblies to permit the respective ends to flex with the movement of the animal under gait.

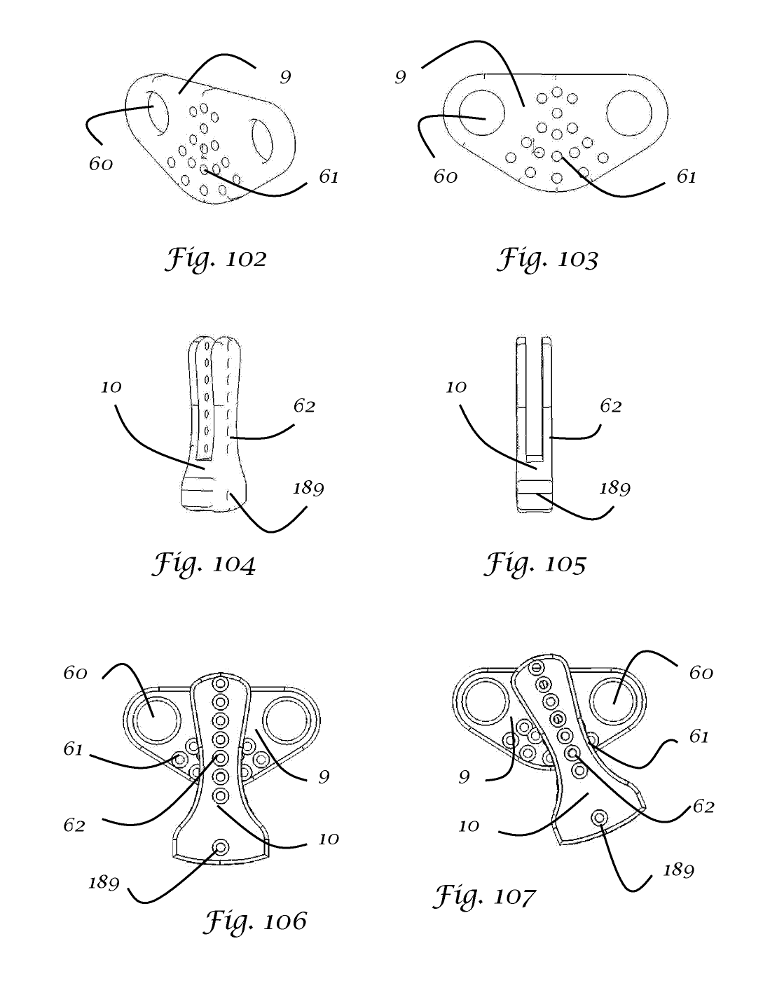

FIGS. 102-103 show rail sliding part 9. The rail sliding part includes holes 60 through which pipe rail 19 may engage to secure rail sliding part 9 to modular pack saddle frame 1 with a sliding arrangement. Additionally, an array of holes 61 configured at various angles may permit the load on the load distribution assembly 94 to be adjusted with respect to angle by using the associated angular adjustment part 10, which is shown in FIGS. 104-105. The adjustable angular load distribution support part 10 may be placed coincident with part rail sliding 9, as shown in FIGS. 106-107. The adjustable angular load distribution support part may be angularly adjustable relative to the rail sliding part, by aligning holes 61 relative to hole 62. For example, FIGS. 106 and 106 show the adjustable angular load distribution support assembly positioned at 90 degrees relative to holes 60 and 60 degree relative to holes 60, respectively. Adjustable angular load distribution support assembly 62 may attached to primary leaf spring 4 by attachment mechanisms through load bearing assembly 90, using coincident holes 91 and 189.

FIGS. 108-109 show top rail 11. In some configurations, the top rail may be the main support that connects left and right side support rails 13 by attaching pipe rail 19, also referred to generally as a transverse member, through hole 202, also referred to generally as a frame-mounting station. Attaching two frame sets including the top rail 11 and left and right side support rails 13 may create modular pack saddle frame 1. Top rail 11, also referred to generally as a frame member, may include a first section 11a and a second section 11b.

FIG. 110 shows a frame member in the form of a hanger side rail part 12. In some configurations, the hanger side rail part may be the main support rail used to create hanger load assembly 24. Two hanger side rail parts may be employed in parallel, connected through concentric holes 203 with pipe rail 19 and locking collar 8.

FIG. 111 shows side support rail 13. In some configurations, the side support rail 13 may form the left and right sides and front and back of the pack frame. The side support rail may be connected to top rail 11 through the respective holes 204, with pipe rail 19. Support rail 13, also referred to generally as a frame member, may include a first section 13a and a second section 13b.

FIGS. 112-113 show 90-degree shelf part 14. 90-degree shelf part 14 may be attached to side support rails 13, and other parts, with pipe rail 19 through the respective holes 205. The 90-degree shelf may permit a load to be attached and secured to the modular pack saddle frame 1.

FIGS. 114-115 show top hanger support 15. Top hanger support may attach to top rail 11 and/or to side support rail 13 with pipe rail 19 through the respective holes, such as hole 95. In this configuration, an even platform may be formed to secure hanger load assembly 24 substantially parallel to the ground. These configurations may use universal cleat 16, which may be attached to pipe rail 19.

In some embodiments of the present disclosure, a universal link, also referred to generally as a multiply-positionable link, is provided. The link may be used for attaching an object to a load-carrying frame having at least first and second frame-mounting stations spaced-apart a given distance. An embodiment of universal cleat 16 is discussed earlier with reference to FIGS. 22-23 and later with reference to FIGS. 116-119 and FIGS. 154-157.

A multiply-positionable link may include a body, a first series and/or pair of link-mounting stations and a second series and/or pair of link-mounting stations. The first pair of link-mounting stations may be spaced-apart the given distance of the first and second frame-mounting stations. The first pair of link-mounting stations may be disposed on the body along a first station line. The second pair of link-mounting stations may be spaced-apart the given distance of the first and second frame-mounting stations and, further, may be disposed along a second station line different than the first station line.

Additionally and/or alternatively, link-mounting stations may be attached to the body in a series of multiple link-mounting stations, and/or the first and second station lines may include more than a pair of link-mounting stations. Further, the frame member may include more than two frame-mounting stations spaced at a given distance. The mounting stations may include holes extending through the body of the link or frame, and/or any other mounting station known in the art.

The link may be supportable on the frame in at least two orientations, for example a first orientation and a second orientation. In the first orientation, the first and second link-mounting stations of the first pair of link-mounting stations may be aligned with the first and second frame-mounting stations of the load-carrying frame. At least one of the mounting stations of the second pair of mounting stations may be spaced from the first-station lines.

In the second orientation of the link body, the first and second link-mounting stations of the second pair of link-mounting stations may be aligned with the first and second frame-mounting stations of the load-carrying frame. At least one of the mounting stations of the first pair of mounting stations may be spaced from the second-station line. In some embodiments, the first link-mounting station of the first pair of link-mounting stations may be the first link-mounting station of the second pair of link-mounting stations. Additionally and/or alternatively, the link may be positionable in more than two orientations.

The link may include at least one hook extending from the body of the link and spaced from at least one of the first and second station lines. One or more hooks may be further distributed in a body plane. The link having one or more hooks may be symmetrical about a plane of symmetry containing the first station line, which is orthogonal to the body plane. In some embodiments, one hook may be disposed on one side of the plane of symmetry and a second hook may be on the other side of the plane of symmetry opposite the one hook. Depending on the orientation of the link, one or more hooks may be useful in attaching loads to a saddle frame.

A saddle in accordance with the present disclosure may include a frame including at least one frame member having at least first and second frame-mounting stations spaced-apart a given distance, a multi-positionable link, and at least first and second mounting assemblies for supporting the link on the frame selectively in the first and second orientations. The first mounting assembly may engage the first frame-mounting station and the first link-mounting station in a selected one of the pairs of link-mounting stations, and the second mounting assembly may engage the second frame-mounting station and the second link-mounting station in the selected one pair of link-mounting stations.

The frame-mounting stations may include holes extending through the frame member and the link-mounting stations may also include holes extending through the body of the link. At least one of the mounting assemblies may include a transverse member that extends through a selected one of the holes of the first and second frame-mounting stations and a selected one of the holes of the respective first link-mounting stations. The frame member holes may have centers disposed a given distance apart, and a pair of link-mounting stations in the first station line may have holes having centers disposed the given distance apart. Additionally and/or alternatively, a pair of link-mounting stations in the second station line may have holes having centers disposed the given distance apart.

FIGS. 116-119 show universal cleat 16, also generally referred to as a multiply-positionable link. Cleat 16 has a planar body with equally sized and equally spaced holes 97, 101, and 207 disposed along a first line S1, equally sized and equally spaced holes 98 and 101, along with an opening forming hook 96 disposed along a second line S2, and equally sized and equally spaced hole 97 and the openings forming hooks 102 and 206 disposed along a second line S2. The size and center-to-center spacing between the holes and openings corresponds to the size and spacing of at least some of the holes in the frame members 11, 12, 13 and 14. The universal cleat 16 may be affixed to the modular animal pack saddle in a variety of configurations. Rope may be secured around the cleat to secure cargo to the modular animal pack saddle without the use of knots. The universal cleat may be secured through hole 97, also referred to generally as a link-mounting station, to the modular animal pack saddle. Additional universal cleats may be secured through the corresponding holes and openings on the same line, also referred to generally as a station line, thereby positioning the additional cleat in the same orientation as the first cleat. Alternatively, the additional cleat may be secured through hole 98, thereby positioning the additional cleat at an orientation perpendicular to the first cleat.

Further, universal cleat 16 can be reversed as shown particularly in FIG. 118. When the cleat is secured to the frame in this orientation, hole 98 may be used to secure rope or ratchet web tie downs, thereby further eliminating the need for knots. Alternatively, if knots are required, the universal cleat 16 may also provide a hook 206 to permit a conventional diamond hitch lashing method to be employed. FIG. 119 shows the universal cleat attached to side support rail 13 through hole 97 and hole 207, also referred to generally as a first pair of link-mounting stations disposed on the body of the link along first station line S1, with pipe rail 19 and secured with locking collar 8, collectively referred to generally as a mounting assembly 37. In this configuration, a rope may be secured to cleat 99 formed by hooks 96 and 102, without the use of a knot. Alternatively, the universal cleat may be attached through hole 98 and hole 101 or the opening of hook 96, two of which may also be referred to generally as a second pair of link-mounting stations disposed on the body of the link along second station line S2, different from the first station line S1. The cleat may also be attached to the frame using the link-mounting stations (hole and openings) disposed along third station line S3.

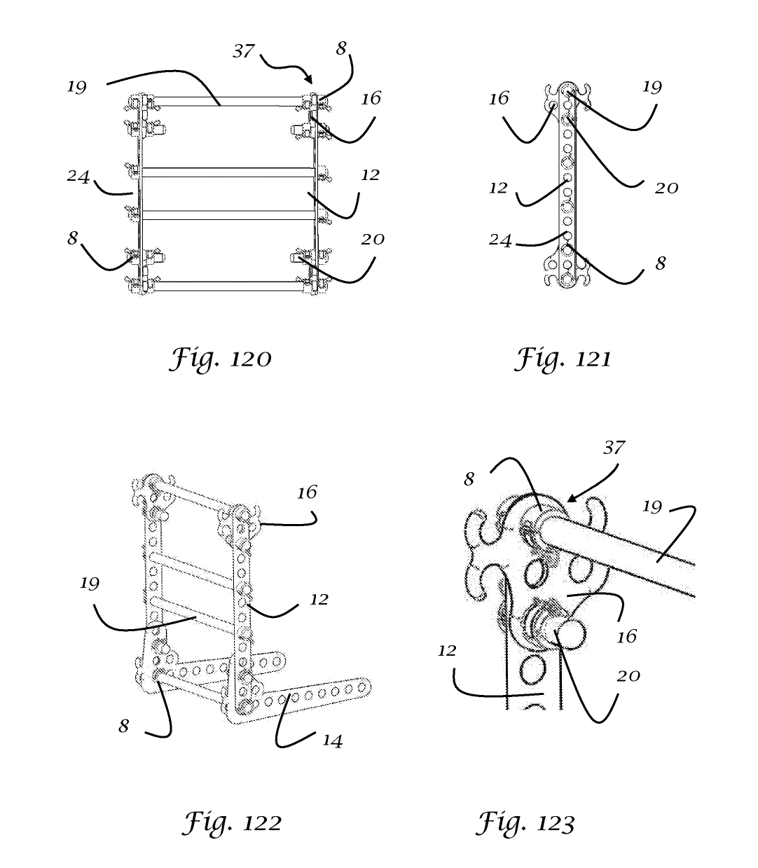

FIGS. 120-123 show hanger load assembly 24. The hanger load assembly 24 may be formed by connecting two hanger side rail parts 12 in a substantially parallel configuration. Pipe rail 19 may extend between the hanger side rail parts, and the assembly may be secured together by locking collar 8. In order to hang the hanger load assembly, universal cleat 16 may be attached to the hanger side rails adjacent to hanger side rail 12 using pipe rails 19 and 20. In FIG. 122, the hanger load assembly 24 is shown configured to accept a load using 90-degree shelf 14. In FIG. 92, detail of universal cleat 16 attaching to hanger side rail 12 is shown, using locking collar 8.

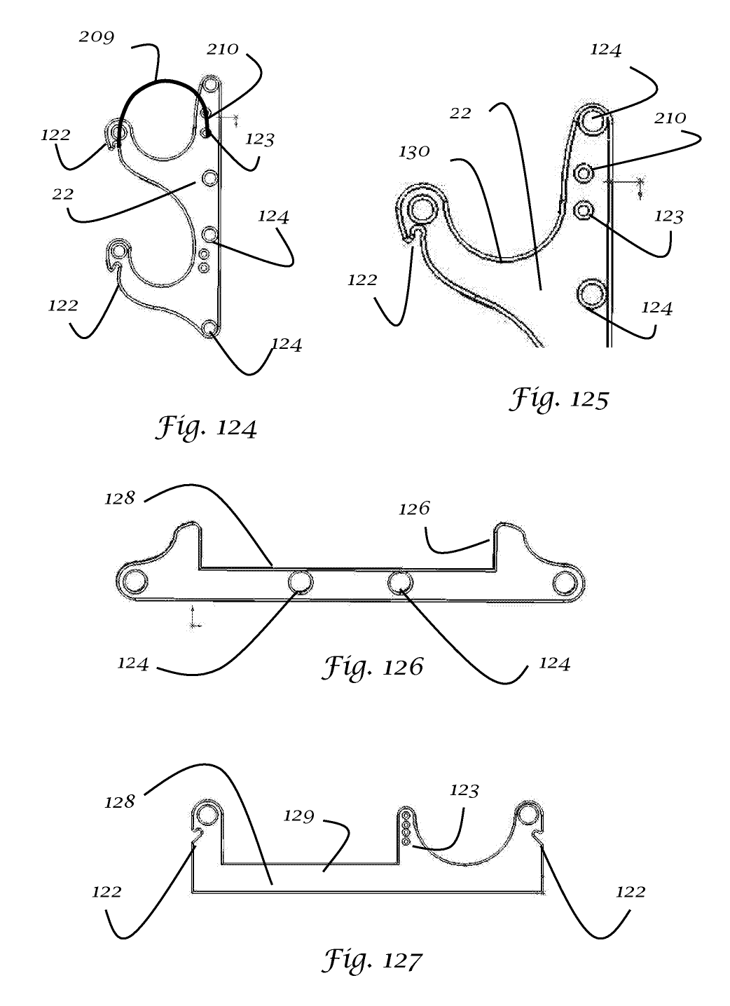

FIGS. 124-127 illustrates a hangar jig 22, which may permit the hanger load assembly to carry virtually any cargo item by cutting a flat material such as plywood or plastic, into the negative shape of the cargo item. The hanger jig may also provide a quick release mechanism.

In the configuration shown in FIGS. 124-125, hanger jig 22 may be cut to carry a number of Javelin Missiles. As shown, the flat material of the hanger jig is cut to a round shape to cradle the Javelin Missile barrel. To attach the cargo item, the hanger jig 22 may be cut with a set of holes 124 that correspond to the placement of holes on the hanger load side plates 12. Accordingly, the hanger jig 22 can be secured with pipe rail 19 and locking collar 8.

The quick release mechanism 209 is simple and inexpensive, as well as effective. The quick release mechanism may be formed from a stretchable cord, such as bungee cord or rubber, which may be threaded through hole 123 in one direction. A half hitch may be tied at one end of the stretchable cord so that the cord is secured in position. The opposite end may be threaded in the opposite direction through hole 210, and a corresponding half hitch may be tied at the end of the same stretchable cord to secure the cord in position. In this configuration, stretching the cord over the item to be secured in cradle 130 may only require slipping the loop created by threading the ends of the cord through the holes 123 and 120 over the hook 122 that is cut into the hanger jig 22, to lock the cord in place by using its own resilience. Conversely, the quick release mechanism 209 can easily and quickly be released by slipping the stretchable cord off the hook 122.

FIG. 126 shows the hanger jig 22 cut in a configuration to secure a square box. In this configuration, the hanger jig may secure the ends 126 and bottom 128 to prevent the box from moving. The hanger jig may be secured to the hanger load assembly by cutting holes 124 so that the hanger jig can be secured with pipe rail 19.

FIG. 127 shows yet another configuration of hangar jig 22. This embodiment includes a cutout 129 that may be adapted to secure a square box. Hooks 122 may be cut into the jig in order to form the quick release mechanism. The respective ends and the stretchable cord may be attached at hole set 123.

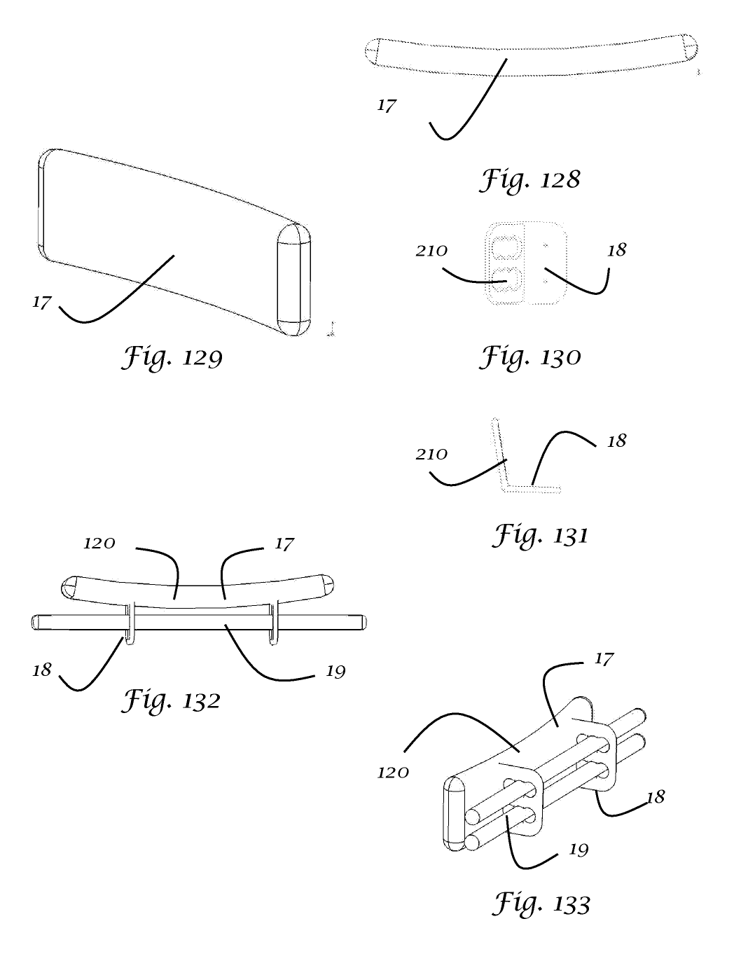

FIGS. 128-133 show a side stabilization pad assembly that may provide stability to the modular animal pack saddle. By securing the pack saddle frame at four areas on the animal's back, for example at the top left and right and sides left and right, a significantly more stable platform may be created. This greater stability may permit the animal to travel at a significantly faster pace, such as the trot, canter or gallop. Additionally, the frame being securely fastened to the animal may permit the load to also be securely fastened to the frame so that the load will not shift in transit.

Specifically, FIGS. 128-129 show side stabilization pad 17. The side stabilization pad may be constructed of a curved plate shaped to the curve of the side of the animal and that may have a layer of horsehair, curly fiber, foam, or any suitable compliant material that will protect the animal and is attached to the plate.

FIGS. 130-131 show side stabilization pad rail connector 18. The connector may have an overlapping hole set cut to receive pipe rail 19. While the width of the pack frame may be adjustable by changing the relative position of the holes in top rail 11 relative to side support rails 13, the overlapping holes 210 may permit a finer adjustment to accommodate the animal more accurately. As shown particularly in FIG. 131, side stabilization pad rail connector 18, may be angled to accommodate the difference between pipe rail 19 and the curvature of the side stabilization pad, adjusted to accommodate the curvature of the animals side. FIGS. 132-133 show side stabilization pad assembly 120. As shown, rail connector 18 may be attached to the stabilization pad 17 with pipe rail 19 in a middle position of hole set 210.

FIGS. 134-135 show locking collar mechanism 8 in the open position and in the closed position, respectively. This locking mechanism 8 may facilitate the reconfiguration of the relative position of parts of the modular pack saddle frame. The collar may be opened and placed around pipe rail 19 or 20, and then closed and locked into position, thereby substantially preventing any of the parts to move from the desired relative position. Accordingly, locking mechanism 8 is also referred to as mounting devices that are each configured to attach to at least one bar or pipe rail for securing the position of the bar in an associated hole of a frame member.

The locking collar mechanism 8 may be formed of five basic parts and three attachment pins. A lower collar part 28 and an upper collar part 27 may be attached for rotation about a common end. A locking mechanism may include a locking tab part 25 having a locking T 26 formed form a pin 211 attached though a hole in one end of the locking T. The locking T may be placed above the collar 212 in the upper collar part 27 so that the pin rests in the channel. Pressing the locking tab 25 inward to be coincident with the radius in the lower collar 28 may toggle the relative position of the parts into a locked position, thereby securing the parts in relative position until a change is required and the process reversed.

FIG. 136 shows short pipe rail 20, which may permit various parts to be attached relative to one another, employing the locking collar mechanism 8, without the employment of tools. Similarly, FIG. 137 shows long pipe rail 19, which may permit various parts to be attached relative to one another over longer distances, employing the locking collar mechanism 8, without the employment of tools. Both of these uses are shown in FIGS. 120-123.

Alternatively, a mechanism which may prevent the various parts from moving could also be formed by use of a round collar, with an inside diameter slightly more than the pipe rail 19 This collar may be secured by drilling a hole into the pipe rail 19 at the appropriate position and securing the parts with a hitch pin, screw, or other appropriate attachment member. However, this strategy would require significant forethought, with respect to the sequence of the parts that would need to be assembled.

FIGS. 138-145 show a winch system further illustrated and discussed with reference to FIGS. 27-29. As shown in FIG. 138, the winch system includes pipe 19 upon which a set of winch drums 146 may be locked together and may be secured in relative position by locking collar mechanism 8. FIGS. 139-140 show the formation of winch drum 146 by two face plates 147 that may be secured to a locking mechanism 145 by a pin 149. The face plates are shown more particularly in FIG. 141. The two facing plates may be secured in relationship to each other by a set of bolts set in a circular manner, and may be spaced apart by winch locking mechanism 145. The pin may be placed though a hole in pipe rail 19, and thereby may prevent the various winch drums from rotating independently. FIG. 140 shows a rope 148 coiled around the pins 146 that create the winch drum.

FIG. 142 shows winch assembly 146 illustrating how the rope 148 may be coiled around the bolts to create a circular drum. By adding or removing pins, the diameter to the drum surface contacting the rope can be varied. Control of the diameter of the winch drum may permit control of the forces required to rotate the winch assembly 150.

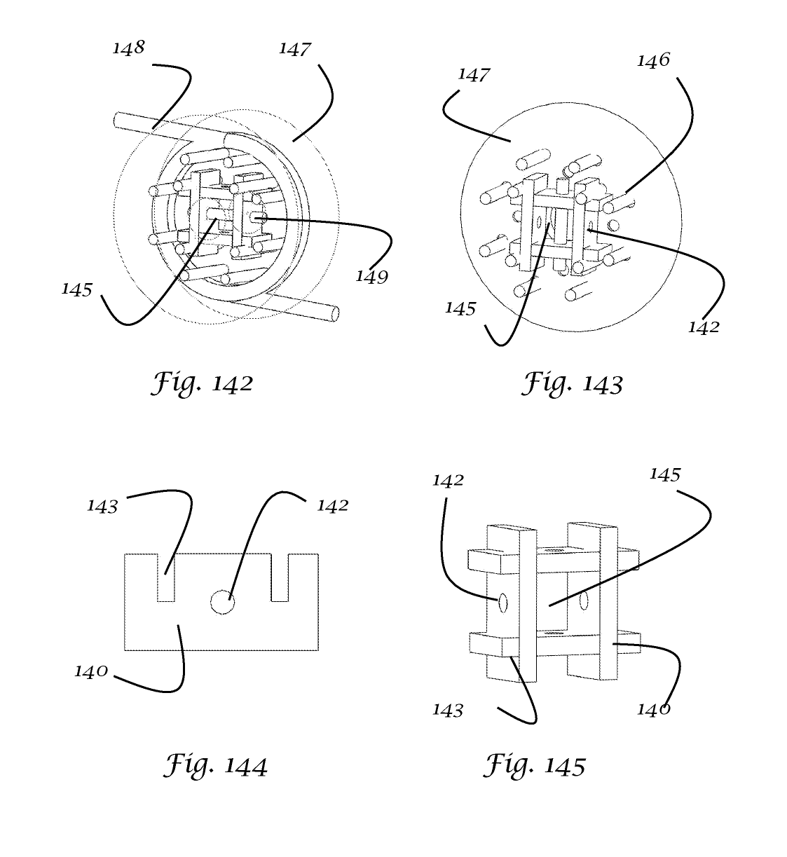

FIG. 143 shows the winch assembly 146 without the rope, illustrating shaft locking mechanism 145. The pipe rail 19 may be placed through the center of box section of locking mechanism 145. A pin may be placed though hole 142 and through the pipe rail 19, thereby locking the winch assembly to the shaft. The locking mechanism 145 may be locked to the face plate 147 by placing bolt 146 in the junction of locking part 140. FIG. 144 shows locking mechanism part 140, illustrating a mortise 143 that may permit four parts to intersect to create the winch locking mechanism 145, as shown in FIG. 145.

FIG. 146 shows a three-dimensional angular measurement instrument on the back of an animal. This three-dimensional angular measurement instrument gauge 180 is detailed in U.S. Pat. No. 6,334,262. The disclosure of this patent are hereby incorporated by reference in its entirety and for all purposes. FIG. 147 shows three-dimensional angular measurement instrument gauge 180 cradled inside a riding saddle 190, on top of the saddle panels or bars.

FIGS. 148-149 illustrates a horse 200 with a computer interface pressure measurement sensor array 201 placed on the animal's back under the saddle. This instrument is explained in detail in U.S. Pat. No. 5,375,397. The disclosure of this patent is hereby incorporated by reference in its entirety and for all purposes. In FIG. 149, a rider 195 is shown mounted in the saddle for perspective

FIG. 150 shows horse 200 with a computer interface pressure measurement sensor array 201 placed above the animal's back and a pack saddle frame 1 placed above the interface pressure measurement sensor array 201.

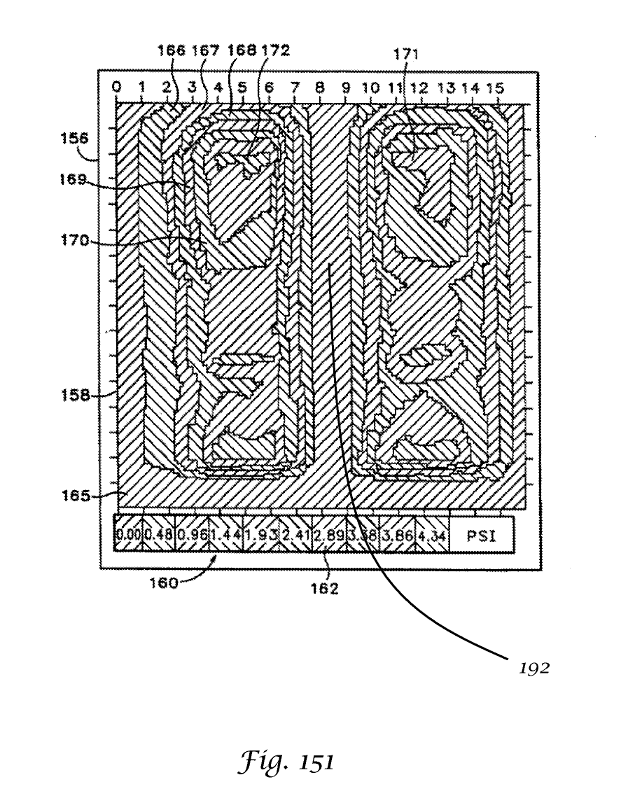

FIG. 151 shows a computer interface pressure scan image 192. The alternating cross-hatching may indicate the various pressures that can be detected by the use of such a measurement method. The goal may be to have uniform even pressure, which may be indicated by one continuous color.

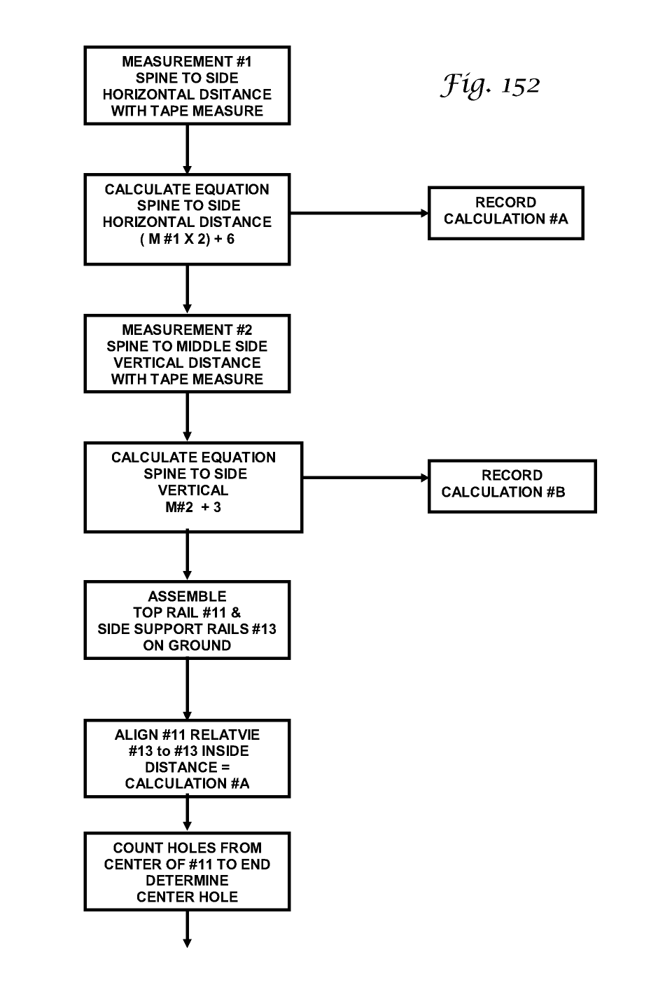

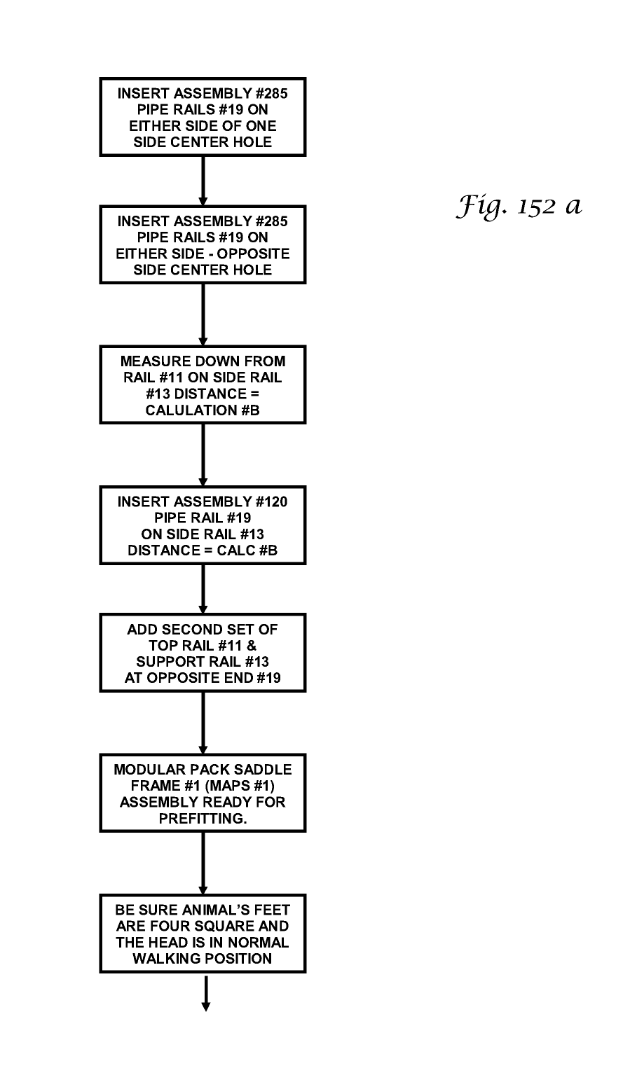

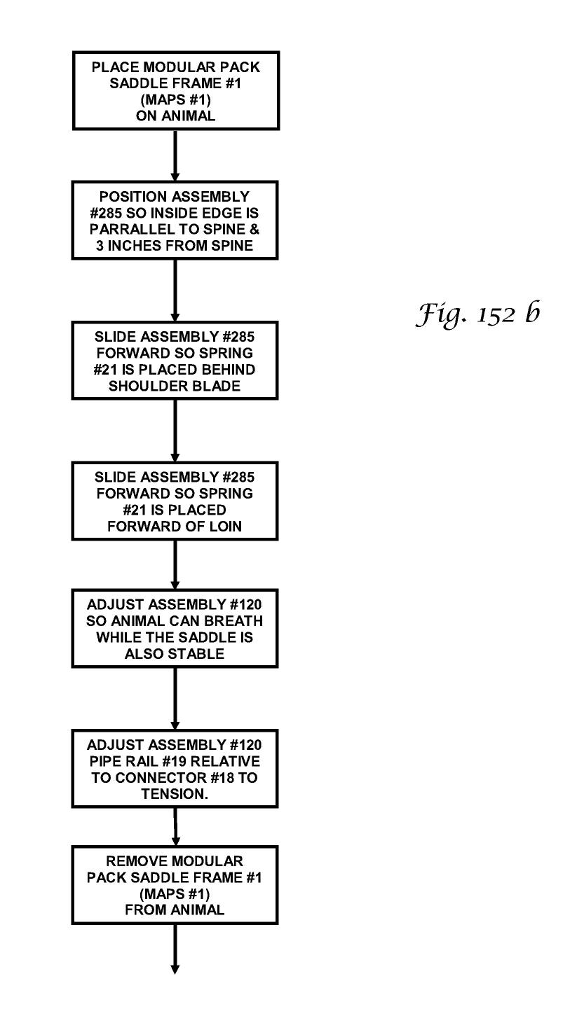

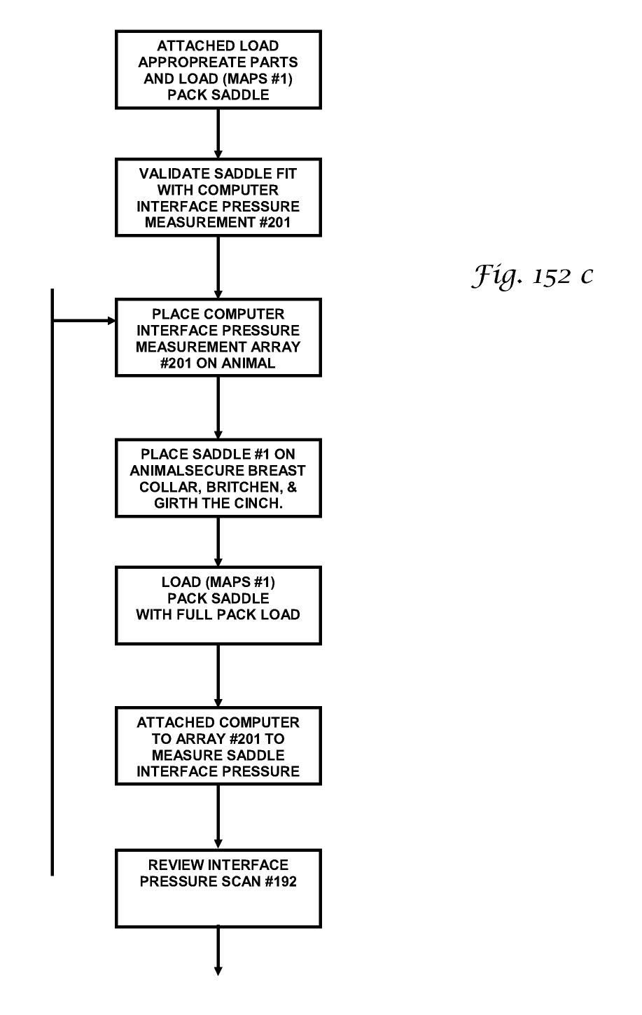

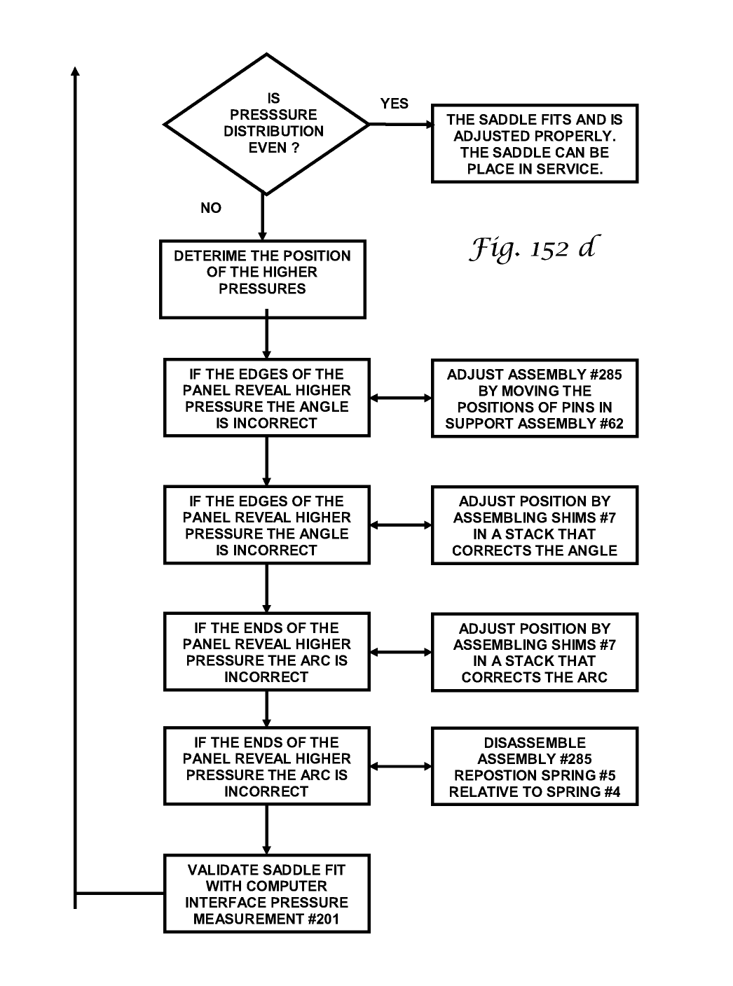

FIG. 152 shows a flow chart for a non-exclusive exemplary method of measurement and fitting the modular animal pack saddle 1 to the pack animal. The method may include one or more of the following steps:
1. A measurement 1 may be obtained using a tape measure to determine the horizontal distance from the spine of the animal to one side of the animal.
2. A quantity A may be determined by multiplying measurement 1 by two, and adding six inches. The quantity A may be recorded for future reference.
3. A measurement 2 may be obtained using a tape measure to measure the vertical distance from the spine of the animal to the middle of one side of the animal.
4. A quantity B may be determined by multiplying measurement 2 by two and adding three inches. Quantity B may be recorded for future reference.
5. Parts of the Modular Animal Pack Frame 1 may be laid out on the ground, including two Top Rails 11 and two pairs of Side Support Rails 13, with one Side Support Rail 13 on either end of each Top Rail 11.
6. The respective holes on the Top Rails and the top of the Side Support Rails may be aligned so that the distance between inner faces of the two Side Support Rails is substantially equal to the quantity A.
7. The location of the center hole on each side of a first top rail 11 may be found by counting the number of exposed holes on the side of the top rail.
8. Pipe Rails 19 of a first deformable double short load distribution assembly 285 may be inserted in the two holes adjacent to the center hole at the outboard ends of a first side of the first top rail 11 and may be secured in position with the locking collar 8.
9. Pipe Rails 19 of a second deformable double short load distribution assembly 285 may be inserted in the two holes adjacent to the center hole at the outboard ends of a second side of the first top rail 11 and may be secured in position with the locking collar 8.
10. A distance corresponding to calculation B may be measured from top rail 11 along side rails 13.
11. Pipe rails 19 of side stabilization pad assembly 120 may be inserted into adjacent holes in the side rails corresponding to the measured location.
12. The second assembled set of top rail 11 and two side support rail 13, may be secured on the opposite ends of each pipe rail 19 with secure with locking collars 8.
13. Modular pack saddle frame 1 may be ready for fitting to the animal.
14. The animal may be placed standing with all four feet square to each other with animal's head is in a normal position when the animal is walking.
15. The modular animal pack saddle may be placed on the animal's back.
16. Deformable double short load distribution assembly 285 may be positioned by adjusting the angular position of adjustable angular load distribution support assembly 62, so that the inside edge of assembly 285, is substantially parallel to the spine of the animal and no closer than three inches from the spine of the animal.
17. The front assembly 285 may be slid so the front edge of the short load distribution spring 21 is just behind the scapula of the animal. (The back edge of the scapula can be found by pressing the skin right behind the shoulder blade)
18. The back assembly 285 may be slid back so that the back edge of the short load distribution spring 21 is just in front of the loin of the animal.
19. The side stabilization pad assembly 120 may be adjusted so that the animal can breathe easily, but at the same time the assembly 120, should be tight enough so that the load can be secured without movement. This adjustment can be facilitated by adjusting the relative position of the pile rail 19 to side stabilization pad rail connector 18.
20. The tension of the side stabilization pad assembly 120 may be a function of the position of the top rail 11 and two side support rail 13, and the position of pile rail 19 to side stabilization pad rail connector 18. By moving the pipe rail 19 to one of the holes in the side stabilization pad rail connector 18, the tension of the modular animal pack frame 1 relative to the shape of the animals back and side can be facilitated with greater resolution and secured with locking collar 8 on both sides of the assembly.
21. The modular pack saddle 1 may be removed from the animal.
22. The appropriate parts may be attached to configure the pack saddle for the movement of the particular pack load.
23. In order to validate that the modular animal pack saddle is adjusted to the animal correctly, the computer interface pressure measurement device may be used.
24. The computer interface pressure measurement sensor pad 201 may be placed onto the animal's back.
25. The modular animal pack saddle may be secured to the animals back over the appropriate padding and computer interface pressure sensor pad 201.
26. The modular animal pack saddle may be loaded with the complete appropriate load.
27. A computer may be attached to the computer interface pressure sensor pad and the interface pressure on the back of the animal may be measured.
28. The computer interface pressure scan may be reviewed.
29. If the interface pressure scan shows that the pressure is distributed evenly, which may be indicated by even color on the display, the saddle may be adjusted properly and the pack saddle may be ready to be placed into service, once the computer interface pressure sensor array pad is removed. The load and pack saddle may be removed from the animals back, the computer interface pressure sensor array pad may be removed from the back of the animal, and the pack saddle can be placed in service with that configuration until the load configuration changes or the animal's back shape changes. (The shape of the back should be observed for changes on a regular basis)
30. If the interface pressure scan indicated that the load is NOT distributed evenly, which may be indicated by uneven color on the display with areas that have remarkably different pressures indicated by significant graduations in the color distribution, the pack saddle IS NOT adjusted properly and the load distribution assembly must be readjusted until even pressure is achieved. Observation of the interface pressure scan results may suggest a position of higher pressures.
31. If the excessive pressures are indicated on one edge of the deformable double short load distribution assembly 285, the angle may be incorrectly adjusted. The angle of the assembly 285 relative to the shape of animal's back may be adjusted by moving the relative positions of the pins on adjustable angular load distribution support assembly 62.
32. Alternatively, the angle of the deformable double short load distribution assembly 285 relative to the shape of the animal's back can also be adjusted employing a set of contoured tapered shims 7.
33. If higher pressure is indicated at the ends of the deformable double short load distribution assembly 285, the shape of the animal's back may have exceeded the material properties of the deformable double short load distribution assembly 285. The relative angle or arc of the assembly can be adjusted by adding the contoured tapered shims 7 in the middle of the assembly, as discussed previously.
34. In some cases, the deformable double short load distribution assembly 285 can be disassembled, and the respective secondary leaf spring 5 can be repositioned relative to primary leaf spring 4. Alternatively, either thinner or thicker primary leaf spring 4 or secondary leaf spring 5 can be added or removed to adjust the modulus or stiffness to adjust the pressure distribution.
35. After adjustments have been performed, the modular animal pack saddle with the complete load secured to the pack saddle may be remeasured with the computer interface pressure measurement instrument and may be readjusted until even pressure is achieved indicated by even color distribution. When the load is balanced, the computer interface pressure sensor array pad may be removed from the back of the animal and the modular pack saddle 1 can be placed in service with that particular load configuration, until the load configuration changes or the animal's back shape changes. (The shape of the back should be observed for changes on a regular basis)

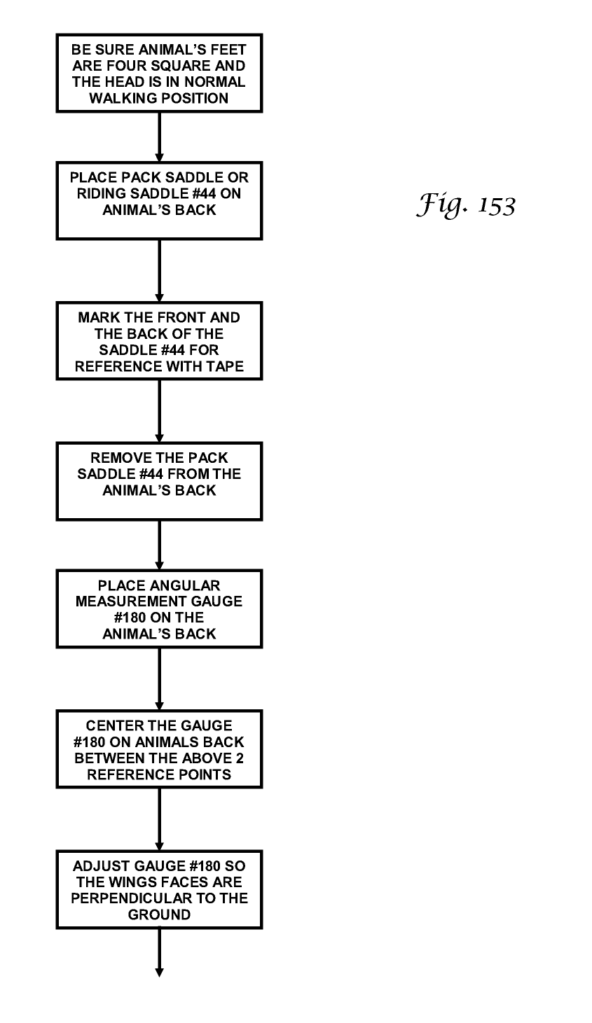

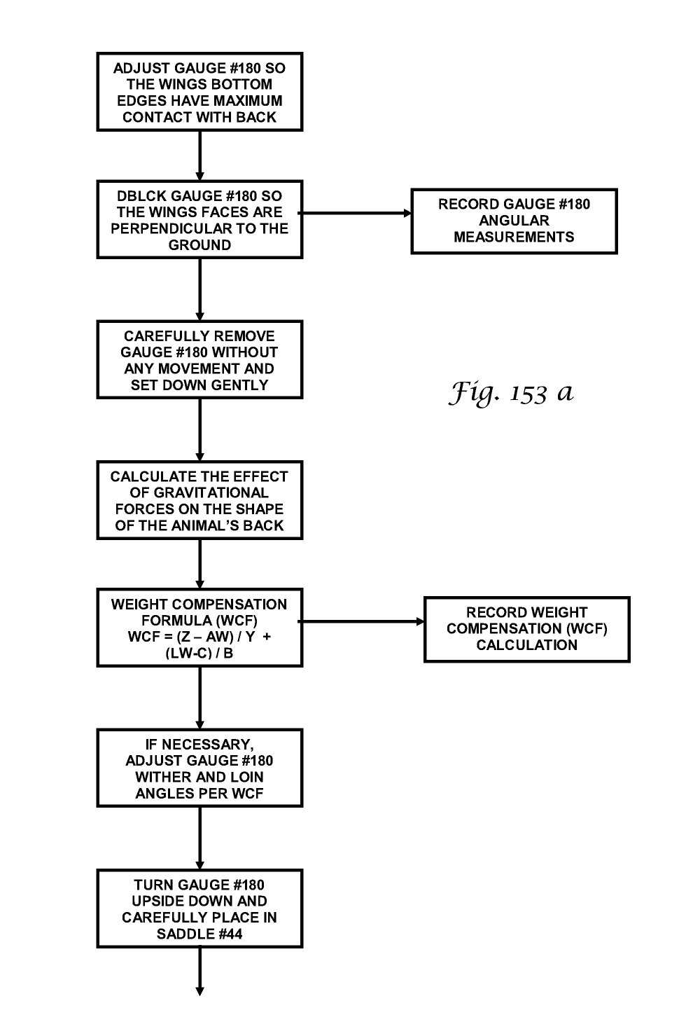

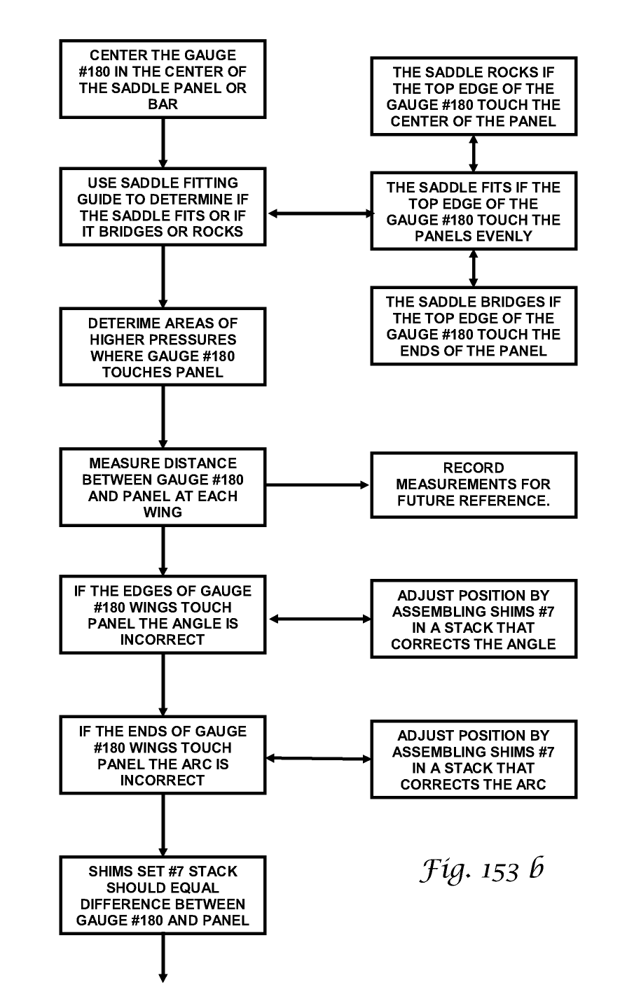

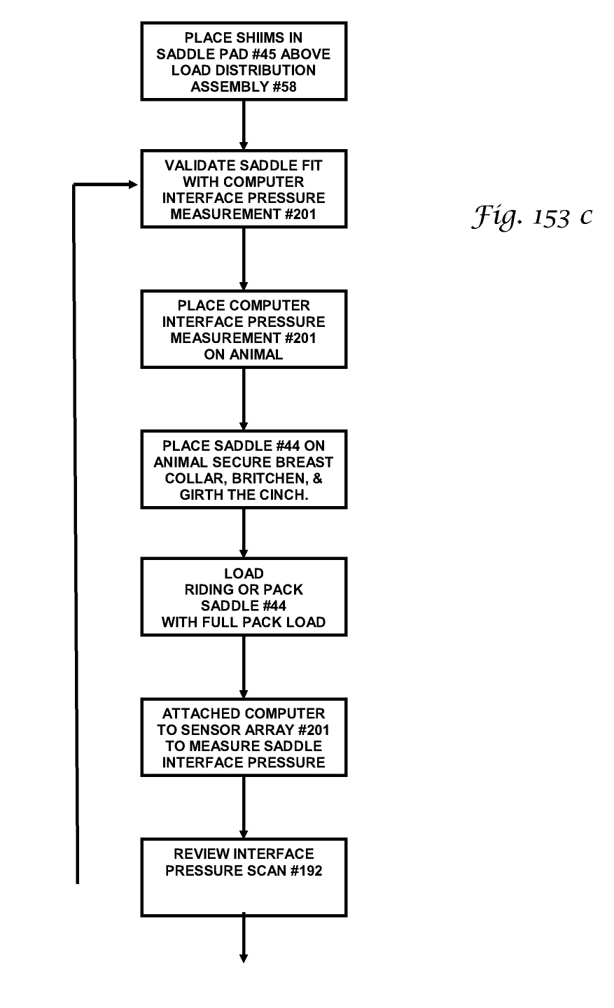

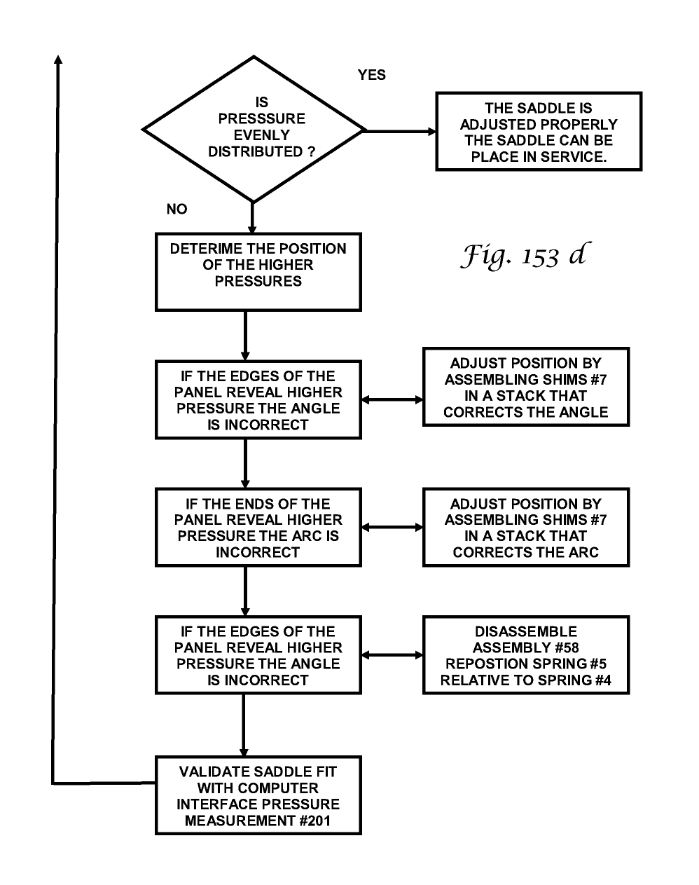

FIG. 153 shows a flow chart for a non-exclusive exemplary method of measurement and fitting the legacy pack saddle to the pack animal or fitting the legacy riding saddle to a riding animal. The method may include one or more of the following steps:
1. The animal may be placed standing with all four feet square to each other with animal's head is in a normal position when the animal is walking.
2. The legacy pack saddle or a riding saddle may be placed on the animal's back.
3. The position in the front of the saddle and the back of the saddle on the animal's back may be marked with tape or chalk for reference.
4. The saddle may be removed from the animal's back.
5. The three-dimensional angular measurement gauge 180 may be placed on the animal's back.
6. The gauge may be centered between the two marks placed in front and in back of the pack saddle 44 for reference.
7. The gauge 180 may be adjusted until the angular measurement wings rest evenly on the flat part of the animals back, perpendicular to the spine of the animal and until the front faces of the wings are perpendicular to the ground.
8. The center, wither, and loin wings may be adjusted downward so that the bottom edges of the wings have maximum contact with the animal's back.
9. After double-checking that the faces of the wings are perpendicular to the ground, the angular measurements on gauge 180, from each of the respective wing (arm) indicia and the arc (link) indicia on the measurement device may be recorded.
10. The measurement device may be lifted off the animal without moving the position of the gauge, and set onto the ground or another work surface.
11. The effect of gravitational forces on the shape of the arc of the animals back may be calculated using the WCF (Weight Compensation Factor) equation.
12. An exemplary equation is WCF=(Z−AW)/Y+(LW−C)/B, where WCF is the change in angular position of the at least one wing set, Z is the established standard animal weight, AW is the weight of the animal's weight, Y is a first established weight corresponding to a one degree change in angular position of the at least one wing set, LW is the weight of the load, C is the established standard load weight, and B is a second established weight corresponding to a one degree change in angular position of the at least one wing set. The calculated WCF may recorded for alter use.
13. If necessary, the wither (pommel) arc and loin (cantle) arcs of the gauge may be adjusted to compensate for gravitational forced cause by the weight of the load relative to the weight of the animal using the appropriate formula or chart. In some examples or circumstances, additional factors may require refined formulas. Additional factors affecting saddle fit may include the age of the animal, the condition of the animal, the type of saddle, the surface area of the saddle panels, the type of riding and the skill of the rider. Appropriate adjustments can be made using this method to account for additional factors. The adjustments can be calibrated employing computer interface pressure measurement instrument 210, for validation.
14. The angular measurement device gauge may be turned upside down and the gauge may be placed in pack saddle 44, which may be placed on the ground upside down, on top of the saddle panels or bars.
15. The angular measurement device gauge 180 may be placed in the center of the saddle, equidistant from the front (pommel or fork) and back (cantle) of the saddle. This location may correlate the position of the reference points that were placed on the animal's back, so that the relative position of the two measurements correlate.
16. The saddle fitting guide may be used to determine the best possible saddle fit for a particular animal.
   a. The saddle may be considered to “Fit” if all the top edges of the wings that are adjacent to the pack saddle bars or panel touch uniformly.
   b. The saddle may be considered to “Rock” if the top edges of the wings that are adjacent to the pack saddle bars or panel do not touch the wither and loin areas at either end of the pack saddle.
   c. The saddle may be considered to “Bridge” if the top edges of the wings that are adjacent to the pack saddle bars or panel touch at the pommel (front) and cantle (back) of the pack saddle and do not touch the center of the pack saddle.
17. Areas of higher pressure where gauge 180 touches the panel may be determined.
18. The difference between the shape of the gauge 180 and the pack saddle panels or bars may be measured at each wing. Measurements may be recorded for future reference.
19. If the edges of the gauge do not touch the panel, a set of contoured tapered shims 7 may be configured to correct the angle.
20. If the ends of the gauge do not touch the panel, a set of contoured tapered shims 7 may be configured to correct the arc.
21. The set of shims 7 may be configured to compensate for the difference between gauge 180 and the panel.
22. The configured contour shim set 7 may be placed in the pocket of saddle pad 45, so that it is above saddle load distribution assembly 58, and above curly fiber or foam 46.
23. In order to validate that the pack saddle 44 is adjusted to the animal correctly, computer interface pressure measurement device 301 may be used.
24. The computer interface pressure measurement sensor may be placed onto the animal's back.
25. Pack saddle 44 with appropriate padding may be placed onto the computer interface pressure sensor pad and secured to the animal.
26. The pack saddle may be loaded with the complete appropriate load.
27. The computer may be attached and used to measure the interface pressure on the back of the animal with the computer interface pressure sensor pad.
28. Computer interface pressure scan 192 may be reviewed.
29. If the interface pressure scan 192 is distributed evenly, indicated by even color on the display, the saddle may be adjusted properly, and the pack saddle may be ready to be placed into service. The load, the pack saddle, and the computer interface pressure sensor array pad may be removed from the back of the animal. The pack saddle can be placed in service with that configuration until the load configuration changes or the animal's back shape changes. (The shape of the back should be observed for changes on a regular basis)
30. If the interface pressure scan 192 is not distributed evenly, which may be indicated by uneven color on the display with areas that have remarkably different pressures indicated by significant graduations in the color distribution, the pack saddle is not adjusted properly and the load distribution assembly may be readjusted until even pressure is achieved. Observation of the interface pressure scan results may suggest a position of higher pressures.
31. If the excessive pressures are indicated on one edge of the pack saddle 44 bar or panel the angle may be incorrectly adjusted. The angle of the pack saddle relative to the shape of the animal's back can be adjusted assembling a set of contoured tapers shims 7.
32. If higher pressure is indicated at the ends of the pack saddle, the arc may be adjusted. The relative angle or arc of the assembly can be adjusted by adding contoured shims 7 in the middle of the assembly, as discussed previously.
33. The fit of pack saddle 44 with the complete load secured to the pack saddle may be remeasured with the computer interface pressure measurement instrument 201 and readjusted until even pressure is achieved indicated by even color distribution on the computer interface pressure scan 192.

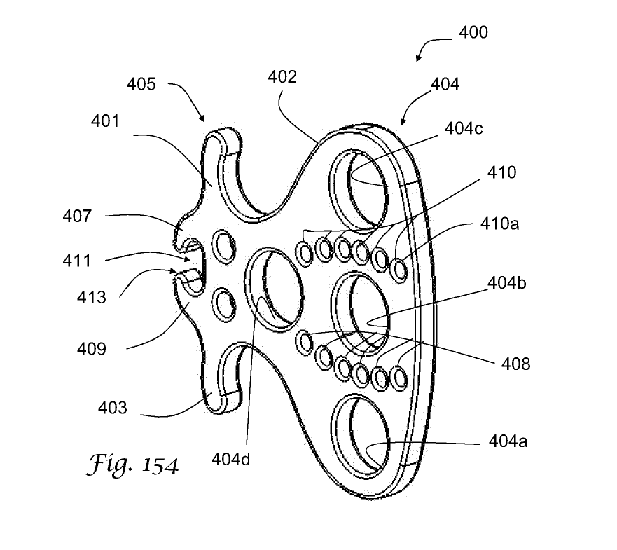

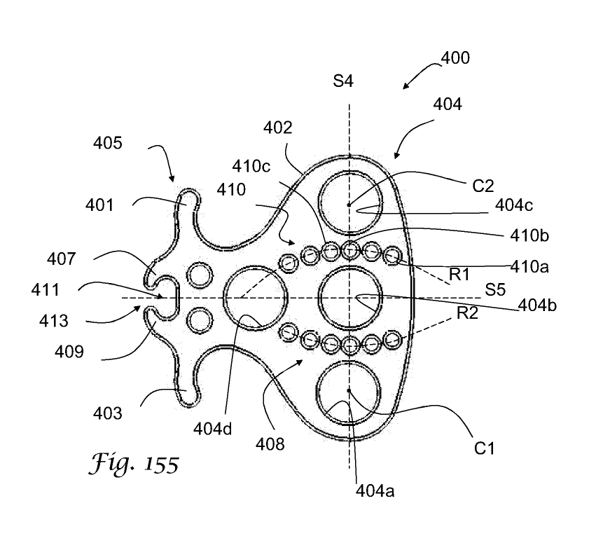

Turning now to FIGS. 154 and 155, an exemplary universal cleat 400, also referred to generally as a multiply-positionable link, is provided. The universal cleat 400 may include a body 402, a first series of in-line link-mounting stations including two or more link-mounting stations 404a, 404b, 404c disposed along a first station line S4; and a second series including two or more in-line link-mounting stations 404b and 404d disposed along a second station line S5 different than the first station line. In some embodiments, a first link-mounting station, such as first mounting station 404b, of a first series of link mounting stations may be the same as a first link-mounting station of a second series of link mounting stations. In this example, the in-line link-mounting stations are holes having equal sizes and correspondingly are also referred to as holes. Within each station line, the holes are spaced equally apart. One or more hooks may be attached to the body 402, such as oppositely directed hooks 401 and 403 forming a cleat tie-down 405. Additionally, hooks may be directed toward each other to form an opening with a narrow neck, such as hooks 407 and 409 forming an opening 411 having a narrow neck 413. The hooks, holes and tie-down are useful for securing objects to the universal cleat, and thereby to the frame of the saddle.

Universal cleat 400 may further include auxiliary link-mounting stations 408 and 410. The link-mounting stations may include at least one auxiliary link-mounting station, such as auxiliary link-mounting station 410a, attached to the body and spaced from the first and second station lines S4, S5. Additionally and/or alternatively, universal cleat 400 may include an array of auxiliary link-mounting stations attached to the body and spaced from the in-line link-mounting stations. In some embodiments, an array of auxiliary link-mounting stations may have a radius of curvature with a center of curvature coincident with a center of an in-line hole 404. For example, the center of curvature C1 of radius of curvature R1 may be coincident with the center of hole 404a. Additionally and/or alternatively, the cleat may include a second array of auxiliary link-mounting stations 408 having a radius of curvature R2 with a center of curvature C2 coincident with the center of curvature of hole 404c. The auxiliary link-mounting stations may also be disposed in other suitable configurations. It will also be appreciated that in the general sense each auxiliary link-mounting station in arrays 408 and 410 may be considered to be in a line with a large-hole link-mounting station disposed along station lines S4 and S5.

As discussed earlier with reference to FIGS. 116-119, the body of the link may be supportable on the frame in at least two orientations. In the first orientation, the first and second link-mounting stations of the first pair of in-line link-mounting stations disposed along station line S4 may be aligned with the first and second frame-mounting stations of the load-carrying frame. In the second orientation of the link body, the first and second in-line link-mounting stations of the second pair of link-mounting stations disposed along station line S5 may be aligned with the first and second frame-mounting stations of the load-carrying frame.

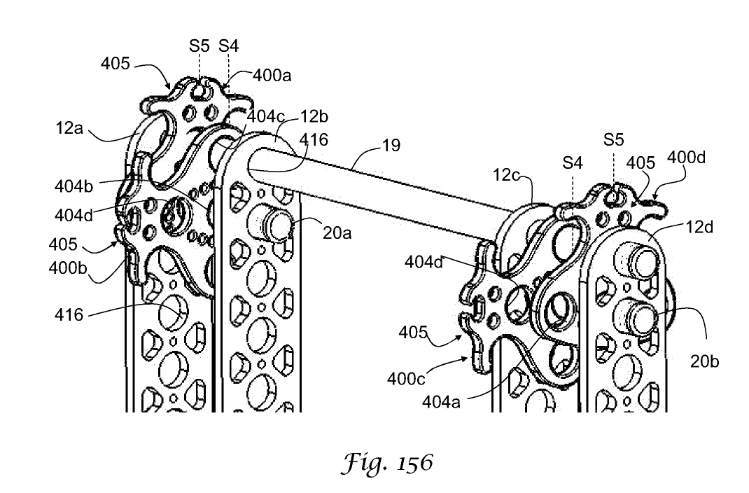

FIG. 156 illustrates universal cleats 400 attached to frame members, such as frame members 12. In particular, cleats 400a and 400b are shown sandwiched between frame members 12a and 12b, and cleats 400c and 400d are shown sandwiched between frame members 12c and 12d. Opposite ends of a long pipe rail 19 extends through respective holes of frame members 12 and cleats 400, as shown. Further a short pipe rail 20a extends through respective holes of each set of frame members 12 and cleats 400. The frame members and cleats are in contact with each other during normal use, being held in place by locking collar assemblies 8, not shown in this figure. It will be appreciated that the universal cleat may be held in position to a single frame member with the use of a suitable attachment mechanism, such as a locking collar assembly 8 attached to a pipe rail 19 as illustrated in FIGS. 119 and 123.

More specifically, pipe rails 19 and 20 extend through respective holes 404b and 404d of cleats 400a and 400d, which holes are disposed along respective mounting-station lines S5. With the cleat held in this orientation, it is seen that hole 404a, shown on cleat 400d, extends beyond the sides of the frame members, and when attached to the ends of the frame members as in this example, the tie-down 405 is exposed, making them available for use. Similarly, pipe rails 19 and 20 extend through respective holes 404c and 404b of cleats 400b and 400c, which holes are disposed along respective mounting-station lines S4. With the cleat held in this orientation, it is seen that hole 404d and cleat tie-down 405 extend beyond the sides of the frame members, making them available for use. It is appreciated then that by being able to position the cleats in different positions, different portions and associated features of the cleat are exposed beyond the frame members.

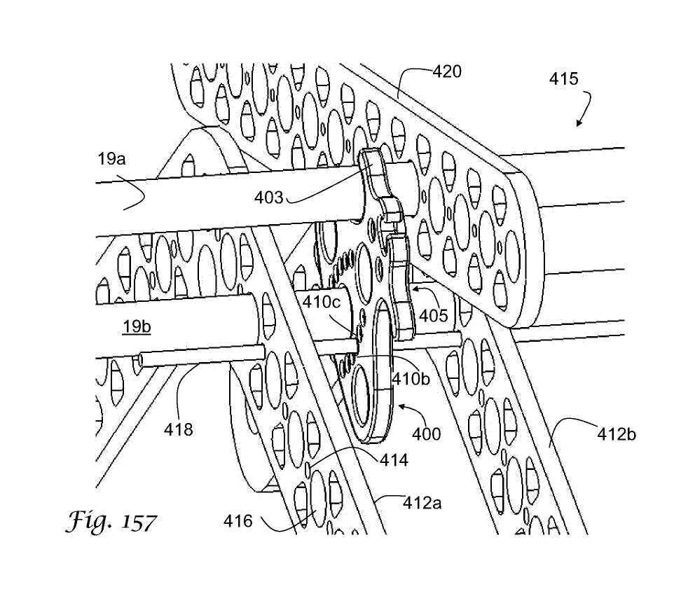

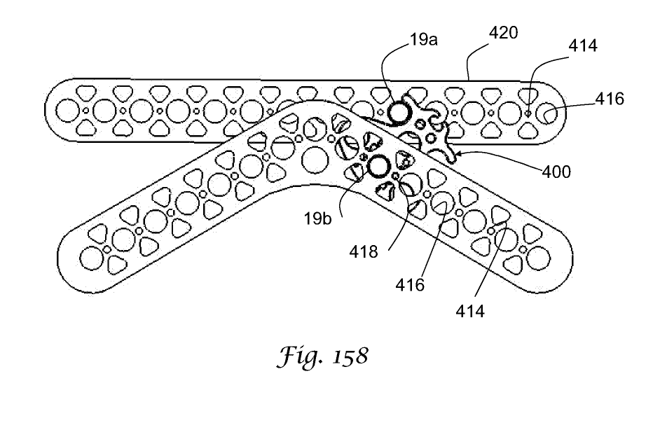

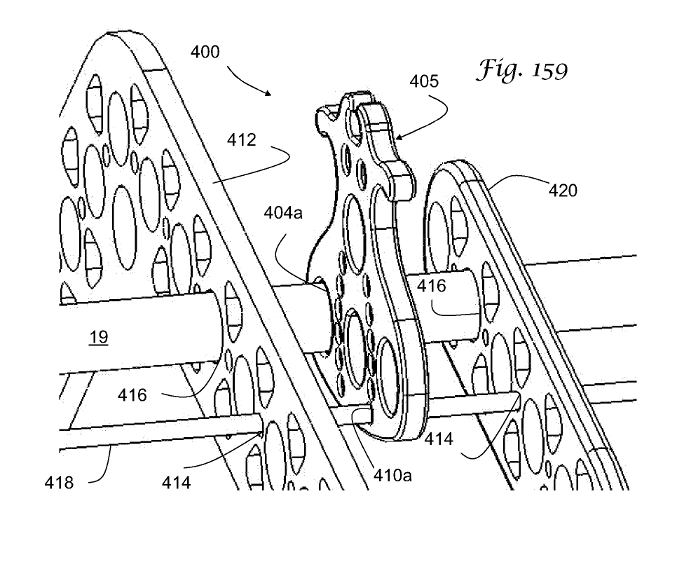

As shown in FIGS. 157 and 158, universal cleat 400 may secure an object, shown generally at 415, to a frame member, such as top frame members 412a and 412b of a pack saddle. Frame members 412 are modified versions of top rail 11 described earlier, and have a series of basic frame-mounting stations 416 and auxiliary frame-mounting stations 414, which in this example are large holes 416 and small holes 414, respectively. Small holes 414 are disposed between the large holes 416. Portions of the frame members may have large holes 416 spaced-apart a distance that equals the spacing between the large holes and hook openings along station lines S4 and S5 of the universal cleat.

Additionally, the spacing between the large holes may vary on the frame members. In such cases there may not be two large holes or hook openings on the cleat disposed along station lines S4 or S5 that align with two corresponding large holes on the desired portion of the frame members. Small holes 414 of the frame members may vary in distance from the immediately adjacent large holes. Small holes 408 of cleat 400 are disposed at different distances from proximate large holes 404a and 404b. Similarly, small holes 410 are disposed at different distances from proximate large holes 404b and 404c. In general, then, the distances between the different small holes and a large hole of the cleat, even large hole 404d, vary so long as the hole does not contain the center of curvature of the array of small holes. This allows the cleat to be secured on the frame by selecting a small hole that aligns with a small hole on the frame when the cleat is pivoted about a large hole not including a center of curvature of an array of small holes.

Referring to FIG. 155, small hole 410a is adjacent to the outer edge of body 402 opposite from cleat tie-down 405, small hole 410b is in line with station line S4, and small hole 410c is the hole next to hole 410b opposite from small hole 410a. It is seen that small pipe rail 418 extends through small hole 410c because the spacing of the large holes on the frame members 412a and 412b in this illustration are not the same as the spacing of the large holes along station line S4 of the cleat. Small hole 410c happens to align with the corresponding hole 414 on the frame member, thereby allowing the cleat to be attached to the frame members using two sets of holes to prevent rotation of the cleat during use.

Object 415 supported by the cleat includes a large pipe rail 19a and a frame member 420 similar to frame member 12 described previously. A load may be attached to the object, with the object supported on cleat 400 by placement in the opening of upwardly facing hook 403. Other mechanisms may be used to secure the object to the saddle, such as by tying with cords. It should be noted that frame member 420 is shown extending between portions of frame members 412a and 412b in this expanded view. When the frame members 412a and 412b are pressed against cleat 400 and secured in position on pipe rails 19b and 418, frame member 420 is pivoted or moved away from the frame members 412a and 412b, thereby allowing the object to be inserted onto the saddle or removed from it after the saddle is assembled.

These figures illustrate a frame member having at least one auxiliary frame-mounting station (small hole 414) adjacent to at least one basic frame-mounting station (large hole 416) for supporting the cleat 400 in at least a third orientation. With the cleat in the third orientation, one of the link-mounting stations of the first or second series of link-mounting stations (large holes 404) may be aligned with a basic frame-mounting station (large hole) of frame member 412 and at least one auxiliary link-mounting station (small hole) in the array 410 may be aligned with an auxiliary frame-mounting station (small hole). Pipe rails 19 and 418, also generally referred to as transverse members, may extend through the respective aligned holes forming the mounting stations.

Further, by having the center of curvature C2 of array of small holes 408 centered in hole 404c, or the center of curvature C1 of array of small holes 410 centered in hole 404a, the cleat can be supported on a frame member in orientations other than the orientations defined by the mounting holes on the station lines S4 and S5 as embodied in universal cleat 400. The additional orientations can be provided by securing the cleat to the frame at hole 404c or 404a, and then aligning with the corresponding small hole on the frame a selected one of the small holes in the respective array. An example of such a configuration is shown in FIG. 159. In this figure, the reference numbers of corresponding features are continued from the previous description. Universal cleat 400 is secured between frame members 412 and 420. Each frame member includes basic frame-mounting stations in the form of large holes 416 spaced along the lengths of the frame members, and auxiliary frame-mounting stations in the form of small holes 414.

Cleat 400 is held in position in part by a first transverse element in the form of a small pipe rail 418 passing through small holes 414 in frame members 412 and 420 and, in this example, small hole 410a of array 410 in cleat 400. The cleat is also held in position by a second transverse element in the form of a large pipe rail 19 extending through respective holes 416 in the frame members and through hole 404a of the cleat. In the orientation shown, cleat tie-down 405 extends beyond the edges of the frame members, but tends to be directed more upwardly than if the cleat was supported by in-line link-mounting elements extending along station line

S4.

As in the immediately previous figures, the frame members and cleat are illustrated in spaced positions along the mounting pipe rails 19 and 418 to facilitate illustration. When mounted for use, the frame members and cleat are pressed together and held in position by attachment mechanisms, such as locking collar assemblies 8, not shown, attached to pipe rails 19.

It will be apparent to one skilled in the art that many variations in form and detail may be made in the preferred embodiments as illustrated and described above without varying from the spirit and scope of the invention that the claims define or are interpreted or modified according to the doctrine of equivalents. The preferred embodiments of the various features of the invention are thus provided for purposes of explanation and illustration, but not limitation.

1. A load-supporting saddle comprising:
a frame for receiving a load to be carried by a load-carrying animal; and
a load-distribution assembly for supporting the load-carrying frame on the back of the pack animal, the load-distribution assembly, including:
a first load-distributing member having opposing first and second surfaces extending between spaced-apart first and second sections and an intermediate third section disposed between and spaced from the first and second sections; and
at least a first load-bearing member attached to each of the opposite first and second sections of the first load-distributing member, each first load-bearing member having a first surface facing the second surface of the first load-distributing member and a second surface opposite the first surface and facing the load-carrying animal during use; and
an attachment mechanism attaching the frame to the load-distribution assembly.

2. The load-supporting saddle of claim 1, wherein the load-distribution assembly further includes at least a second load-distributing member extending between spaced-apart first and second sections and an intermediate section disposed between and spaced from the first and second sections, the intermediate section of the second load-distributing member being attached to one of the first load-bearing members opposite the first load-distributing member.

3. The load-supporting saddle of claim 2, wherein the load-distribution assembly further includes a second load-bearing member attached to each of the first and second sections of the second load-distributing member, each second load-bearing member having a first surface facing the second load-distributing member and a second surface opposite the first surface and facing the load-carrying animal during use.

4. The load-supporting saddle of claim 3, wherein the load-distribution assembly further includes a spring-plate member extending along and attached to the second surfaces of a plurality of the second load-bearing members.

5. The load-supporting saddle of claim 1, wherein the load-distribution assembly further includes a plurality of load-distributing members, load-bearing members attached to the load-distributing members, and a spring-plate member, the plurality of load-distributing members being attached to the spring-plate member at spaced locations.

6. The load-supporting saddle of claim 5, wherein the plurality of load-distributing members are attached to the spring-plate member in a rectangular array.

7. The load-supporting saddle of claim 1, wherein the attachment mechanism allows pivoting of the load-distribution assembly relative to the frame.

8-26. (canceled)

27. A load-supporting saddle comprising:
a frame for supporting a load to be carried by a load-carrying animal; and
a hoist assembly for raising a load vertically toward the frame while the frame is supported by the load-carrying animal, the hoist assembly including:
a first support member supported on the frame and extending laterally of the animal beyond a first side of the frame, and
a first guide element supported by the first support member at a position disposed horizontally beyond the first side of the frame so that a first cord hanging downwardly from the first guide element is spaced from the frame.

28. The saddle of claim 27, wherein the first guide element is a pulley adapted to rotate relative to the support member.

29. The saddle of claim 27, wherein the hoist assembly further includes a winch assembly including a first spool section and a drive mechanism rotatingly mounting the first spool relative to the frame, the drive mechanism operable in a hoisting mode for rotating the first spool section relative to the frame, and thereby winding the first cord while the first cord is attached to the first spool section and has a free end extending over and hanging from the first guide element.

30. The saddle of claim 29, wherein the drive mechanism includes a shaft on which the first spool section is mounted and a second spool section also mounted on the shaft, whereby the shaft is rotated by unwinding a second cord wound on the second spool section.

31. The saddle of claim 29, wherein the hoist assembly includes a second support member supported on the frame and extending laterally beyond a second side of the frame opposite the first side, and a second guide element supported by the second support member at a position disposed horizontally beyond the second side of the frame so that a second cord hanging downwardly from the second guide element is spaced from the frame.

32. The saddle of claim 31, wherein the winch assembly further includes a second spool section, the drive mechanism also rotatingly mounting the second spool section relative to the frame, the drive mechanism operable in the hoisting mode for rotating the second spool section relative to the frame, and thereby winding the second cord while the second cord is attached to the second spool section and has a free end extending over and hanging from the second guide element.

33. The saddle of claim 32, wherein the drive mechanism includes a shaft on which the first and second spool sections are mounted and a third spool section also mounted on the shaft, whereby the shaft is rotated by unwinding a third cord wound on the third spool section.

34. The saddle of claim 27, wherein the hoist assembly includes a second support member supported on the frame and extending laterally beyond a second side of the frame opposite the first side, and a second guide element supported by the second support member at a position disposed horizontally beyond the second side of the frame so that a second cord hanging downwardly from the second guide element is spaced from the frame.

35-50. (canceled)
